(19) United States
(12) Patent Application Publication
(10) Pub. No.: US 2001/0019560 A1
(43) Pub. Date: Sep. 6, 2001

(54) Method of and apparatus for transmitting digital data

(76) Inventor: Shigeyuki Yamashita, Kanagawa (JP)

Correspondence Address: William S. Frommer, Esq., FROMMER LAWRENCE & HAUG LLP, 745 Fifth Avenue, New York, NY, 10151, US

(21) Appl. No.: 09/754,737

(22) Filed: Jan. 4, 2001

(30) Foreign Application Priority Data
Jan. 5, 2000 (JP) 2000-000232
Jan. 19, 2000 (JP) 2000-009792
Jan. 25, 2000 (JP) 2000-015453
Feb. 10, 2000 (JP) 2000-033460

(51) Int. Cl. H04J 3/16

(52) U.S. Cl. 370/472; 370/487

(57) ABSTRACT

A method of transmitting digital data includes the steps of multiplexing a plurality of compressed digital video or video and audio signal data to produce 8-bit word sequence data, combining an additional word data group including 8-bit word synchronous data allotted a predetermined specific code with the 8-bit word sequence data to produce composite 8-bit word sequence data in which the additional word data group is repeatedly inserted at predetermined word intervals, causing the composite 8-bit word sequence data to be subjected to 8B/10B conversion to produce composite 10-bit word sequence data having a portion formed based on the additional word data group including 10-bit word synchronous data provided with running disparity not neutral, converting the composite 10-bit word sequence data into serial data, and transmitting the serial data.

### BACKGROUND OF THE INVENTION

1. Field of the Invention

The present invention generally relates to method of and apparatus for transmitting digital data, and more particularly, is directed to improvements in a digital data transmitting method by which word sequence data based on a plurality of digital video signals or combined digital video and audio signals and including word synchronous data are produced to be subjected to 8B/10B (8 bits to 10 bits) conversion and other data processings and then converted into serial digital data to be transmitted through a data transmission line, and in a digital data transmitting apparatus used for putting the above-mentioned method into practice. The word sequence data thus converted into the serial digital data to be transmitted may be formed based on compressed digital video signals or compressed digital video and audio signals combined with each other to include an additional word group containing the word synchronous data,

2. Description of the Prior Art

In the field of data transmission in which digital data containing information data representing various signal information are transmitted, an electric transmission system and an optical transmission system have been proposed to be put into practice. In the case of the electric transmission system, the digital data are made in the form of serial data and converted into one or more electric signals to be transmitted through one or more transmission lines each made of a coaxial cable or a pair of twisted lines. In the case of the optical transmission system, the digital data are made in the form of serial data and converted into one or more optical signals to be transmitted through one or more transmission lines each made of an optical fiber cables.

There has been proposed a Fibre Channel System as one of the digital data transmission system mentioned above. In the digital data transmission system such as the Fiber Channel System or the like, the digital data to be transmitted are subjected 8B/10B conversion by which every bit group of 8 bits of the digital data is converted into a new bit group of 10 bits in accordance with a predetermined conversion table to produce 10-bit word sequence data in a transmission side. Then, the 10-bit word sequence data are subjected to parallel to serial (P/S) conversion to produce serial data based on the 10-bit word sequence data and the serial data thus obtained are transmitted.

In a receiving side, the serial data received therein are subjected to serial to parallel (S/P) conversion to produce 10-bit word sequence data and then the 10-bit word sequence data are subjected to 10B/8B conversion by which every bit group of 10 bits is converted into a new bit group of 8 bits in accordance with the predetermined conversion table. The original digital data are reproduced from the word sequence data obtained by the 10B/8B conversion.

The data transmission in which the digital data to be transmitted are subjected to the 8B/10B conversion in advance of transmission thereof as described above is recognized to bring about superior transmission quality with 10-bit words each having selected contents.

Further, in the digital data transmission system such as the Fiber Channel System or the like, wherein the digital data are transmitted in the form of 10-bit word sequence data, the 10-bit word sequence data are formed in accordance with a predetermined data format in which successive minimum independent packets each called a frame, as shown in FIG. 1, for example, are formed. The frame shown in FIG. 1 is entirely constituted with 2,148 bytes to contain a frame start portion of 4 bytes, a frame header portion of 24 bytes, an optional header portion of 64 bytes, a payload portion of 2,048 bytes, an error check portion of 4 bytes and a frame end portion of 4 bytes, which are successively arranged.

The 10-bit word sequence data representing signal information are loaded in the payload portion of 2,048 bytes. This means that a large number of frames, in each of which the 10-bit word sequence data constituted with 2, 048 bytes at the maximum are loaded in the payload portion, are formed to be successively transmitted in the transmitting side and the 10-bit word sequence data are derived from the payload portion of each of the frames successively received in the receiving side when the transmission of the 10-bit word sequence data is performed.

The 10-bit word data constituting the 10-bit word sequence data are classified into three groups including a first group of 10-bit word data in each of which the number of “1” is greater than the number of “0” , a second group of 10-bit word data in each of which the number of “0” is greater than the number of “1” , and a third group of 10-bit word data in each of which the number of “0” is equal to the number of “1” . There has been proposed a concept of running disparity for representing the condition of the number of “0” and the condition of the number of “1” in each of 10-bit word data. When the number of “1” is greater than the number of “0” , the running disparity is positive, when the number of “1” is smaller than the number of “0” , the running disparity is negative, and when the number of “1” is equal to the number of “O” , the running disparity is neutral. Word data in which the number of “1” greater than the number of “0” is called word data of the positive running disparity, word data in which the number of “1” smaller than the number of “0” is called word data of the negative running disparity, and word data in which the number of “1” equal to the number of “0” is called word data of the neutral running disparity. The word data of the neutral running disparity is operative to transfer the running disparity just before that same word data of the neutral running disparity without any change.

When the 10-bit word sequence data are transmitted as described above, it is required to detect clearly each of the 10-bit words in the receiving side for 10B/8B conversion to which the 10-bit word sequence data is subjected. Therefore, word synchronous data are inserted into the 10-bit word sequence data which is to be transmitted in the form of serial data. The word synchronous data are formed to be 10-bit word data having a specific code which is never used for 10-bit word data representing information to be transmitted. The word synchronous data inserted into the 10-bit word sequence data is provided with the positive running disparity when the running disparity just before that same word synchronous data is negative and with the negative running disparity when the running disparity just before that same word synchronous data is positive.

The word synchronous data are constituted, for example, with 10-bit word data DS10 called K28.5 of a code name. FIG. 2 shows the 10-bit word data DS10 called K28.5 of the code name. The 10-bit word data DS10 are formed to be “0 0 1 1 1 1 1 0 1 0”, the running disparity of which is positive, when the running disparity just before that same word synchronous data is negative, and to be “1 1 0 0 0 0 0 1 0 1”, the running disparity of which is positive, when the running disparity just before that same word synchronous data is positive. Hereinafter, the data of “0 0 1 1 1 1 1 0 1 0” are called +28.5 and the data of “1 1 0 0 0 0 0 1 0 1” are called −28.5.

In the meantime, digital word sequence data representing image information (hereinafter, referred to digital image information data) are usually formed with a great quantity of data, and therefore, it is desired on the occasion of the transmission or recording of the digital image information data that the digital image information data are subjected to data compression to reduce the quantity of data without bringing about substantive deterioration in quality of data. Accordingly, various researches and developments have been done in the field of data compression technology for reducing the quantity of digital image information data and a standard system called MPEG has been proposed as one of results of the researches and developments. The MPEG has been advised by the Moving Picture Image Cording Experts Group which is a working group belonging to the International Organization for Standardization/International Electrotechnical Committee Joint Technical Committee (ISO/IEC JTC).

In the MPEG system, the digital image information data are subjected to data compression by means of high efficient coding according to the Discrete Cosine Transformation, which is usually called DCT for short.

In connection with the above, it has been also proposed a DV format system in which digital image or image and sound information data which are obtained, for example, based on a television signal or digital image and sound information data from which a television signal is produced are subjected to data compression by means of the DCT.

There are two different DV format systems, one of which is a SD type DV format system in which digital image or image and sound information data which are obtained based on a standard television signal (a SD signal), a frame of which is formed with 525 lines and a field frequency is 60 Hz or a frame of which is formed with 625 lines and a field frequency is 50 Hz, or digital image or image and sound information data from which the SD signal is produced, are subjected to data compression by means of the DCT, and the other of which is a HD type DV format system in which digital image or image and sound information data which are obtained based on a high definition television signal (an HD signal), a frame of which is formed with 1,125 lines and a field frequency is 60 Hz or a frame of which is formed with 1,250 lines and a field frequency is 50 Hz, or digital image or image and sound information data from which the HD signal is produced, are subjected to data compression by means of the DCT.

When the digital image or image and sound information data are subjected to data compression by means of high efficient coding in accordance with the MPEG system, the DV format system or the like, data compression at extremely high compressibility is realized and such an advantage that images with high quality are reproduced from the compressed digital image or image and sound information data is obtained. Consequently, in the field of electronic apparatus for professional use and home use, such as a digital video camera, a digital video tape recorder and so on, digital image or image and sound information data subjected to data compression by means of high efficient coding in accordance with the MPEG system (hereinafter, referred to MPEG information data) or digital image or image and sound information data subjected to data compression by means of high efficient coding in accordance with the DV format system (hereinafter, referred to DV format information data) have come to be often transacted.

On the occasion of transmission of the MPEG information data, the DV format information data or the like, in order to make it possible to utilize effectively existing integrated circuit devices previously developed for construction of data transmitting and receiving circuits for digital video signals, it is strongly desired that 8-bit word sequence data containing word synchronous data are formed based on the data to be transmitted and then subjected to 8B/10B conversion to produce 10-bit word sequence data and the 10-bit word sequence data thus produced are further converted into serial data to be transmitted in a transmitting side.

Under the situation in which 8-bit word sequence data containing word synchronous data are formed based on data to be transmitted and then subjected to 8B/10B conversion to produce 10-bit word sequence data and the 10-bit word sequence data thus produced are converted into serial data to be transmitted in a transmitting side, if a plurality of MPEG information data, DV format information data or the like can be so multiplexed and transmitted as to be surely and separately reproduced at a receiving side in addition to transmission of a single channel of MPEG information data, DV format information data or the like, the MPEG information data, the DV format information data or the like are utilized more effectively and the field of utilization of the MPEG information data, the DV format image information data or the like is desirably extended. The effective utilization of the MPEG information data, the DV format information data or the like or the extension of the field of utilization of the MPEG information data, the DV format information data or the like brings about, for example, further progress of technology in the field of electronic apparatus for professional use and home use.

However, any practical embodiment of digital data transmitting system by which a plurality of MPEG information data, DV format information data or the like are multiplexed and transmitted in such a manner that 8-bit word sequence data containing word synchronous data are formed based on a plurality of MPEG information data, DV format information data or the like to be transmitted and then subjected to 8B/10B conversion to produce 10-bit word sequence data and the 10-bit word sequence data thus produced are further converted into serial data to be transmitted in a transmitting side, so as to be surely and separately reproduced at a receiving side, has not been previously found. Further, any literature or thesis disclosing the digital data transmitting system which can multiplex and transmit a plurality of MPEG information data, DV format information data or the like in such a manner as mentioned above, has not been previously found also.

In the field of video signals, there have been proposed several digital video signals standardized for digital transmission of video signals. For example, 4:2:2 component digital video signal (hereinafter, referred to a D1 signal) and 4 fsc composite digital video signal (hereinafter, referred to a D2 signal) are known as the standardized digital video signals.

The D1 signal or the D2 signal is formed with a Y data sequence in the form of 10-bit word sequence data representing a luminance signal component of a video signal and a CB/CR data sequence in the form of 10-bit word sequence data representing a chrominance signal component of the video signal, which are word-multiplexed with each other to produce a word multiplex data sequence. Predetermined portions of the word multiplex data sequence are replaced with time reference code data SAV (Start of Active Video) and time reference code data EAV (End of Active Video). The SAV and EAV serve as word synchronous data.

In FIG. 3, portions of the 10-bit word sequence data corresponding to a horizontal blanking period and periods just before and after the horizontal blanking period within a horizontal period. In the portions shown in FIG. 3, the SAV which has the time reference code and is formed with four words (3ff,000,000,XYZ) each composed of 10 bits is located just before the portion corresponding to a video data period and the EAV which has the time reference code and is formed with four words (3FF,000,000,XYZ) each composed of 10 bits is located just after the portion corresponding to the video data period. The 3FF and 000 are hexadecimal numbers and representing fixed value information, respectively, and the XYZ are a hexadecimal number and identifying the field period, the field blanking period, the SAV and the EAV.

When the D1 signal formed with the 10-bit word sequence data as shown FIG. 3 is transmitted, the 10-bit word sequence data are subjected to P/S conversion to produce serial data to be transmitted. In a receiving portion, portions corresponding to the SAV and the EAV contained in the serial data received therein are detected. The 10-bit word sequence data constituting the D1 signal are subjected to the S/P conversion to reproduce the D1 signal under the condition in which word synchronization is taken with the detected portions corresponding to the SAV and the EAV.

There has been also proposed a data interface called Serial Data Transport Interface (SDTI) for transmitting compressed digital image information data such as the MPEG image information data, as aforementioned, in the form of serial data through a transmission line. The SDTI has been standardized as “SMPTE 305M” by the Society of Motion Picture and Television Engineers (SMPTE) in the United States.

In a signal format according to the SDTI (hereinafter, referred to a SDTI signal format), time standard code data are located at each of portions corresponding to horizontal periods, respectively, as occasion demands. The digital signal formed in accordance with the SDTI signal format (hereinafter, referred to a SDTI signal) which is used for transmitting the compressed digital video signal data or video and audio signal data is subjected to P/S conversion to produce serial data to be transmitted in the form of electronic signals or optical signals.

On the occasion of transmission of the D1 signal, D2 signal, SDTI signal or the like formed as described above, in order to make it possible to utilize effectively existing integrated circuit devices previously developed for construction of data transmitting and receiving circuits for digital video signals, it is desired that word sequence data containing word synchronous data and subjected to 8B/10B conversion are formed based on data to be transmitted and the word sequence data thus produced are converted into serial data to be transmitted in a transmitting side.

Under the situation in which word sequence data containing word synchronous data and subjected to 8B/10B conversion are formed based on data to be transmitted and the word sequence data thus produced are converted into serial data to be transmitted in a transmitting side, if a plurality of digital video signals, such as the D1 signals, D2 signals, SDTI signals or the like, can be so multiplexed and transmitted as to be surely and separately reproduced at a receiving side in addition to transmission of a single video signal, the video signals, such as the D1 signals, D2 signals, SDTI signals or the like, are utilized more effectively and the field of utilization of the digital video signals is desirably extended. The effective utilization of the digital video signals or the extension of the field of utilization of the digital video signals brings about, for example, further progress of technology in the field of electronic apparatus for professional use and home use.

However, any practical embodiment of digital data transmitting system by which a plurality of digital video signals, such as the D1 signals, D2 signals, SDTI signals or the like, are multiplexed and transmitted in such a manner that word sequence data containing word synchronous data and subjected to 8B/10B conversion are formed based on a plurality of digital video signals, such as the D1 signals, D2 signals, SDTI signals or the like to be transmitted and the word sequence data thus produced are converted into serial data to be transmitted in a transmitting side, so as to be surely and separately reproduced at a receiving side, has not been previously found. Further, any literature or thesis disclosing the digital data transmitting system which can multiplex and transmit a plurality of digital video signals, such as the D1 signals, D2 signals, SDTI signals or the like, in such a manner as mentioned above, has not been previously found also.

In the field of video signals, there has been also proposed the HD signal as aforementioned as one of the standardized digital video signals. The HD signal is formed, for example, in accordance with such data formats as shown in FIGS. 4A and 4B.

The data formats shown in FIGS. 4A and 4B include a Y data sequence as shown in FIG. 4A, which represents a luminance signal component of a video signal and a PB/PR data sequence as shown in FIG. 4B, which represents color difference signal components of the video signal. Each of data words constituting the Y data sequence or the PB/PR data sequence is composed of 10 bits. Namely, each of the Y data sequence and the PB/PR data sequence is formed into 10-bit word sequence data. A part of the Y data sequence which includes a portion corresponding to a horizontal blanking period and parts of portions corresponding to a couple of video data periods appearing before and after the horizontal blanking period in a horizontal period of the Y data sequence is shown in FIG. 4A. Similarly, a part of the PB/PR data sequence which includes a portion corresponding to a horizontal blanking period and parts of portions corresponding to a couple of video data periods appearing before and after the horizontal blanking period in a horizontal period of the PB/PR data sequence is shown in FIG. 4B.

In the Y data sequence shown in FIG. 4A, time reference code data SAV which are composed of four 10-bit words (3FF(Y), 000(Y), 000(Y), XYZ(Y): 3FF and 000 are hexadecimal numbers and (Y) indicates a word contained in the Y data sequence) are provided just before a portion corresponding to the video data period and another time reference code data EAV which are composed of four 10-bit words (3FF(Y), 000(Y), 000(Y), XYZ(Y)) are provided just after the portion corresponding to the video data period. Similarly, in the PB/PR data sequence shown in FIG. 4B, time reference code data SAV which are composed of four 10-bit words (3FF(C), 000(C), 000(C), XYZ(C): 3FF and 000 are hexadecimal numbers and (C) indicates a word contained in the PB/PR data sequence) are provided just before a portion corresponding to the video data period and another time reference code data EAV which are composed of four 10-bit words (3FF(C), 000(C), 000(C), XYZ(C)) are provided just after the portion corresponding to the video data period. The time reference code data EAV and SAV contained in the Y data sequence are provided in a portion corresponding to the horizontal blanking period of the Y data sequence and the time reference code data EAV and SAV contained in the PB/PR data sequence are provided in a portion corresponding to the horizontal blanking period of the PB/PR data sequence.

When the Y data sequence and the PB/PR data sequence are transmitted, the Y data sequence and the PB/PR data sequence are subjected to word-multiplexing treatment under a condition in which the portion corresponding to the horizontal blanking period of the Y data sequence in which the time reference code data EAV and SAV are contained is synchronized with the portion corresponding to the horizontal blanking period of the PB/PR data sequence in which the time reference code data EAV and SAV are contained, so as to produce word multiplex data sequence formed into 10-bit word sequence data, as shown in FIG. 5, and the digital video signal in the form of 10-bit word sequence data formed in accordance with the data format of the word multiplex data sequence shown in FIG. 5 is converted into serial data to be transmitted.

In the word multiplex data sequence shown in FIG. 5, multiplex time reference code data (multiplex SAV) which are composed of eight 10-bit words (3FF(C), 3FF(Y), 000(C), 000(Y), 000(C), 000(Y), XYZ(C), XYZ(Y)) are provided just before a portion corresponding to the video data period and another multiplex time reference code data (multiplex EAV) which are composed of eight 10-bit words (3FF(C), 3FF(Y), 000(C), 000(Y), 000(C), 000(Y), XYZ(C), XYZ(Y)) are provided just after the portion corresponding to the video data period.

On the occasion of transmission of the HD signal including the Y data sequence and the PB/PR data sequence as described above, in order to make it possible to utilize effectively existing integrated circuit devices previously developed for construction of data transmitting and receiving circuits for digital video signals, it is desired that word sequence data containing word synchronous data allotted a predetermined specific code, such as K 28.5, and subjected to 8B/10B conversion are formed based on data to be transmitted and the word sequence data thus produced are converted into serial data to be transmitted in a transmitting side.

Considering that it is presumable that in the near future the digital video signal is transmitted in the form of serial digital data at the bit transmission rate which is selected to be extremely high under a condition in which it is strongly desired that the digital video signal formed in accordance with the data format of the word multiplex data sequence is transmitted in such a manner that word sequence data containing word synchronous data allotted a predetermined specific code and subjected to 8B/10B conversion are formed based on data representing a digital video signal to be transmitted and the word sequence data thus produced are converted into serial data to be transmitted in a transmitting side, if it is possible to transmit not only digital data formed into a single channel for representing a digital video signal but also digital data divided into a plurality of channels for representing a digital video signal, the data transmitting and receiving circuits used for the transmission of the digital video signal can be constructed with effective utilization of the existing integrated circuit devices previously developed and the digital video signal is utilized more effectively and the field of utilization of the digital video signal is desirably extended. The effective utilization of the digital video signal or the extension of the field of utilization of the digital video signal brings about further progress of technology in the field of electronic apparatus for professional use and home use.

However, any practical embodiment of digital data transmission system which can transmit digital data divided into a plurality of channels for representing a digital video signal in such a manner that a plurality of word sequence data each containing word synchronous data allotted a predetermined specific code and subjected to 8B/10B conversion are formed based on the digital data divided into a plurality of channels to be transmitted and the word sequence data thus produced are further converted into serial data to be transmitted in a transmitting side, has not been previously found.

Further, any literature or thesis disclosing the digital data transmission system which can transmit the multiplex digital data formed with the digital data divided into a plurality of channels for representing the digital video signal in the manner mentioned above, has not been previously found also.

### OBJECTS AND SUMMARY OF THE INVENTION

Accordingly, it is an object of the present invention to provide a method of transmitting digital data, in which word sequence data including word synchronous data and subjected to 8B/10B conversion are produced for representing image or image and other information and converted into serial digital data to be transmitted, and which avoids the aforementioned disadvantages encountered with the prior art.

It is another object of the present invention to provide a method of transmitting digital data, in which word sequence data including word synchronous data and subjected to 8B/10B conversion are produced for representing image or image and other information and converted into serial digital data to be transmitted through a data transmission line, and by which a plurality of compressed digital video or video and audio signal data, such as MPEG image information data, DV format image information data or the like, can be transmitted in such a manner that 8-bit word sequence data containing word synchronous data are formed based on the compressed digital video or video and audio signal data to be transmitted and then subjected to 8B/10B conversion to produce 10-bit word sequence data and the 10-bit word sequence data thus produced are further converted into serial data to be transmitted.

It is a further object of the present invention to provide a method of transmitting digital data, in which word sequence data including word synchronous data and subjected to 8B/10B conversion are produced for representing image information and converted into serial digital data to be transmitted through a data transmission line, and by which a plurality of digital video signals, such as the D1 signals, D2 signals, SDTI signals or the like, can be transmitted in such a manner that word sequence data containing word synchronous data and subjected to 8B/10B conversion are formed based on the digital video signals to be transmitted and the word sequence data thus produced are converted into serial data to be transmitted.

It is a further object of the present invention to provide a method of transmitting digital data, in which word sequence data including word synchronous data and subjected to 8B/10B conversion are produced for representing image information and converted into serial digital data to be transmitted, and by which digital data divided into a plurality of channels for representing a digital video signal, such as a HD signal, can be transmitted in such a manner that a plurality of word sequence data each containing word synchronous data allotted a predetermined specific code, such as K 28.5 as aforementioned, and subjected to 8B/10B conversion are produced based on the digital data divided into a plurality of channels to be transmitted and the sequence data thus produced are converted into serial data to be transmitted.

It is a further object of the present invention to provide an apparatus for transmitting digital data, in which word sequence data including word synchronous data and subjected to 8B/10B conversion are produced for representing image information and converted into serial digital data to be transmitted, and which avoids the aforementioned disadvantages encountered with the prior art.

It is a further object of the present invention to provide an apparatus for transmitting digital data, in which word sequence data including word synchronous data and subjected to 8B/10B conversion are produced for representing image information and converted into serial digital data to be transmitted through a data transmission line, and by which a plurality of compressed digital video or video and audio signal data, such as MPEG image information data, DV format image information data or the like, can be transmitted in such a manner that 8-bit word sequence data containing word synchronous data are formed based on the compressed digital image information data to be transmitted and then subjected to 8B/10B conversion to produce 10-bit word sequence data and the 10-bit word sequence data thus produced are further converted into serial data to be transmitted.

It is a further object of the present invention to provide an apparatus for transmitting digital data, in which word sequence data including word synchronous data and subjected to 8B/10B conversion are produced for representing image information and converted into serial digital data to be transmitted through a data transmission line, and by which a plurality of digital video signals, such as the D1 signals, D2 signals, SDTI signals or the like, can be transmitted in such a manner that word sequence data containing word synchronous data and subjected to 8B/10B conversion are formed based on the digital video signals to be transmitted and the word sequence data thus produced are converted into serial data to be transmitted.

It is a still further object of the present invention to provide a method of transmitting digital data, in which word sequence data including word synchronous data and subjected to 8B/10B conversion are produced for representing image information and converted into serial digital data to be transmitted, and by which digital data divided into a plurality of channels for representing a digital video signal, such as a HD signal, are transmitted in such a manner that a plurality of word sequence data each containing word synchronous data allotted a predetermined specific code, such as K 28.5 as aforementioned, and subjected to 8B/10B conversion are produced based on the digital data divided into a plurality of channels to be transmitted and the sequence data thus produced are converted into serial data to be transmitted.

According to a first aspect of the present invention, there is provided a method of transmitting digital data, which comprises the steps of multiplexing a plurality of compressed digital video or video and audio signal data to produce 8-bit word sequence data, combining an additional word data group including 8-bit word synchronous data allotted a predetermined specific code with the 8-bit word sequence data to produce composite 8-bit word sequence data in which the additional word data group is repeatedly inserted at predetermined word intervals, causing the composite 8-bit word sequence data to be subjected to 8B/10B conversion to produce composite 10-bit word sequence data having a portion formed based on the additional word data group including 10-bit word synchronous data provided with running disparity not neutral, converting the composite 10-bit word sequence data into serial data, and transmitting the serial data.

In one embodiment of the first aspect of the present invention, the compressed digital video or video and audio signal data are digital image or image and sound information data subjected to data compression by means of high efficient coding.

According to a second aspect of the present invention, there is provided a method of transmitting digital data, which comprises the steps of multiplexing a plurality of digital video signals or combinations of a plurality of digital video signals and a bit adding signal to produce word sequence data, inserting an additional word data group including word synchronous data allotted a predetermined specific code into the word sequence data at predetermined word intervals thereof to produce composite word sequence data, causing the composite word sequence data to be subjected to 8B/10B conversion to produce converted composite word sequence data having a portion formed based on the additional word data group to include converted word synchronous data provided with running disparity not neutral, converting the converted composite word sequence data into serial data, and transmitting the serial data.

In one embodiment of the second aspect of the present invention, each of the digital video signals is provided in the form of 10-bit word sequence data.

According to a third aspect of the present invention, there is provided a method of transmitting digital data, which comprises the steps of multiplexing a plurality of digital video signals or combinations of a plurality of digital video signals and a bit adding signal to produce word sequence data, inserting an additional word data group having at least a couple of portions each including word synchronous data allotted a predetermined specific code and ancillary word data into the word sequence data at predetermined word intervals thereof to produce composite word sequence data, causing the composite word sequence data to be subjected to 8B/10B conversion to produce converted composite word sequence data having a portion formed based on the additional word data group to include at least a couple of converted word synchronous data each provided with running disparity not neutral, converting the converted composite word sequence data into serial data, and transmitting the serial data.

In one embodiment of the third aspect of the present invention, the ancillary word data are converted through the 8B/10B conversion into word data of neutral running disparity.

According to a fourth aspect of the present invention, there is provided a method of transmitting digital data, which comprises the steps of obtaining first and second 8-bit word sequence data based on first and second digital information data forming a digital video signal, respectively, inserting an additional word data group including 8-bit word synchronous data allotted a predetermined specific code into each of the first and second 8-bit word sequence data at predetermined word intervals thereof to produce first and second composite 8-bit word sequence data, causing each of the first and second composite 8-bit word sequence data to be subjected to 8B/10B conversion to produce first and second composite 10-bit word sequence data each having a portion formed based on the additional word data group to include 10-bit word synchronous data allotted a predetermined specific code obtained based on the 8-bit word synchronous data, converting the first and second composite 10-bit word sequence data into first and second serial data, respectively, and transmitting the first and second serial data.

In one embodiment of the fourth aspect of the present invention, the first and second digital information data are obtained by dividing the digital video signal into a couple of data sequence.

According to a fifth aspect of the present invention, there is provided a method of causing a digital video signal to be subjected to bit-dividing to produce first, second and third divided-bit word sequence data, inserting an additional word data group including 8-bit word synchronous data allotted a predetermined specific code into each of the first, second and third divided-bit word sequence data at predetermined word intervals thereof to produce first, second and third composite 8-bit word sequence data, causing each of the first, second and third composite 8-bit word sequence data to be subjected to 8B/10B conversion to produce first, second and third composite 10-bit word sequence data each having a portion formed based on the additional word data group to include 10-bit word synchronous data allotted a predetermined specific code obtained based on the 8-bit word synchronous data, converting the first, second and third composite 10-bit word sequence data into first, second and third serial data, respectively, and transmitting the first, second and third serial data.

In one embodiment of the fifth aspect of the present invention, the first, second and third divided-bit word sequence data are formed into 8-bit word sequence data, 8-bit word sequence data and 4-bit word sequence data, respectively, and additional 4-bit word sequence data are added to the third divider-bit word sequence data.

According to a sixth aspect of the present invention, there is provided an apparatus for transmitting digital data, which comprises data multiplexing means for multiplexing a plurality of compressed digital video or video and audio signal data to produce 8-bit word sequence data, composite 8-bit word sequence data producing means for combining an additional word data group including 8-bit word synchronous data allotted a predetermined specific code with the 8-bit word sequence data to produce composite 8-bit word sequence data in which the additional word data group is repeatedly inserted at predetermined word intervals, serial data producing means operative to cause the composite 8-bit word sequence data to be subjected to 8B/10B conversion to produce composite 10-bit word sequence data having a portion formed based on the additional word data group including 10-bit word synchronous data provided with running disparity not neutral and to convert the composite 10-bit word sequence data into serial data, and data transmitting means for transmitting the serial data.

The apparatus according to the sixth aspect of the present invention is used for putting the method according to the first aspect of the present invention into practice.

According to a seventh aspect of the present invention, there is provided an apparatus for transmitting digital data, which comprises data multiplexing means for multiplexing a plurality of digital video signals or combinations of a plurality of digital video signals and a bit adding signal to produce word sequence data, composite word sequence data producing means for inserting an additional word data group including word synchronous data allotted a predetermined specific code into the word sequence data at predetermined word intervals thereof to produce composite word sequence data, serial data producing means operative to cause the composite word sequence data to be subjected to 8B/10B conversion to produce converted composite word sequence data having a portion formed based on the additional word data group to include converted word synchronous data provided with running disparity not neutral and to convert the converted composite word sequence data into serial data, and data transmitting means for transmitting the serial data.

The apparatus according to the seventh aspect of the present invention is used for putting the method according to the second aspect of the present invention into practice.

According to an eighth aspect of the present invention, there is provided an apparatus for transmitting digital data, which comprises data multiplexing means for multiplexing a plurality of digital video signals or combinations of a plurality of digital video signals and a bit adding signal to produce word sequence data, composite word sequence data producing means for inserting an additional word data group having at least a couple of portions each including word synchronous data allotted a predetermined specific code and ancillary word data into the word sequence data at predetermined word intervals thereof to produce composite word sequence data, serial data producing means operative to cause the composite word sequence data to be subjected to 8B/10B conversion to produce converted composite word sequence data having a portion formed based on the additional word data group to include at least a couple of converted word synchronous data each provided with running disparity not neutral and to convert the converted composite word sequence data into serial data, and data transmitting means for transmitting the serial data.

The apparatus according to the eighth aspect of the present invention is used for putting the method according to the third aspect of the present invention into practice.

According to a ninth aspect of the present invention, there is provided an apparatus for transmitting digital data, which comprises 8-bit word data producing means for obtaining first and second 8-bit word sequence data based on first and second digital information data forming a digital video signal, respectively, composite 8-bit word data producing means for inserting an additional word data group including 8-bit word synchronous data allotted a predetermined specific code into each of the first and second 8-bit word sequence data at predetermined word intervals thereof to produce first and second composite 8-bit word sequence data, serial data producing means operative to cause each of the first and second composite 8-bit word sequence data to be subjected to 8B/10B conversion to produce first and second composite 10-bit word sequence data each having a portion formed based on the additional word data group to include 10-bit word synchronous data allotted a predetermined specific code obtained based on the 8-bit word synchronous data and to convert the first and second composite 10-bit word sequence data into first and second serial data, respectively, and data transmitting means for transmitting the first and second serial data.

The apparatus according to the ninth aspect of the present invention is used for putting the method according to the fourth aspect of the present invention into practice.

According to a tenth aspect of the present invention, there is provided an apparatus for transmitting digital data, which comprises bit dividing means for causing a digital video signal to be subjected to bit-dividing to produce first, second and third divided-bit word sequence data, composite 8-bit word sequence data producing means for inserting an additional word data group including 8-bit word synchronous data allotted a predetermined specific code into each of the first, second and third divided-bit word sequence data at predetermined word intervals thereof to produce first, second and third composite 8-bit word sequence data, serial data producing means operative to cause each of the first, second and third composite 8-bit word sequence data to be subjected to 8B/10B conversion to produce first, second and third composite 10-bit word sequence data each having a portion formed based on the additional word data group to include 10-bit word synchronous data allotted a predetermined specific code obtained based on the 8-bit word synchronous data and to convert the first, second and third composite 10-bit word sequence data into first, second and third serial data, respectively, and data transmitting means for transmitting the first, second and third serial data.

The apparatus according to the tenth aspect of the present invention is used for putting the method according to the fifth aspect of the present invention into practice.

With the method of or apparatus for transmitting digital data thus constituted in accordance with one of the first to tenth aspects of the present invention, a plurality of compressed digital video or video and audio signal data, a plurality of digital video signals or combinations of a plurality of digital video signals and a bit adding signal, or a plurality of digital information data forming a digital video signal can be transmitted in such a manner that word sequence data containing word synchronous data allotted a predetermined specific code and subjected to 8B/10B conversion are formed based on the data or signals to be transmitted and the word sequence data thus produced are converted into serial data to be transmitted in a transmitting side, so as to be surely and separately reproduced at a receiving side.

The above and other objects, features and advantages of the present invention will become apparent from the following detailed description which is to be read in conjunction with the accompanying drawings.

### BRIEF DESCRIPTION OF THE DRAWINGS

FIG. 1 is a conceptive chart showing an example of a frame used for transmission of digital data;

FIG. 2 is a conceptive chart showing examples of word synchronous data used for transmission of digital data;

FIG. 3 are a time chart used for explanation of an example of a data format for a digital video signal;

FIGS. 4A and 4B are time charts used for explanation of another example of a data format for a digital video signal;

FIG. 5 is a time chart used for explanation of a further example of a data format for a digital video signal;

FIG. 6 is a schematic block diagram showing a first embodiment of apparatus for transmitting digital data according to the present invention, in which a first embodiment of method of transmitting digital data according to the present invention is carried out;

FIGS. 7A and 7B are time charts used for explaining the first embodiment of method of transmitting digital data according to the present invention;

FIG. 8 is a schematic block diagram showing an embodiment of a transmission rate converting and data inserting portion provided in the apparatus shown in FIG. 6;

FIGS. 9A to 9C are time charts used for explanation of the method carried out in the apparatus shown in FIG. 6;

FIGS. 10A to 10C are time charts used for explanation of the method carried out in the apparatus shown in FIG. 6;

FIG. 11 is a schematic block diagram showing a second embodiment of apparatus for transmitting digital data according to the present invention, in which a second embodiment of method of transmitting digital data according to the present invention is carried out;

FIGS. 12A and 12B are time charts used for explaining the second embodiment of method of transmitting digital data according to the present invention;

FIG. 13 is a schematic block diagram showing an embodiment of data receiving apparatus for receiving a signal transmitted from the apparatus shown in FIG. 6;

FIGS. 14A to 14D are time charts used for explanation of an operation of the data receiving apparatus shown in FIG. 13;

FIGS. 15A to 15D are time charts used for explanation of an operation of the data receiving apparatus shown in FIG. 13;

FIG. 16 is a schematic block diagram showing an embodiment of data receiving apparatus for receiving a signal transmitted from the apparatus shown in FIG. 11;

FIG. 17 is a schematic block diagram showing a third embodiment of apparatus for transmitting digital data according to the present invention, in which a third embodiment of method of transmitting digital data according to the present invention is carried out;

FIG. 18 is a time chart used for explaining the third embodiment of method of transmitting digital data according to the present invention;

FIG. 19 is a conceptive chart showing examples of 8-bit word ancillary data used in the third embodiment of method of transmitting digital data according to the present invention;

FIGS. 20A to 20C are time charts used for explaining the third embodiment of method of transmitting digital data according to the present invention;

FIGS. 21A to 21C are time charts used for explaining the third embodiment of method of transmitting digital data according to the present invention;

FIG. 22 is a schematic block diagram showing a fourth embodiment of apparatus for transmitting digital data according to the present invention, in which a fourth embodiment of method of transmitting digital data according to the present invention is carried out;

FIG. 23 is a schematic block diagram showing an embodiment of a transmission rate converting and data inserting portion provided in the apparatus shown in FIG. 22;

FIGS. 24A to 24C are time charts used for explaining the fourth embodiment of method of transmitting digital data according to the present invention;

FIG. 25 is a schematic block diagram showing an embodiment of data receiving apparatus for receiving a signal transmitted from the apparatus shown in FIG. 17;

FIGS. 26A to 26D are time charts used for explanation of an operation of the data receiving apparatus shown in FIG. 25;

FIG. 27 is a schematic block diagram showing an embodiment of data receiving apparatus for receiving a signal transmitted from the apparatus shown in FIG. 22;

FIGS. 28A to 28D are time charts used for explanation of an operation of the data receiving apparatus shown in FIG. 27;

FIG. 29 is a schematic block diagram showing a fifth embodiment of apparatus for transmitting digital data according to the present invention, in which a fifth embodiment of method of transmitting digital data according to the present invention is carried out;

FIG. 30 is a time chart used for explaining the fifth embodiment of method of transmitting digital data according to the present invention;

FIGS. 31A to 31C are time charts used for explaining the fifth embodiment of method of transmitting digital data according to the present invention;

FIGS. 32A to 32C are time charts used for explaining the fifth embodiment of method of transmitting digital data according to the present invention;

FIG. 33 is a schematic block diagram showing an embodiment of data receiving apparatus for receiving a signal transmitted from the apparatus shown in FIG. 29;

FIGS. 34A to 34D are time charts used for explanation of an operation of the data receiving apparatus shown in FIG. 33;

FIG. 35 is a schematic block diagram showing a sixth embodiment of apparatus for transmitting digital data according to the present invention, in which a sixth embodiment of method of transmitting digital data according to the present invention is carried out;

FIGS. 36 to 43 are time charts used for explaining the sixth embodiment of method of transmitting digital data according to the present invention;

FIG. 44 is a schematic block diagram showing a seventh embodiment of apparatus for transmitting digital data according to the present invention, in which a seventh embodiment of method of transmitting digital data according to the present invention is carried out;

FIGS. 45 and 46 are schematic block diagrams showing respectively embodiments of transmission rate converting and data inserting portions provided in the apparatus shown in FIG. 44;

FIGS. 47 to 50 are time charts used for explaining the seventh embodiment of method of transmitting digital data according to the present invention;

FIG. 51 is a schematic block diagram showing an eighth embodiment of apparatus for transmitting digital data according to the present invention, in which an eighth embodiment of method of transmitting digital data according to the present invention is carried out;

FIG. 52 is a schematic block diagram showing a part of a ninth embodiment of apparatus for transmitting digital data according to the present invention, in which a ninth embodiment of method of transmitting digital data according to the present invention is carried out;

FIG. 53 is a schematic block diagram showing another part of the ninth embodiment of apparatus for transmitting digital data according to the present invention, in which the ninth embodiment of method of transmitting digital data according to the present invention is carried out;

FIG. 54 is a schematic block diagram showing an embodiment of data receiving apparatus for receiving a signal transmitted from the apparatus shown in FIG. 35;

FIGS. 55A, 55B, 56A and 56B are time charts used for explanation of an operation of the data receiving apparatus shown in FIG. 54;

FIG. 57 is a schematic block diagram showing an embodiment of data receiving apparatus for receiving a signal transmitted from the apparatus shown in FIG. 44;

FIGS. 58A, 58B, 59A and 59B are time charts used for explanation of an operation of the data receiving apparatus shown in FIG. 57;

FIG. 60 is a schematic block diagram showing an embodiment of data receiving apparatus for receiving a signal transmitted from the apparatus shown in FIG. 51;

FIG. 61 is a schematic block diagram showing a part of an embodiment of data receiving apparatus for receiving a signal transmitted from the apparatus shown in FIGS. 52 and 53; and

FIG. 62 is a schematic block diagram showing another part of the embodiment of data receiving apparatus for receiving the signal transmitted from the apparatus shown in FIGS. 52 and 53.

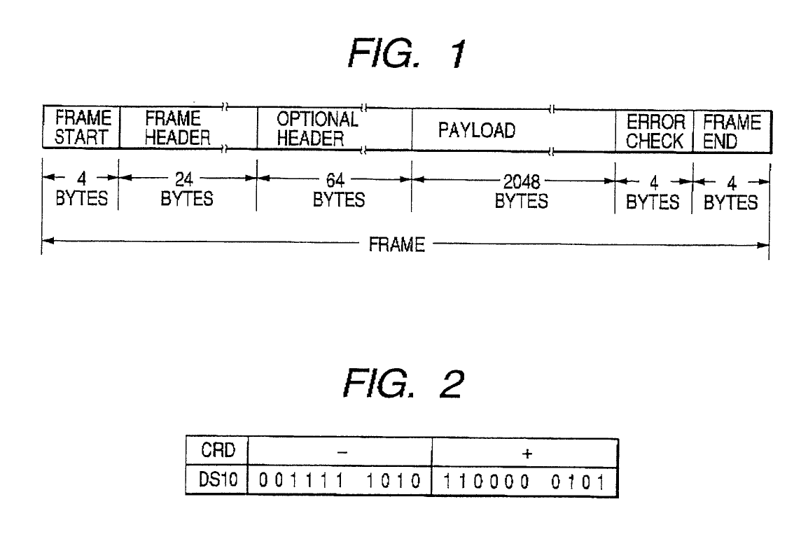

### DESCRIPTION OF THE PREFERRED EMBODIMENTS

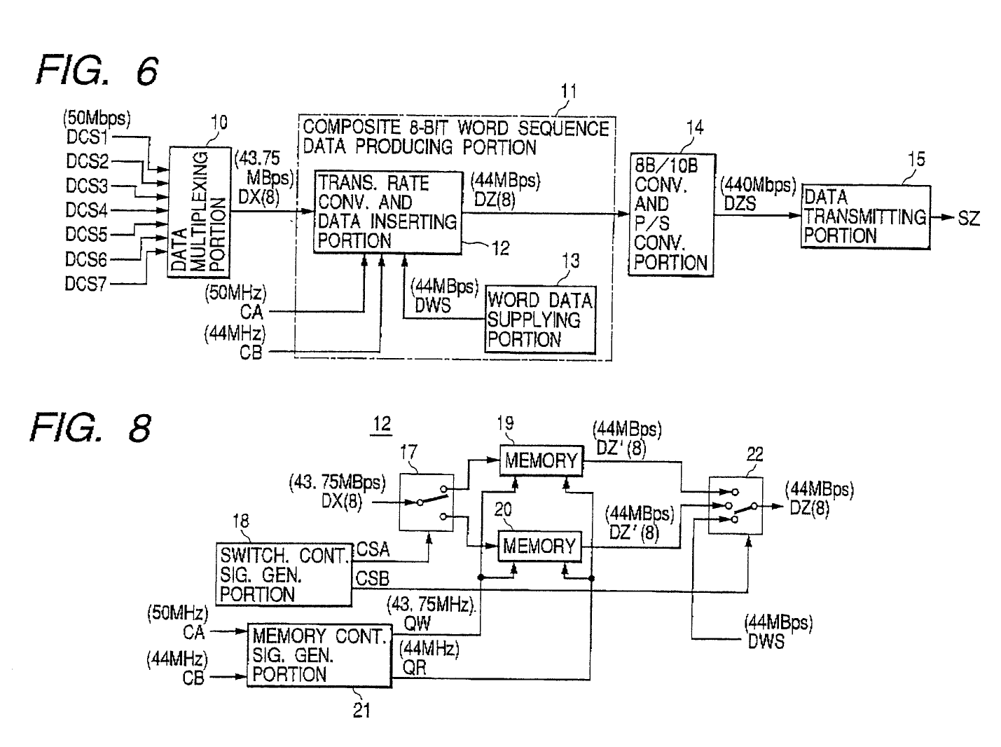

FIG. 6 shows a first embodiment of apparatus for transmitting digital data according to the present invention, in which a first embodiment of method of transmitting digital data according to the present invention is carried out.

Referring to FIG. 6, seven channels of HD type DV format information data (hereinafter, referred merely to DV format data) DCS1 to DCS7 are supplied to a data multiplexing portion 10. Each of the DV format data DCS1 to DCS7 are compressed digital video or video and audio signal data in the form of serial data having the bit transmission rate of, for example, 50 Mbps, which are obtained by converting DV format information data in the form of 8-bit word sequence data having the word transmission rate of, for example, 6.25 MBps into serial data.

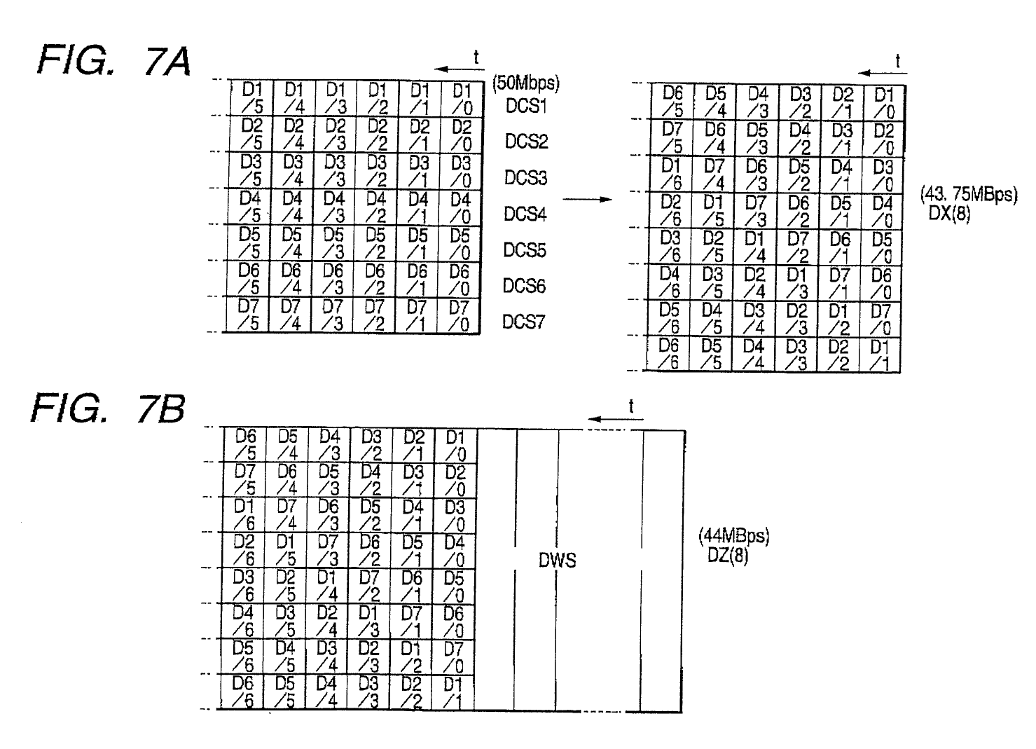

In the data multiplexing portion 10, as shown in FIG. 7A, for example, every bit constituting each of the DV format data DCS1 which come in the form of bit sequence D1/0, D1/1, D1/2, D1/3, D1/4, D1/5, . . . transmitted at the bit transmission rate of 50 Mbps, the DV format data DCS2 which come in the form of bit sequence D2/0, D2/1, D2/2, D2/3, D2/4, D2/5, . . . transmitted at the bit transmission rate of 50 Mbps the DV format data DCS3 which come in the form of bit sequence D3/0, D3/1, D3/2, D3/3, D3/4, D3/5, . . . transmitted at the bit transmission rate of 50 Mbps, the DV format data DCS4 which come in the form of bit sequence D4/0, D4/1, D4/2, D4/3, D4/4, D4/5, . . . transmitted at the bit transmission rate of 50 Mbps , the DV format data DCS5 which come in the form of bit sequence D5/0, D5/1, D5/2, D5/3, D5/4, D5/5, . . . transmitted at the bit transmission rate of 50 Mbps, the DV format data DCS6 which come in the form of bit sequence D6/0, D6/1, D6/2, D6/3, D6/4, D6/5, . . . transmitted at the bit transmission rate of 50 Mbps, and the DV format data DCS7 which come in the form of bit sequence D7/0, D7/1, D7/2, D7/3, D7/4, D7/5, . . . transmitted at the bit transmission rate of 50 Mbps, is successively extracted one by one and every eight bits thus extracted are arranged to form a word successively so that 8-bit word sequence data DX(8) are produced at the word transmission rate of 50 Mbps×7/8=43.75 MBps. An arrow t in FIG. 7A represents elapsing time.

The 8-bit word sequence data DX(8) produced in the data multiplexing portion 10 to have the word transmission rate of 43.75 MBps are supplied to a composite 8-bit word sequence data producing portion 11. In the composite 8-bit word sequence data producing portion 11, the 8-bit word sequence data DX(8) are guided to a transmission rate converting and data inserting portion 12. A clock pulse signal CA which has the frequency of 50 MHz and is in synchronism with the clock signal of each of the DV format data DCS1 to DCS7 and another clock pulse signal CB having the frequency 44 MHz are supplied to the transmission rate converting and data inserting portion 12 in addition to the 8-bit word sequence data DX(8). Further, an additional word data group DWS which is constituted with a plurality of 8-bit word data including 8-bit word synchronous data allotted a predetermined specific code and has the word transmission rate of 44 MBps is also supplied to the transmission rate converting and data inserting portion 12 from a word data supplying portion 13.

In the transmission rate converting and data inserting portion 12, the word transmission rate of the 8-bit word sequence data DX(8) is converted from 43.75 MBps to 44 MBps and then the additional word data group DWS including the 8-bit word synchronous data from the word data supplying portion 13 is inserted into the 8-bit word sequence data DX(8) at predetermined word intervals thereof to produce 8-bit word sequence data DZ(8) having the word transmission rate of 44 MBps. That is, the composite 8-bit word sequence data DZ(8) are produced based on the DV format data DCS1 to DCS7 in the transmission rate converting and data inserting portion 12.

FIG. 8 shows an embodiment of the transmission rate converting and data inserting portion 12. In the embodiment shown in FIG. 8, the 8-bit word sequence data DX(8) obtained from the data multiplexing portion 10 are supplied to a switch 17. The switch 17 performs switching operations at every predetermined period, for example, every period of 1 ms in response to a control signal CSA supplied from a switching control signal generating portion 18 so as to supply alternately a memory 19 and a memory 20 with the 8-bit word sequence data DX(8) at every period of lms.

A memory control signal generating portion 21 to which the clock pulse signal CA having the frequency of 50 MHz and the clock pulse signal CB having the frequency of 44 MHz are supplied, is provided in relation to the memories 19 and 20. The memory control signal generating portion 21 is operative to produce a write control signal QW having the frequency of 50 MHz×7/8=43.75 MHz based on the clock pulse signal CA and a read control signal QR having the frequency of 44 MHz based on the clock pulse signal CB and to supply each of the memories 19 and 20 with the write control signal QW and the read control signal QR.

In the memory 19, the 8-bit word sequence data DX(8) are written to be stored at the word transmission rate of 43.75 MBps in accordance with the write control signal QW having the frequency of 43.75 MHz when the 8-bit word sequence data DX(8) are supplied through the switch 17 to the memory 19. Similarly, in the memory 20, the 8-bit word sequence data DX(8) are written to be stored at the word transmission rate of 43.75 MBps in accordance with the write control signal QW having the frequency of 43.75 MHz when the 8-bit word sequence data DX(8) are supplied through the switch 17 to the memory 20. Accordingly, the 8-bit word sequence data DX(8) having the word transmission rate of 43.75 MBps are written to be stored in the memories 19 and 20 alternately at every period of lms.

The 8-bit word sequence data DX(8) stored in the memory 19 during a certain period of 1 ms are read from the memory 19 during the next period of 1 ms in accordance with the read control signal QR having the frequency of 44 MHz so as to produce 8-bit word sequence data DZ′(8) having the word transmission rate of 44 MBps. The 8-bit word sequence data DZ′(8) thus obtained from the memory 19 are supplied to a switch 22. The 8-bit word sequence data DX(8) stored in the memory 20 during a certain period of 1 ms are read from the memory 20 during the next period of 1 ms in accordance with the read control signal QR having the frequency of 44 MHz so as to produce 8-bit word sequence data DZ′(8) having the word transmission rate of 44 MBps. The 8-bit word sequence data DZ′(8) thus obtained from the memory 20 are also supplied to the switch 22. The additional word data group DWS having the word transmission rate of 44 MBps is further supplied from the word data supplying portion 13 to the switch 22.

The switch 22 is operative to extract successively the additional word data group DWS having the word transmission rate of 44 MBps and supplied from the word data supplying portion 13, the 8-bit word sequence data DZ′(8) having the word transmission rate of 44 MBps and read from the memory 20 and the 8-bit word sequence data DZ′(8) having the word transmission rate of 44 MBps and read from the memory 19 at every predetermined period corresponding to a predetermined number of 8-bit word data, in response to a control signal CSB supplied from the switching control signal generating portion 18. As a result, the composite 8-bit word sequence data DZ(8), as shown in FIG. 7B, which are obtained by inserting the additional word data group DWS having the word transmission rate of 44 MBps into the 8-bit word sequence data DZ′(8) having the word transmission rate of 44 MBps at predetermined word intervals are derived from the switch 22. An arrow t in FIG. 7B represents also elapsing time.

An example of the additional word data group DWS supplied from the word data supplying portion 13, which is constituted with a plurality of 8-bit word data including 8-bit word synchronous data allotted the predetermined specific code and has the word transmission rate of 44 MBps, is formed to have at least one optional 8-bit word ancillary data DEX8, four 8-bit word data including two 8-bit word synchronous data DEK8 and two specific 8-bit word ancillary data DEA8 arranged alternately to follow the optional 8-bit word ancillary data DEX8, and another two optional 8-bit word ancillary data DEX8 following the four 8-bit word data including two 8-bit word synchronous data DEK8 and two specific 8-bit word ancillary data DEA8.

A portion of the composite 8-bit word sequence data DZ(8) in which the example of the additional word data group DWS mentioned above is inserted is shown in FIG. 9A. In FIG. 9A, DVV8 represents 8-bit word data contained in the 8-bit word sequence data DZ′(8) read from the memories 19 or 20.

Another example of the additional word data group DWS supplied from the word data supplying portion 13, which has the word transmission rate of 44 MBps, is formed to have a couple of groups of four 8-bit word data each including two 8-bit word synchronous data DEK8 and two specific 8-bit word ancillary data DEA8 arranged alternately and positioned at the beginning and end portions, respectively, and at lest one 8-bit word data operative to reverse the running disparity and positioned between the beginning and end portions.

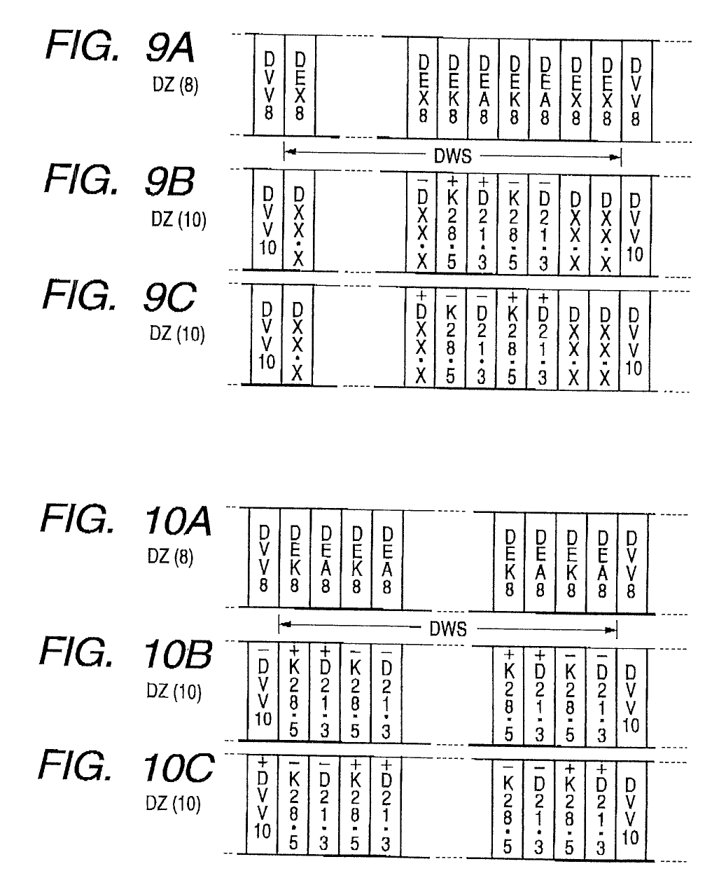

A portion of the composite 8-bit word sequence data DZ(8) in which another example of the additional word data group DWS mentioned above is inserted is shown in FIG. 10A. In FIG. 10A, DVV8 represents 8-bit word data contained in the 8-bit word sequence data DZ′(8) read from the memory 19 or 20.

The composite 8-bit word sequence data DZ(8) thus produced in the transmission rate converting and data inserting portion 12 are derived from the composite 8-bit word sequence data producing portion 11 to an 8B/10B converting and parallel to serial (P/S) converting portion 14. In the 8B/10B converting and P/S converting portion 14, the composite 8-bit word sequence data DZ(8) are subjected to 8B/10B conversion by which every eight bits constituting each word of the composite 8-bit word sequence data DZ(8) are converted into ten bits in accordance with a predetermined conversion table to produce composite 10-bit word sequence data DZ(10) having the word transmission rate of 44 MBps. In such 8B/10B conversion, the 8-bit word synchronous data DEK8 are converted into 10-bit word synchronous data K 28.5, the specific 8-bit word ancillary data DEA8 are converted into 10-bit word data D21.3, the optional 8-bit word ancillary data DEX8 are converted into 10-bit word data DXX.X, and the 8-bit word data DVV8 are converted into 10-bit word data DVV10. The 10-bit word data D21.3 are word data of the neutral running disparity.

Accordingly, if such an additional word data group DWS as shown in FIG. 9A is inserted into the composite 8-bit word sequence data DZ(8), a portion of the composite 10-bit word sequence data DZ(10) formed based on the additional word data group DWS are so formed as to be shown in FIG. 9B when the running disparity just before the first K28.5 is negative, and a portion of the composite 10-bit word sequence data DZ(10) formed based on the additional word data group DWS are so formed as to be shown in FIG. 9C when the running disparity just before the first K28.5 is positive.

Further, if such an additional word data group DWS as shown in FIG. 10A is inserted into the composite 8-bit word sequence data DZ(8), a portion of the composite 10-bit word sequence data DZ(10) formed based on the additional word data group DWS are so formed as to be shown in FIG. 10B when the running disparity just before the first K28.5 is negative, and a portion of the composite 10-bit word sequence data DZ(10) formed based on the additional word data group DWS are so formed as to be shown in FIG. 10C when the running disparity just before the first K28.5 is positive.

In addition to the above, in the 8B/10B converting and P/S converting portion 14, the composite 10-bit word sequence data DZ(10) which are obtained by causing the composite 8-bit word sequence data DZ(8) to be subjected to the 8B/10B conversion to have the word transmission rate of 44 MBps, are subjected to P/S conversion by which parallel data are converted into serial data to produce serial data DZS based on the composite 10-bit word sequence data DZ(10) and having the bit transmission rate of 44 MBps×10=440 Mbps. The serial data DZS thus obtained are supplied from the 8B/10B converting and P/S converting portion 14 to a data transmitting portion 15.

The data transmitting portion 15 is operative to convert the serial data DZS to a transmittal signal SZ which is, for example, an electric signal suitable for transmission through a data transmission line made of a coaxial cable or an optical signal suitable for transmission through a data transmission line made of an optical fiber, and to transmit the transmittal signal SZ through the data transmission line so that the serial data DZS are substantially transmitted.

In the embodiment shown in FIG. 6, the 8B/10B converting and P/S converting portion 14 and the data transmitting portion 15 are operative to cause the composite 8-bit word sequence data DZ(8) having the word transmission rate of 44 MBps to be subjected to the 8B/10B conversion to produce the composite 10-bit word sequence data DZ(10) having the word transmission rate of 44 MBps, to cause the composite 10-bit word sequence data DZ(10) to be subjected to the P/S conversion to produce the serial data DZS having the bit transmission rate 440 Mbps and to transmit the serial data DZS. Accordingly, the 8B/10B converting and P/S converting portion 14 and the data transmitting portion 15 can be constituted, for example, by utilizing effectively integrated circuit (IC) devices which have been previously proposed to be used for digital data transmission under the Fibre Channel System or the like. Consequently, a plurality of compressed digital video or video and audio signal data, for example, a plurality of DV format data, can be transmitted in such a manner that 8-bit word sequence data containing 8-bit word synchronous data are formed based on the compressed digital video or video and audio signal data to be transmitted and then subjected to 8B/10B conversion to produce 10-bit word sequence data containing 10-bit word synchronous data and the 10-bit word sequence data thus produced are further converted into serial data to be transmitted.

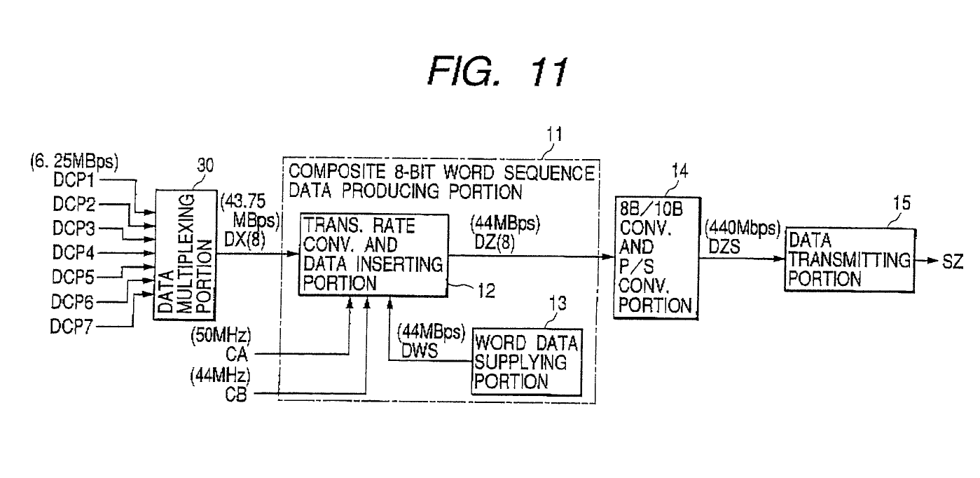

FIG. 11 shows a second embodiment of apparatus for transmitting digital data according to the present invention, in which a second embodiment of method of transmitting digital data according to the present invention is carried out.

Referring to FIG. 11, seven channels of DV format data DCP1 to DCP7 are supplied to a data multiplexing portion 30. Each of the DV format data DCP1 to DCP7 are compressed digital video or video and audio signal data in the form of 8-bit word sequence data having the word transmission rate of, for example, 6.25 MBps.

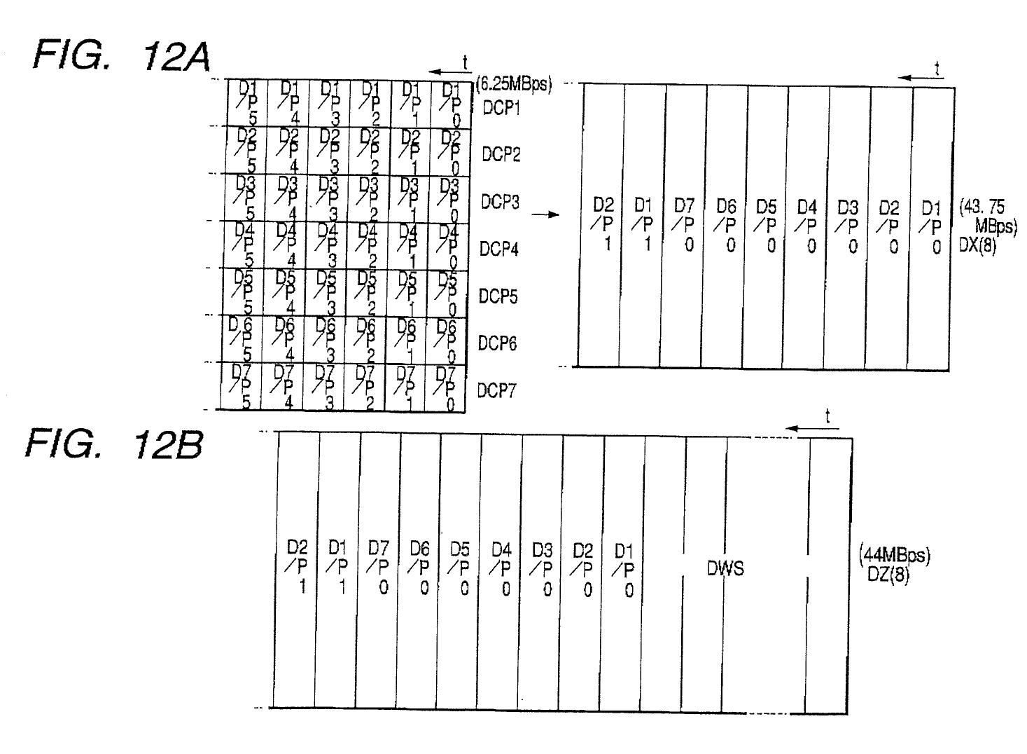

In the data multiplexing portion 30, as shown in FIG. 12A, for example, every 8-bit word constituting each of the DV format data DCP1 which come in the form of word sequence D1/P0, D1/P1, D1/P2, D1/P3, D1/P4, D1/P5, . . . transmitted at the word transmission rate of 6.25 MBps, the DV format data DCP2 which come in the form of word sequence D2/P0, D2/P1, D2/P2, D2/P3, D2/P4, D2/P5, . . . transmitted at the word transmission rate of 6.25 MBps, the DV format data DCP3 which come in the form of word sequence D3/P0, D3/P1, D3/P2, D3/P3, D3/P4, D3/P5, . . . transmitted at the word transmission rate of 6.25 MBps, the DV format data DCP4 which come in the form of word sequence D4/P0, D4/P1, D4/P2, D4/P3, D4/P4, D4/P5, . . . transmitted at the word transmission rate of 6.25 MBps, the DV format data DCP5 which come in the form of word sequence D5/P0, D5/P1, D5/P2, D5/P3, D5/P4, D5/P5, . . . transmitted at the word transmission rate of 6.25 MBps, the DV format data DCP6 which come in the form of word sequence D6/P0, D6/P1, D6/P2, D6/P3, D6/P4, D6/P5, . . . transmitted at the word transmission rate of 6.25 MBps, and the DV format data DCP7 which come in the form of word sequence D7/P0, D7/1, D7/P2, D7/P3, D7/P4, D7/P5, . . . transmitted at the word transmission rate of 6.25 MBps, is successively extracted one by one so that 8-bit word sequence data DX(8) are produced at the word transmission rate of 6.25 Mbps×7=43.75 MBps. An arrow t in FIG. 12A represents elapsing time.

The 8-bit word sequence data DX(8) produced in the data multiplexing portion 30 to have the word transmission rate of 43.75 MBps are supplied to a composite 8-bit word sequence data producing portion 11. The composite 8-bit word sequence data producing portion 11 is constituted in the same manner as that shown in FIG. 6 to include a transmission rate converting and data inserting portion 12 and a word data supplying portion 13 for supplying with additional word data group DWS at the word transmission rate of 44 MBps. In the composite 8-bit word sequence data producing portion 11, the 8-bit word sequence data DX(8) obtained from the data multiplexing portion 30 are processed in the same manner that the 8-bit word sequence data DX(8) obtained from the data multiplexing portion 10 are processed in the composite 8-bit word sequence data producing portion 11 shown in FIG. 6. (The contents of the additional word data group DWS supplied from the word data supplying portion 13 and the operation of the transmission rate converting and data inserting portion 12 are substantially the same as those of the first embodiment shown in FIG. 6 and therefore detailed explanation thereof will be omitted.)

As a result, composite 8-bit word sequence data DZ(8), as shown in FIG. 12B, which are obtained by inserting the additional word data group DWS having the word transmission rate of 44 MBps into the 8-bit word sequence data having the word transmission rate of 44 MBps at predetermined word intervals, are derived from the composite 8-bit word sequence data producing portion 11. An arrow t in FIG. 12B represents elapsing time.

The composite 8-bit word sequence data DZ(8) thus obtained from the composite 8-bit word sequence data producing portion 11 are supplied to an 8B/10B converting and P/S converting portion 14. The 8B/10B converting and P/S converting portion 14 is constituted in the same manner as the 8B/10B converting and P/S converting portion 14 shown in FIG. 6 and operative to function in the same manner as the 8B/10B converting and P/S converting portion 14 shown in FIG. 6. Therefore, serial data DZS having the word transmission rate of 440 Mbps are obtained from the 8B/10B converting and P/S converting portion 14 and the serial data DZS are supplied to a data transmitting portion 15.

The data transmitting portion 15 is constituted and operative to function in the same manner as the data transmitting portion 15 shown in FIG. 6. As a result, in the data transmitting portion 15, the serial data DZS are converted into a transmittal signal SZ which is, for example, an electric signal suitable for transmission through a data transmission line made of a coaxial cable or an optical signal suitable for transmission through a data transmission line made of an optical fiber, and the transmittal signal SZ is transmitted through the data transmission line so that the serial data DZS are substantially transmitted.

In the embodiment shown in FIG. 11 also, the 8B/10B converting and P/S converting portion 14 and the data transmitting portion 15 are operative to cause the composite 8-bit word sequence data DZ(8) having the word transmission rate of 44 MBps to be subjected to the 8B/10B conversion to produce the composite 10-bit word sequence data DZ(10) having the word transmission rate of 44 MBps, to cause the composite 10-bit word sequence data DZ(10) to be subjected to the P/S conversion to produce the serial data DZS having the bit transmission rate 440 Mbps and to transmit the serial data DZS. Accordingly, the 8B/10B converting and P/S converting portion 14 and the data transmitting portion 15 can be constituted, for example, by utilizing effectively integrated circuit (IC) devices which have been previously proposed to be used for digital data transmission under the Fibre Channel System or the like. Consequently, a plurality of compressed digital video or video and audio signal data, for example, a plurality of DV format data, can be transmitted in such a manner that 8-bit word sequence data containing 8-bit word synchronous data are formed based on the compressed digital video or video and audio signal data to be transmitted and then subjected to 8B/10B conversion to produce 10-bit word sequence data containing 10-bit word synchronous data and the 10-bit word sequence data thus produced are further converted into serial data to be transmitted.

FIG. 13 shows an embodiment of data receiving apparatus for receiving the transmittal signal SZ formed based on the serial data DZS, which are obtained by causing the composite 8-bit word sequence data DZ(8) to be subjected to the 8B/10B conversion and the P/S conversion, and transmitted from the data transmitting portion 15 of the apparatus shown in FIG. 6.

Referring to FIG. 13, a signal receiving portion 40 is provided for receiving a transmittal signal SZ which is, for example, an electric signal suitable for transmission through a data transmission line made of a coaxial cable or an optical signal suitable for transmission through a data transmission line made of an optical fiber. The signal receiving portion 40 is operative to reproduce serial data DZS based on the transmittal signal SZ received thereby and supplies a synchronous data detecting, S/P converting and 10B/8B (10 bits to 8 bits) converting portion 41 with the serial data DZS.

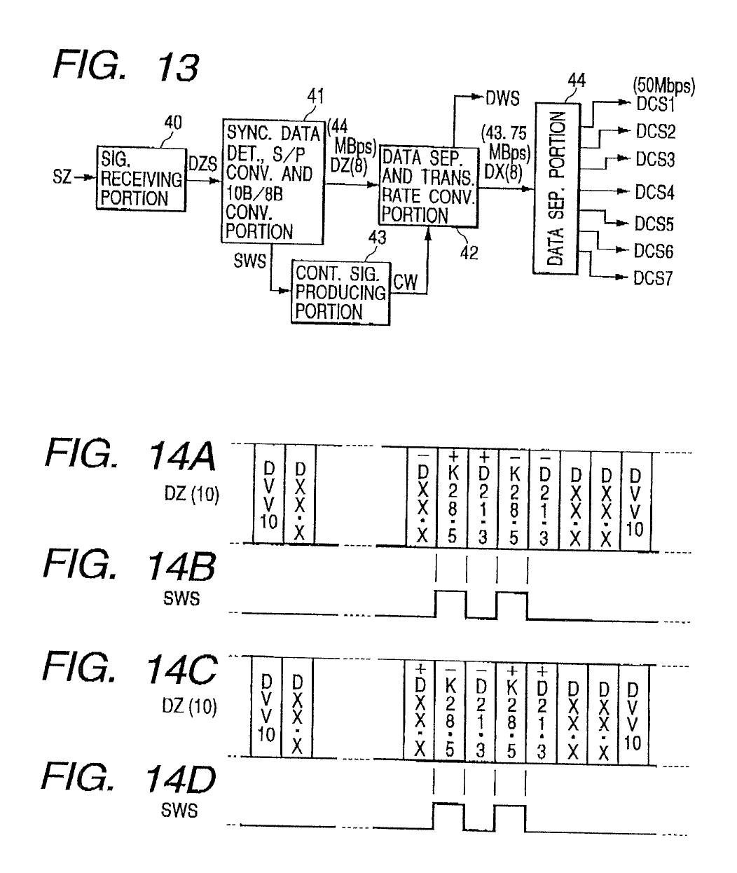

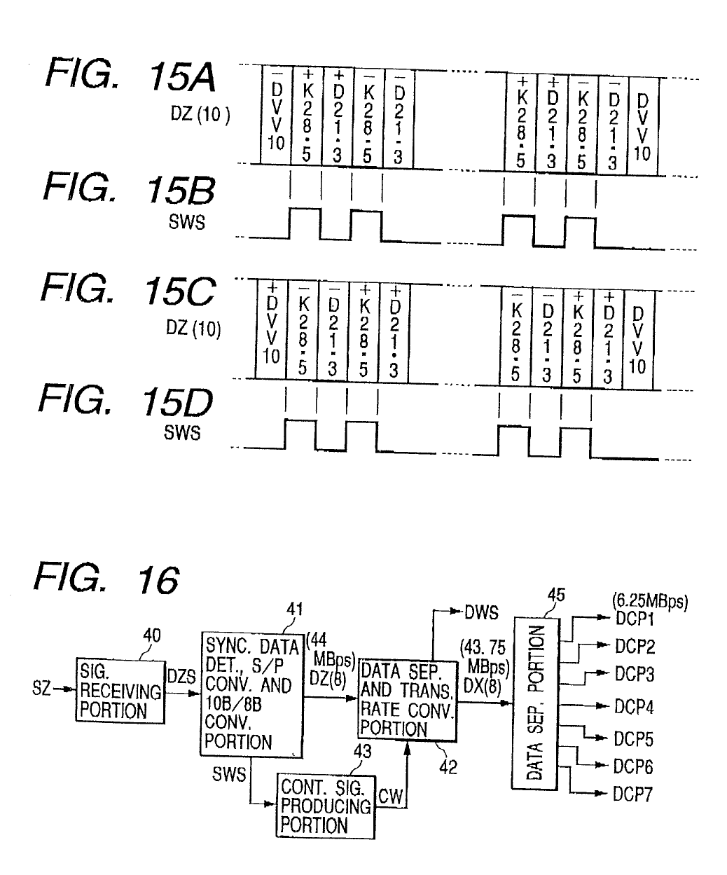

In the synchronous data detecting, S/P converting and 10B/8B converting portion 41, such a portion of the serial data DZS that is formed with serial data converted from 10-bit word synchronous data of +K28.5 or −K28.5 is detected as synchronous data and the serial data DZS are subjected to S/P conversion under a word synchronism condition in accordance with the detected synchronous data to produce composite 10-bit word sequence data DZ(10) having the word transmission rate of, for example, 44 MBps, as shown in FIG. 14A, FIG. 14C, FIG. 15A or FIG. 15C. The composite 10-bit word sequence data DZ(10) shown in FIG. 14A, FIG. 14C, FIG. 15A or FIG. 15C are formed selectively in response to the contents of additional word data group DWS contained therein and the running disparity just before the first K28.5 in the additional word data group DWS.

Then, in the synchronous data detecting, S/P converting and 10B/8B converting portion 41, the composite 10-bit word sequence data DZ(10) is subjected to 10B/8B conversion by which every ten bits of the composite 10-bit word sequence data DZ(10) are partitioned and the partitioned ten bits are converted into eight bits in accordance with a predetermined conversion table to reproduce composite 8-bit word sequence data DZ(8) having the word transmission rate of 44 MBps. The composite 8-bit word sequence data DZ(8) thus obtained in the synchronous data detecting, S/P converting and 10B/8B converting portion 41 are supplied to a data separating and transmission rate converting portion 42.

Besides, in the synchronous data detecting, S/P converting and 10B/8B converting portion 41, the +K28.5 or −K28.5 in the additional word data group DWS contained in the composite 10-bit word sequence data DZ(10) are detected and a K28.5 detection output signal SWS is produced to be supplied to a control signal producing portion 43. The K28.5 detection output signal SWS is obtained in response to the contents of the additional word data group DWS contained in the composite 10-bit word sequence data DZ(10), for example, as shown in FIG. 14B, FIG. 14D, FIG. 15B or FIG. 15D.

In the control signal producing portion 43, a synchronous control signal CW is produced based on the K28.5 detection output signal SWS. The synchronous control signal CW obtained from the control signal producing portion 43 is supplied to the data separating and transmission rate converting portion 42.

In the data separating and transmission rate converting portion 42, the additional word data group DWS is separated from the composite 8-bit word sequence data DZ(8) with use of the synchronous control signal CW from the control signal producing portion 43, and 8-bit word sequence data DZ′(8) obtained based on the composite 8-bit word sequence data DZ(8) to have the word transmission rate of 44 MBps and the additional word data group DWS are separately obtained. Further, in the data separating and transmission rate converting portion 42, the 8-bit word sequence data DZ′(8) having the word transmission rate of 44 MBps are subjected to transmission rate conversion by which the word transmission rate of the 8-bit word sequence data DZ′(8) is converted from 44 MBps to 43.75 MBps to produce 8-bit word sequence data DX(8) having the word transmission rate of 43.75 MBps. Accordingly, the additional word data group DWS and the 8-bit word sequence data DX(8) having the word transmission rate of 43.75 MBps are derived from the data separating and transmission rate converting portion 42.

The 8-bit word sequence data DX(8) thus obtained from the data separating and transmission rate converting portion 42 is supplied to a data separating portion 44. In the data separating portion 44, every one bit of the 8-bit word sequence data DX(8) is extracted successively to form seven separated groups and each of the bits forming the separated group are derived successively to form serial data having the bit transmission rate 50 Mbps. As a result, seven channels of DV format data DCS1 to DCS7, each of which are the serial data having the bit transmission rate 50 Mbps, are produced based on the 8-bit word sequence data DX(8) and the DV format data DCS1 to DCS7 are derived separately from the data separating portion 44. In such a manner as mentioned above, the seven channels of DV format data DCS1 to DCS7, each of which are compressed digital video or video and audio signal data in the form of serial data having the bit transmission rate 50 Mbps, are reproduced.

FIG. 16 shows an embodiment of data receiving apparatus for receiving the transmittal signal SZ formed based on the serial data DZS, which are obtained by causing the composite 8-bit word sequence data DZ(8) to be subjected to the 8B/10B conversion and the P/S conversion, and transmitted from the data transmitting portion 15 of the apparatus shown in FIG. 11.

The embodiment shown in FIG. 16 has many portions constituted in the same manner as those of the embodiment shown in FIG. 13. In FIG. 16, blocks and parts corresponding to those of FIG. 13 are marked with the same references and further description thereof will be omitted.

Referring to FIG. 16, in place of the data separating portion 44 in the data receiving apparatus shown in FIG. 13, a data separating portion 45 to which 8-bit word sequence data DX(8) having the word transmission rate of 43.75 MBps and obtained from a data separating and transmission rate converting portion 42 is supplied, is provided. In the data separating portion 45, every eight bits of the 8-bit word sequence data DX(8) are extracted successively to form seven separated groups and each of the eight bits forming the separated group are derived successively to form 8-bit word sequence data having the word transmission rate 6.26 MBps. As a result, seven channels of DV format data DCP1 to DCP7, each of which are the 8-bit word sequence data having the word transmission rate 6.26 MBps, are produced based on the 8-bit word sequence data DX(8) and the DV format data DCP1 to DCP7 are derived separately from the data separating portion 45. In such a manner as mentioned above, the seven channels of DV format data DCP1 to DCP7, each of which are compressed digital video or video and audio signal data in the form of 8-bit word sequence data having the word transmission rate 6.25 MBps, are reproduced.

Although seven channels of DV format data are multiplexed and transmitted by the method for transmitting digital data carried out in each of the embodiments shown in FIGS. 6 and 11, digital data to be transmitted should not be limited to DV format data but may be other compressed digital video or video and audio signal data. Further, the number of channels of the digital data to be transmitted should not be restricted to seven.

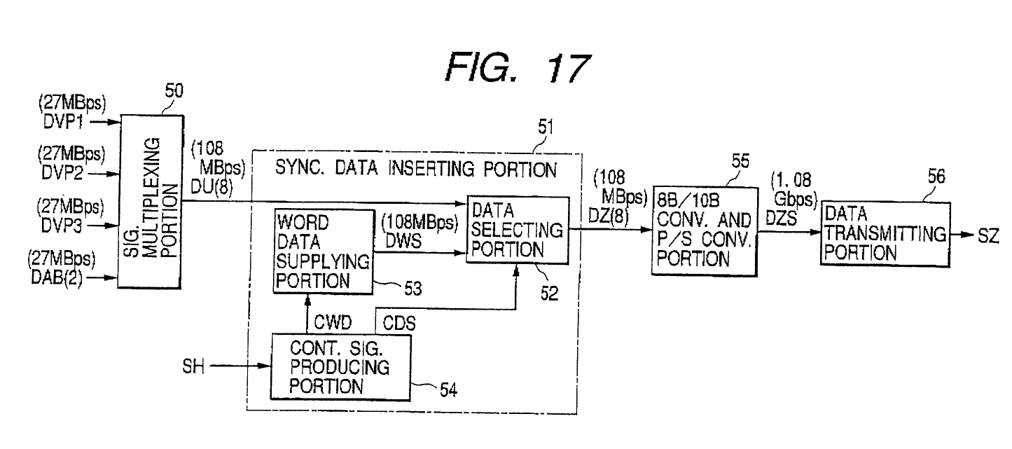

FIG. 17 shows a third embodiment of apparatus for transmitting digital data according to the present invention, in which a third embodiment of method of transmitting digital data according to the present invention is carried out.

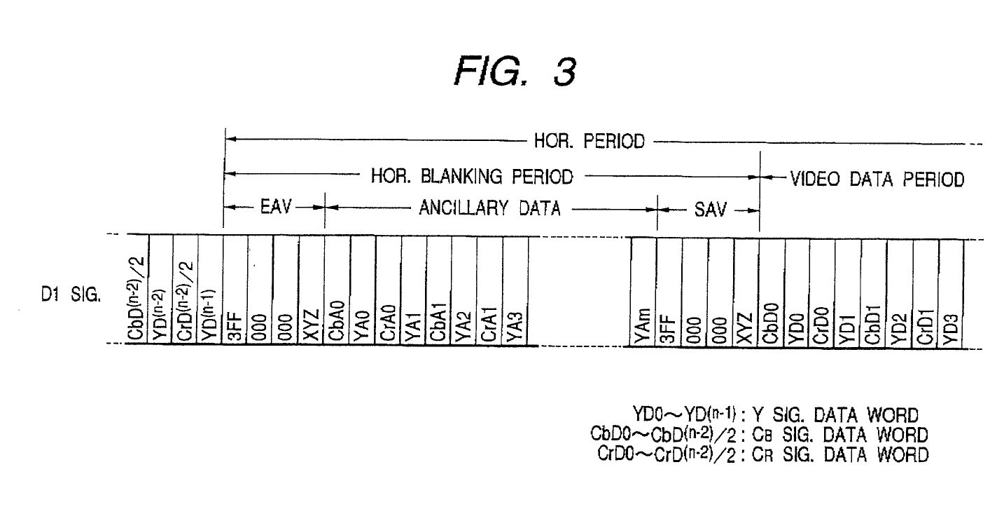

Referring to FIG. 17, three channels of D1 signals DVP1 to DVP3 as a plurality of digital video signals and 2-bit additional data DAB(2) as a bit adding signal are supplied to a signal maltiplexing portion 50. Each of the D1 signals DVP1 to DVP3 is, for example, a digital signal formed with 10-bit word sequence data according to the data format shown in FIG. 3 and having the word transmission rate of, for example, 27 MBps. The 2-bit additional data DAB(2) are 2-bit word sequence data having the word transmission rate of, for example, 27 MBps.

In the signal maltiplexing portion 50, the D1 signals DVP1 to DVP3 and the 2-bit additional data DAB(2) are subjected to data multiplexing, under a condition in which the D1 signals DVP1 to DVP3 are in synchronism in phase of horizontal period with one another and the 2-bit additional data DAB(2) and each of the D1 signals DVP1 to DVP3 are in bit-synchronism with each other, to produce 8-bit word sequence data DU(8) based on the D1 signals DVP1 to DVP3 are the 2-bit additional data DAB(2). In such data multiplexing, 32 bits including 10 bits of each of the D1 signals DVP1 to DVP3 and 2 bits of the 2-bit additional data DAB(2) and transmitted at the same time are successively divided into four words each formed with 8 bits so as to produce 8-bit word sequence data DU(8) having the word transmission rate of 27 MBps×32/8=108 MBps.

Since the D1 signals DVP1 to DVP3 are in synchronism in phase of horizontal period with one another, the 8-bit word sequence data DU(8) obtained as mentioned above has horizontal period, horizontal blanking period and so on corresponding respectively to the horizontal period, horizontal blanking period and so on of each of the D1 signals DVP1 to DVP3. In the horizontal blanking period of the 8-bit word sequence data DU(8), EAV and SAV based on time reference code data EAV and SAV in each of the D1 signals DVP1 to DVP3 are provided and a group of horizontal synchronous data composed of a plurality of horizontal synchronous word data are also provided between the EAV and the SAV.

The 8-bit word sequence data DU(8) obtained from the signal multiplexing portion 50 are supplied to a synchronous data inserting portion 51. A horizontal synchronous pulse signal SH of each of the D1 signals DVP1 to DVP3 is also supplied to the synchronous data inserting portion 51. In the synchronous data inserting portion 51, the 8-bit word sequence data DU(8) from the signal multiplexing portion 50 are guided to a data selecting portion 52 to which an additional word data group DWS having the word transmission rate of 108 MBps are supplied from a word data supplying portion 53. The additional word data group DWS is constituted with a plurality of 8-bit word data including word synchronous data allotted a predetermined specific code.

Further, in the synchronous data inserting portion 51, the horizontal synchronous pulse signal SH is supplied to a control signal producing portion 54. In the control signal producing portion 54, control signals CWD and CDS, each of which is in synchronism with the horizontal synchronous pulse signal SH, are produced. The control signal CWD is supplied to the word data supplying portion 53 and the control signal CDS is supplied to the data selecting portion 52. The additional word data group DWS is derived in response to the control signal CWD from the word data supplying portion 53 to be supplied to the data selecting portion 52.

The data selecting portion 52 is operative to derive selectively the additional word data group DWS when the control signal CDS is supplied and the 8-bit word sequence data DU(8) when the control signal CDS is not supplied so that the additional word data group DWS is inserted in response to the control signal CDS into the horizontal blanking period in each horizontal period of the 8-bit word sequence data DU(8).

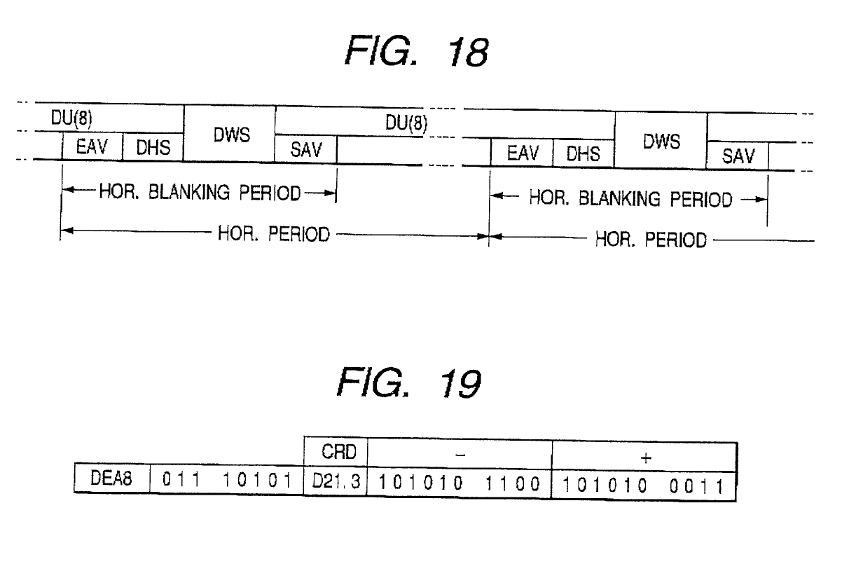

Such data insertion in which the additional word data group DWS is inserted into the 8-bit word sequence data DU(8) is concretely carried out, for example, in the manner as shown in FIG. 18. That is, a plurality of horizontal synchronous word data positioned just before the SAV in the horizontal blanking period in each horizontal period of the 8-bit word sequence data DU(8) are replaced with the additional word data group DWS. The timing of such data replacement by which the horizontal synchronous word data positioned just before the SAV are replaced with the additional word data group DWS is set by the control signals CWD and CDS. Then, the 8-bit word sequence data DU(8) having the horizontal blanking period in each horizontal period into which the additional word data group DWS is inserted are obtained from the data selecting portion 52 as composite 8-bit word sequence data DZ(8) having the word transmission rate of 108 MBps.

The additional word data group DWS supplied from the word data supplying portion 53 is constituted with a plurality of 8-bit word data including 8-bit word synchronous data DEK8 allotted the predetermined specific code and specific 8-bit word ancillary data DEA8. An example of the additional word data group DWS is formed to have a couple of groups of four 8-bit word data arranged in series, each of which includes a series of 8-bit word synchronous data DEK8, specific 8-bit word ancillary data DEA8 and two optional 8-bit word ancillary data DEX8 for reversing the running disparity.

The 8-bit word synchronous data DEK8 are converted into 10-bit word data DS10 by 8B/10B conversion. Therefore, when the 8-bit word sequence data DZ(8) are subjected to 8B/10B conversion, 8-bit word synchronous data DEK8 are converted into +K28.5 if the running disparity just before the same is negative and into −K28.5 if the running disparity just before the same is positive.

The specific 8-bit word ancillary data DEA8 are represented with “0 1 1 1 0 1 0 1” as shown in FIG. 19 and converted into 10-bit word data D21.3 by 8B/10B conversion. The D21.3 are formed to be “1 0 1 0 1 0 1 1 0 0” , the running disparity of which is neutral, when the running disparity just before the same is negative, and to be “1 0 1 0 1 0 0 0 1 1” , the running disparity of which is neutral, when the running disparity just before the same is positive.

The optional 8-bit word ancillary data DEX8 for reversing the running disparity is converted into 10-bit word data DXX.X by 8B/10B conversion. The DXX.X is provided with the positive running disparity when the running disparity just before the same is negative and with the negative running disparity when the running disparity just before the same is positive. That is, the optional 8-bit word ancillary data DEX8 for reversing the running disparity are optional 8-bit word data meeting such conditions as mentioned above.

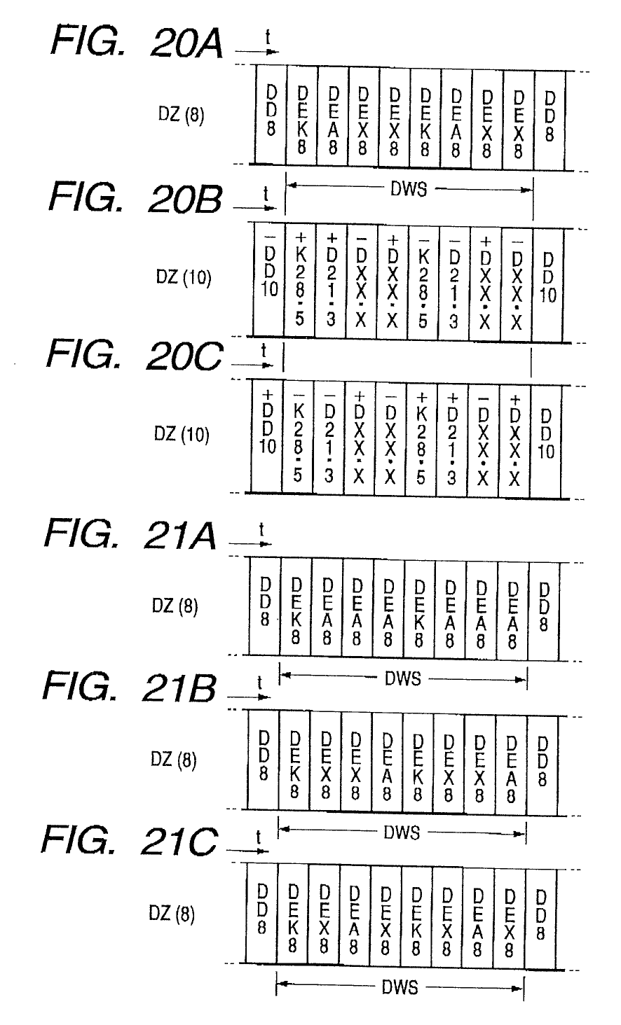

A portion of the composite 8-bit word sequence data DZ(8) in which the example of the additional word data group DWS mentioned above is inserted is shown in FIG. 20A. In FIG. 20A, DD8 represents 8-bit word data contained in the 8-bit word sequence data DU(8) obtained from the signal multiplexing portion 50 and an arrow t represents elapsing time.

Another example of the additional word data group DWS supplied from the word data supplying portion 53 is formed to have, for example, a couple of groups of four 8-bit word data arranged in series, each of which includes a series of 8-bit word synchronous data DEK8 and three specific 8-bit word ancillary data DEA8, a couple of groups of four 8-bit word data arranged in series, each of which includes a series of 8-bit word synchronous data DEK8, two optional 8-bit word ancillary data DEX8 for reversing the running disparity and specific 8-bit word ancillary data DEA8, a couple of groups of four 8-bit word data arranged in series, each of which includes a series of 8-bit word synchronous data DEK8, optional 8-bit word ancillary data DEX8 for reversing the running disparity, or specific 8-bit word ancillary data DEA8 and optional 8-bit word ancillary data DEX8 for reversing the running disparity. A portion of the composite 8-bit word sequence data DZ(8) in which another example of the additional word data group DWS mentioned above is inserted is shown in FIG. 21A, 21B or 21C. In each of FIGS. 21A, 21B and 21C, DD8 represents 8-bit word data contained in the 8-bit word sequence data DU(8) obtained from the signal multiplexing portion 50 and an arrow t represents elapsing time.

The composite 8-bit word sequence data DZ(8) containing the additional word data group DWS obtained from the data selecting portion 52 to have the word transmission rate of 108 MBps is derived from the synchronous data inserting portion 51 to be supplied to an 8B/10B converting and P/S converting portion 55.

In the 8B/10B converting and P/S converting portion 55, the composite 8-bit word sequence data DZ(8) are subjected to 8B/10B conversion by which every eight bits constituting each word of the composite 8-bit word sequence data DZ(8) are converted into ten bits in accordance with a predetermined conversion table to produce composite 10-bit word sequence data DZ(10) having the word transmission rate of 108 MBps. In such 8B/10B conversion, the 8-bit word synchronous data DEK8 are c on verted into 10-bit word synchronous data K 28.5, the specific 8-bit word ancillary data DEA8 are converted into 10-bit word data D21.3, the optional 8-bit word ancillary data DEX8 are converted into 10-bit word data DXX.X, and the 8-bit word data DD8 are converted into 10-bit word data DD10.

Accordingly, if such an additional word data group DWS as shown in FIG. 20A is inserted into the composite 8-bit word sequence data DZ(8), a portion of the composite 10-bit word sequence data DZ(10) formed based on the additional word data group DWS are so formed as to be shown in FIG. 20B when the running disparity just before the first K28.5 is negative, and a portion of the composite 10-bit word sequence data DZ(10) formed based on the additional word data group DWS are so formed as to be shown in FIG. 20C when the running disparity just before the first K28.5 is positive. In either case, +K28.5 are contained in the portion of the composite 10-bit word sequence data DZ(10) formed based on the additional word data group DWS.

Further, in the case where such an additional word data group DWS as shown in FIG. 21A, 21B or 21C is inserted into the composite 8-bit word sequence data DZ(8), +K28.5 are contained in the portion of the composite 10-bit word sequence data DZ(10) formed based on the additional word data group DWS in the same manner as the case where the additional word data group DWS shown in FIG. 20A is inserted into the composite 8-bit word sequence data DZ(8).

In addition to the above, in the 8B/10B converting and P/S converting portion 55, the composite 10-bit word sequence data DZ(10) which are obtained by causing the composite 8-bit word sequence data DZ(8) to be subjected to the 8B/10B conversion to have the word transmission rate of 108 MBps, are subjected to P/S conversion by which parallel data are converted into serial data to produce serial data DZS based on the composite 10-bit word sequence data DZ(10) and having the bit transmission rate of 108 MBps×10=1.08 Gbps. The serial data DZS thus obtained are supplied from the 8B/10B converting and P/S converting portion 55 to a data transmitting portion 56.

The data transmitting portion 56 is operative to convert the serial data DZS to a transmittal signal SZ which is, for example, an electric signal suitable for transmission through a data transmission line made of a coaxial cable or an optical signal suitable for transmission through a data transmission line made of an optical fiber, and to transmit the transmittal signal SZ through the data transmission line so that the serial data DZS are substantially transmitted.

In the embodiment shown in FIG. 17, the 8B/10B converting and P/S converting portion 55 and the data transmitting portion 56 are operative to cause the composite 8-bit word sequence data DZ(8) having the word transmission rate of 108 MBps to be subjected to the 8B/10B conversion to produce the composite 10-bit word sequence data DZ(10) having the word transmission rate of 108 MBps, to cause the composite 10-bit word sequence data DZ(10) to be subjected to the P/S conversion to produce the serial data DZS having the bit transmission rate 1.08 Gbps and to transmit the serial data DZS. Accordingly, the 8B/10B converting and P/S converting portion 55 and the data transmitting portion 56 can be constituted,for example, by utilizing effectively integrated circuit (IC) devices which have been previously proposed to be used for digital data transmission under the Fibre Channel System or the like. Consequently, a plurality of compressed digital video or video and audio signal data, for example, three channels of D1 signals DVP1 to DVP3 and 2-bit additional data DAB(2) can be transmitted in such a manner that 8-bit word sequence data containing 8-bit word synchronous data are formed based on the compressed digital video or video and audio signal data to be transmitted and then subjected to 8B/10B conversion to produce 10-bit word sequence data containing 10-bit word synchronous data and the 10-bit word sequence data thus produced are further converted into serial data to be transmitted.

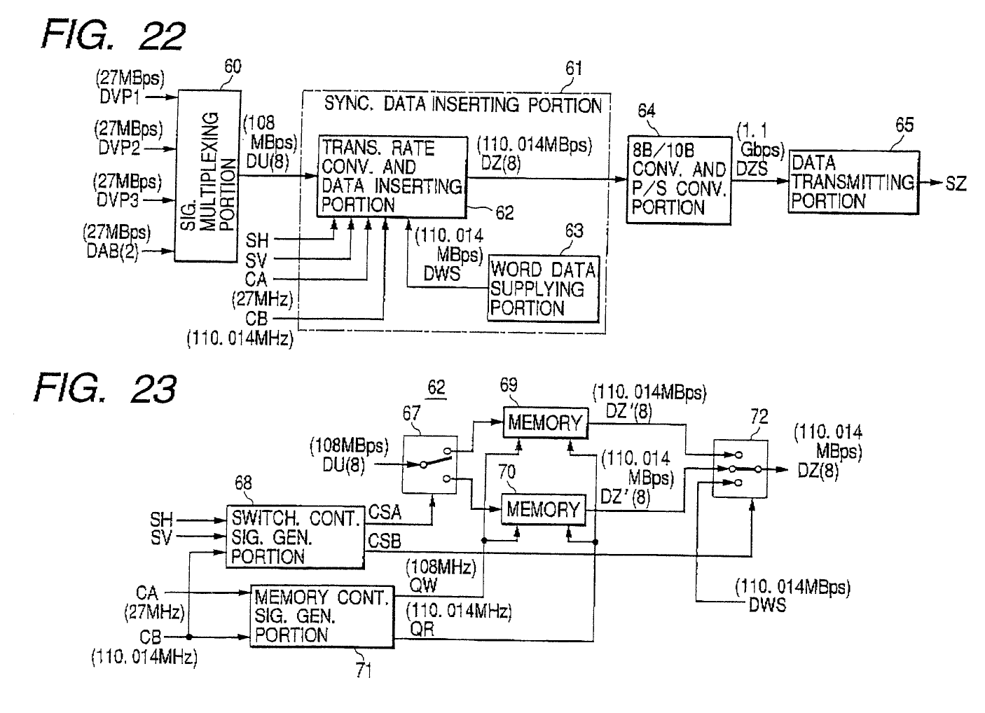

FIG. 22 shows a fourth embodiment of apparatus for transmitting digital data according to the present invention, in which a fourth embodiment of method of transmitting digital data according to the present invention is carried out.

Referring to FIG. 22, three channels of D1 signals DVP1 to DVP3 as a plurality of digital video signals and 2-bit additional data DAB(2) as a bit adding signal are supplied to a signal maltiplexing portion 60. Each of the D1 signals DVP1 to DVP3 is, for example, a digital signal formed with 10-bit word sequence data according to the data format shown in FIG. 3 and having the word transmission rate of, for example, 27 MBps. The 2-bit additional data DAB(2) are 2-bit word sequence data having the word transmission rate of, for example, 27 MBps.

In the signal maltiplexing portion 60, the D1 signals DVP1 to DVP3 and the 2-bit additional data DAB(2) are subjected to data multiplexing, under a condition in which the D1 signals DVP1 to DVP3 are in synchronism in phase of horizontal period with one another and the 2-bit additional data DAB(2) and each of the D1 signals DVP1 to DVP3 are in bit-synchronism with each other, to produce 8-bit word sequence data DU(8) based on the D1 signals DVP1 to DVP3 and the 2-bit additional data DAB(2). In such data multiplexing, 32 bits including 10 bits of each of the D1 signals DVP1 to DVP3 and 2 bits of the 2-bit additional data DAB(2) and transmitted at the same time are successively divided into four words each formed with 8 bits so as to produce 8-bit word sequence data DU(8) having the word transmission rate of 27 MBps×32/8=108 MBps.

Since the D1 signals DVP1 to DVP3 are in synchronism in phase of horizontal period with one another, the 8-bit word sequence data DU(8) obtained as mentioned above has horizontal period, horizontal blanking period and so on corresponding respectively to the horizontal period, horizontal blanking period and so on of each of the D1 signals DVP1 to DVP3.

The 8-bit word sequence data DU(8) produced in the signal maltiplexing portion 60 to have the word transmission rate of 108 MBps are supplied to a synchronous data inserting portion 61. Horizontal and vertical synchronous pulse signals SH and SV of each of the D1 signals DVP1 to DVP3, a clock pulse signal CA which has the frequency of 27 MHz and is in synchronism with a word clock signal of each of the D1 signals DVP1 to DVP3 and another clock pulse signal CB having the frequency 110.014 MHz are also supplied to the synchronous data inserting portion 61.

In the synchronous data inserting portion 61, the 8-bit word sequence data DU(8) from the signal multiplexing portion 60 are guided to a transmission rate converting and data inserting portion 62. The horizontal synchronous signal SH, the vertical synchronous pulse signal SV, the clock pulse signal CA and the clock pulse signal CB are also supplied to the transmission rate converting and data inserting portion 62. Besides, an additional word data group DWS having the word transmission rate of 110.014 MBps is supplied from a word data supplying portion 63 to the transmission rate converting and data inserting portion 62. The additional word data group DWS is constituted with a plurality of 8-bit word data including 8-bit word synchronous data allotted a predetermined specific code.

In the transmission rate converting and data inserting portion 62, the word transmission rate of the 8-bit word sequence data DU(8) is converted from 108 MBps to 110.014 MBps and then the additional word data group DWS including the 8-bit word synchronous data from the word data supplying portion 63 is inserted into the 8-bit word sequence data DU(8) at predetermined word intervals thereof to produce composite 8-bit word sequence data DZ(8) having the word transmission rate of 110.014 MBps. That is, the composite 8-bit word sequence data DZ(8) are produced based on a combination of the D1 signals DVP1 to DVP3 and the 2-bit additional data DAB(2) in the transmission rate converting and data inserting portion 62.

FIG. 23 shows an embodiment of the transmission rate converting and data inserting portion 62. In the embodiment shown in FIG. 23, the 8-bit word sequence data DU(8) obtained from the signal multiplexing portion 60 are supplied to a switch 67. The switch 67 performs switching operations at every predetermined period, for example, every horizontal period of the 8-bit word sequence data DU(8) in response to a control signal CSA supplied from a switching control signal generating portion 68.

The horizontal synchronous pulse signal SH, the vertical synchronous pulse signal SV and the clock pulse signal CB having the frequency of 110.014 MHz are supplied to the switching control signal generating portion 68. In the switching control signal generating portion 68, the control signal CSA is produced in response to the horizontal and vertical synchronous pulse signals SH and SV so as to be in synchronism with the horizontal period of the 8-bit word sequence data DU(8) and a control signal CSB is produced in response to the horizontal synchronous pulse signal SH and the clock pulse signal CB to be in synchronism with the horizontal period of the 8-bit word sequence data DU(8) so as to be in synchronism with both of the horizontal period of the 8-bit word sequence data DU(8) and a period corresponding to an integer times the period of the clock pulse signal CB.

Memories 69 and 70 are connected with the switch 67. The switch 67 supplies alternately the memory 69 and the memory 70 with the 8-bit word sequence data DU(8) at every horizontal period of the 8-bit word sequence data DU(8) with its switching operations.

A memory control signal generating portion 71 to which the clock pulse signal CA having the frequency of 27 MHz and the clock pulse signal CB having the frequency of 110.014 MHz are supplied, is provided in relation to the memories 69 and 70. The memory control signal generating portion 71 is operative to produce a write control signal QW having the frequency of 27 MHz×4=108 MHz based on the clock pulse signal CA and a read control signal QR having the frequency of 110.014 MHz based on the clock pulse signal CB and to supply each of the memories 69 and 70 with the write control signal QW and the read control signal QR.

In the memory 69, the 8-bit word sequence data DU(8) are written to be stored at the word transmission rate of 108 MBps in accordance with the write control signal QW having the frequency of 108 MHz when the 8-bit word sequence data DU(8) are supplied through the switch 67 to the memory 69. Similarly, in the memory 70, the 8-bit word sequence data DU(8) are written to be stored at the word transmission rate of 108 MBps in accordance with the write control signal QW having the frequency of 108 MHz when the 8-bit word sequence data DU(8) are supplied through the switch 67 to the memory 70. Accordingly, the 8-bit word sequence data DU(8) having the word transmission rate of 108 MBps are written to be stored in the memories 69 and 70 alternately at every horizontal period of the 8-bit word sequence data DU(8).

The 8-bit word sequence data DU(8) stored in the memory 69 during a certain horizontal period of the 8-bit word sequence data DU(8) are read from the memory 69 during the next horizontal period of the 8-bit word sequence data DU(8) in accordance with the read control signal QR having the frequency of 110.014 MHz so as to produce 8-bit word sequence data DZ′(8) having the word transmission rate of 110.014 MBps. The 8-bit word sequence data DZ′(8) thus obtained from the memory 69 are supplied to a switch 72. The 8-bit word sequence data DU(8) stored in the memory 70 during a certain horizontal period of the 8-bit word sequence data DU(8) are read from the memory 70 during the next horizontal period of the 8-bit word sequence data DU(8) in accordance with the read control signal QR having the frequency of 110.014 MHz so as to produce 8-bit word sequence data DZ′(8) having the word transmission rate of 110.014 MBps. The 8-bit word sequence data DZ′(8) thus obtained from the memory 70 are also supplied to the switch 72. The additional word data group DWS having the word transmission rate of 110.014 MBps is further supplied from the word data supplying portion 63 to the switch 72.

The switch 72 is operative to extract successively the additional word data group DWS having the word transmission rate of 110.014 MBps and supplied from the word data supplying portion 63, the 8-bit word sequence data DZ′ (8) having the word transmission rate of 110.014 MBps and read from the memory 70 and the 8-bit word sequence data DU′(8) having the word transmission rate of 110.014 MBps and read from the memory 69 at every predetermined period corresponding to a predetermined number of 8-bit word data, in response to the control signal CSB supplied from the switching control signal generating portion 68. As a result, the composite 8-bit word sequence data DZ(8), which are obtained by inserting the additional word data group DWS having the word transmission rate of 110.014 MBps into the 8-bit word sequence data DZ′ (8) having the word transmission rate of 110.014 MBps at predetermined word intervals are derived from the switch 72.

The additional word data group DWS supplied from the word data supplying portion 63 is constituted with a plurality of 8-bit word data including 8-bit word synchronous data DEK8 allotted the predetermined specific code and specific 8-bit word ancillary data DEA8. An example of the additional word data group DWS is formed to have a couple of groups of two 8-bit word data arranged in series, each of which includes a series of 8-bit word synchronous data DEK8 and specific 8-bity word ancillary data DEA8, and at least one optional 8-bit word ancillary data DEX8 for reversing the running disparity following the groups in series.

The 8-bit word synchronous data DEK8, the specific 8-bit word ancillary data DEA8 and the optional 8-bit word ancillary data DEX8 for reversing the running disparity are the same as those included in the additional word data group DWS supplied from the word data supplying portion 53 in FIG. 17 and explained above.

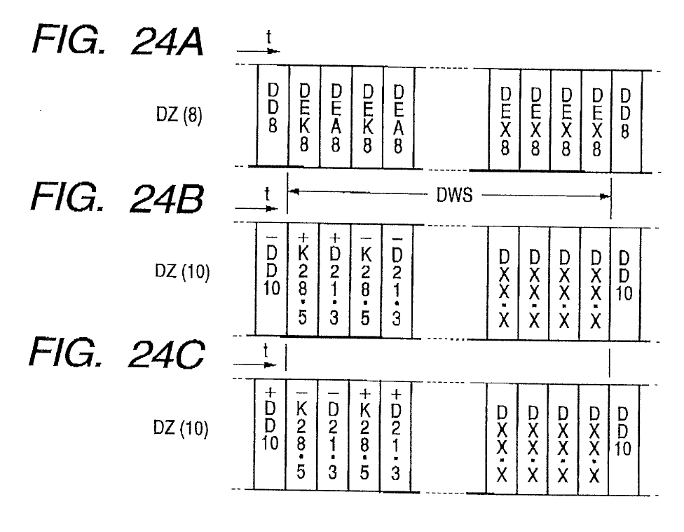

A portion of the composite 8-bit word sequence data DZ(8) in which the example of the additional word data group DWS mentioned above is inserted is shown in FIG. 24A. In FIG. 24A, DD8 represents 8-bit word data contained in the 8-bit word sequence data DZ′(8) read from the memories 69 and 70 and an arrow t represents elapsing time.

The 8-bit word sequence data DZ(8) obtained in the transmission rate converting and data inserting portion 62 to have the word transmission rate of 110.014 MBps is derived from the synchronous data inserting portion 61 to be supplied to an 8B/10B converting and P/S converting portion 64.

In the 8B/10B converting and P/S converting portion 64, the composite 8-bit word sequence data DZ(8) are subjected to 8B/10B conversion by which every eight bits constituting each word of the composite 8-bit word sequence data DZ(8) are converted into ten bits in accordance with a predetermined conversion table to produce composite 10-bit word sequence data DZ(10) having the word transmission rate of 110.014 MBps. In such 8B/10B conversion, the 8-bit word synchronous data DEK8 are converted into 10-bit word synchronous data K 28.5, the specific 8-bit word ancillary data DEA8 are converted into 10-bit word data D21.3, the optional 8-bit word ancillary data DEX8 are converted into 10-bit word data DXX.X, and the 8-bit word data DD8 are converted into 10-bit word data DD10.

Accordingly, if such an additional word data group DWS as shown in FIG. 24A is inserted into the composite 8-bit word sequence data DZ(8), a portion of the composite 10-bit word sequence data DZ(10) formed based on the additional word data group DWS are so formed as to be shown in FIG. 24B when the running disparity just before the first K28.5 is negative, and a portion of the composite 10-bit word sequence data DZ(10) formed based on the additional word data group DWS are so formed as to be shown in FIG. 24C when the running disparity just before the first K28.5 is positive. In either case, +K28.5 are contained in the portion of the composite 10-bit word sequence data DZ(10) formed based on the additional word data group DWS.

In addition to the above, in the 8B/10B converting and P/S converting portion 64, the composite 10-bit word sequence data DZ(10) which are obtained by causing the composite 8-bit word sequence data DZ(8) to be subjected to the 8B/10B conversion to have the word transmission rate of 110.014 MBps, are subjected to P/S conversion by which parallel data are converted into serial data to produce serial data DZS based on the composite 10-bit word sequence data DZ(10) and having the bit transmission rate of 110.014 MBps×10≈1.1 Gbps. The serial data DZS thus obtained are supplied from the 8B/10B converting and P/S converting portion 64 to a data transmitting portion 65.

The data transmitting portion 65 is operative to convert the serial data DZS to a transmittal signal SZ which is, for example, an electric signal suitable for transmission through a data transmission line made of a coaxial cable or an optical signal suitable for transmission through a data transmission line made of an optical fiber, and to transmit the transmittal signal SZ through the data transmission line so that the serial data DZS are substantially transmitted.

In the embodiment shown in FIG. 22, the 8B/10B converting and P/S converting portion 64 and the data transmitting portion 65 are operative to cause the composite 8-bit word sequence data DZ(8) having the word transmission rate of 110.014 MBps to be subjected to the 8B/10B conversion to produce the composite 10-bit word sequence data DZ(10) having the word transmission rate of 110.014 MBps, to cause the composite 10-bit word sequence data DZ(10) to be subjected to the P/S conversion to produce the serial data DZS having the bit transmission rate 1.1 Gbps and to transmit the serial data DZS. Accordingly, the 8B/10B converting and P/S converting portion 64 and the data transmitting portion 65 can be constituted,for example, by utilizing effectively integrated circuit (IC) devices which have been previously proposed to be used for digital data transmission under the Fibre Channel System or the like. Consequently, a plurality of compressed digital video or video and audio signal data, for example, three channels of D1 signals DVP1 to DVP3 and 2-bit additional data DAB(2) can be transmitted in such a manner that 8-bit word sequence data containing 8-bit word synchronous data are formed based on the compressed digital video or video and audio signal data to be transmitted and then subjected to 8B/10B conversion to produce 10-bit word sequence data containing 10-bit word synchronous data and the 10-bit word sequence data thus produced are further converted into serial data to be transmitted.

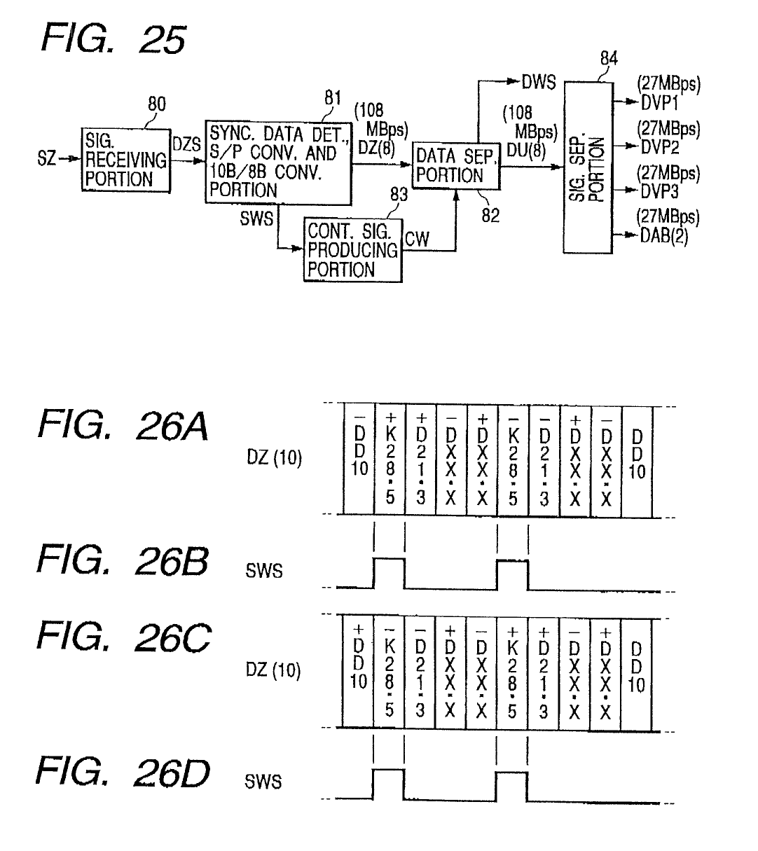

FIG. 25 shows an embodiment of data receiving apparatus for receiving the transmittal signal SZ formed based on the serial data DZS, which are obtained by causing the composite 8-bit word sequence data DZ(8) to be subjected to the 8B/10B conversion and the P/S conversion, and transmitted from the data transmitting portion 56 of the apparatus shown in FIG. 17.

Referring to FIG. 25, a signal receiving portion 80 is provided for receiving a transmittal signal SZ which is, for example, an electric signal suitable for transmission through a data transmission line made of a coaxial cable or an optical signal suitable for transmission through a data transmission line made of an optical fiber. The signal receiving portion 80 is operative to reproduce serial data DZS based on the transmittal signal SZ received thereby and supplies a synchronous data detecting, S/P converting and 10B/8B converting portion 81 with the serial data DZS.

In the synchronous data detecting, S/P converting and 10B/8B converting portion 81, such a portion of the serial data DZS that is formed with serial data converted from 10-bit word synchronous data of +K28.5 or −K28.5 is detected as synchronous data and the serial data DZS are subjected to S/P conversion under a word synchronism condition in accordance with the detected synchronous data to produce composite 10-bit word sequence data DZ(10) having the word transmission rate of, for example, 108 MBps, as shown in FIG. 26A or FIG. 26C. The composite 10-bit word sequence data DZ(10) shown in FIG. 26A or FIG. 26C. are formed selectively in response to the contents of additional word data group DWS contained therein and the running disparity just before the first K28.5 in the additional word data group DWS.

Then, in the synchronous data detecting, S/P converting and 10B/8B converting portion 81, the composite 10-bit word sequence data DZ(10) is subjected to 10B/8B conversion by which every ten bits of the composite 10-bit word sequence data DZ(10) are partitioned and the partitioned ten bits are converted into eight bits in accordance with a predetermined conversion table to reproduce composite 8-bit word sequence data DZ(8) having the word transmission rate of 108 MBps. The composite 8-bit word sequence data DZ(8) thus obtained in the synchronous data detecting, S/P converting and 10B/8B converting portion 81 are supplied to a data separating portion 82.

Besides, in the synchronous data detecting, S/P converting and 10B/8B converting portion 81, the +K28.5 or −K28.5 in the additional word data group DWS contained in the composite 10-bit word sequence data DZ(10) are detected and a K28.5 detection output signal SWS is produced to be supplied to a control signal producing portion 83. The K28.5 detection output signal SWS is obtained in response to the contents of the additional word data group DWS contained in the composite 10-bit word sequence data DZ(10), for example, as shown in FIG. 26B or FIG. 26D.

In the control signal producing portion 83, a synchronous control signal CW is produced based on the K28.5 detection output signal SWS. The synchronous control signal CW obtained from the control signal producing portion 83 is supplied to the data separating portion 82.

In the data separating portion 82, the additional word data group DWS is separated from the composite 8-bit word sequence data DZ(8) with use of the synchronous control signal CW from the control signal producing portion 83, and 8-bit word sequence data DU(8) obtained based on the composite 8-bit word sequence data DZ(8) to have the word transmission rate of 108 MBps and the additional word data group DWS are separately obtained.

The 8-bit word sequence data DU(8) thus obtained from the data separating portion 82 is supplied to a signal separating portion 84. In the signal separating portion 84, each 32 bits forming successive 4 word data of the 8-bit word sequence data DU(8) are divided into three groups of ten bits and two bits. Then, each ten bits in each of three groups are derived successively to produce three 10-bit word sequence data each having the word transmission rate of 108 MBps/4=27 MBps and each 2 bite are derived successively to produce 2-bit word sequence data having the word transmission rate of 108 MBps/4=27 MBps. As a result, three channels of D1 signals DVP1 to DVP3, each of which are 10-bit word sequence data having the word transmission rate of 27 MBps and 2-bit additional data DAB(2) which are 2-bit word sequence data having the word transmission rate of 27 MBps are derived separately from the signal separating portion 84. In such a manner as mentioned above, the three channels of D1 signals DVP1 to DVP3 which are a plurality of digital video signals and 2-bit additional data DAB(2) which are a bit adding signal are reproduced.

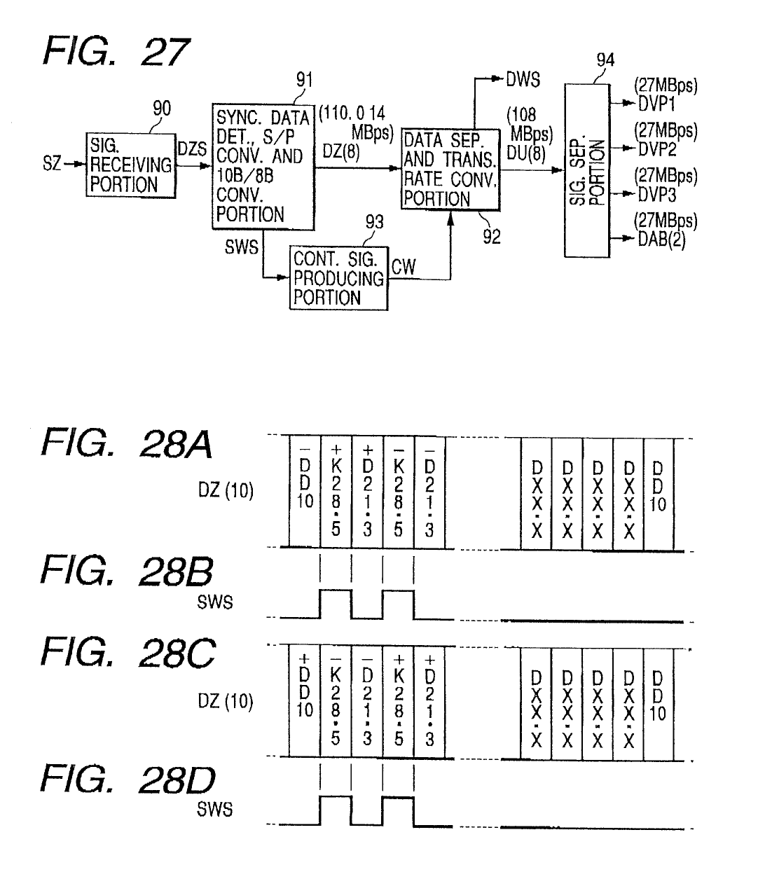

FIG. 27 shows an embodiment of data receiving apparatus for receiving the transmittal signal SZ formed based on the serial data DZS, which are obtained by causing the composite 8-bit word sequence data DZ(8) to be subjected to the 8B/10B conversion and the P/S conversion, and transmitted from the data transmitting portion 65 of the apparatus shown in FIG. 22.

Referring to FIG. 27, a signal receiving portion 90 is provided for receiving a transmittal signal SZ which is, for example, an electric signal suitable for transmission through a data transmission line made of a coaxial cable or an optical signal suitable for transmission through a data transmission line made of an optical fiber. The signal receiving portion 90 is operative to reproduce serial data DZS based on the transmittal signal SZ received thereby and supplies a synchronous data detecting, S/P converting and 10B/8B converting portion 91 with the serial data DZS.

In the synchronous data detecting, S/P converting and 10B/8B converting portion 91, such a portion of the serial data DZS that is formed with serial data converted from 10-bit word synchronous data of +K28.5 or −K28.5 is detected as synchronous data and the serial data DZS are subjected to S/P conversion under a word synchronism condition in accordance with the detected synchronous data to produce composite 10-bit word sequence data DZ(10) having the word transmission rate of, for example, 110.014 MBps, as shown in FIG. 28A or FIG. 28C. The composite 10-bit word sequence data DZ(10) shown in FIG. 28A or FIG. 28C. are formed selectively in response to the contents of additional word data group DWS contained therein and the running disparity just before the first K28.5 in the additional word data group DWS.

Then, in the synchronous data detecting, S/P converting and 10B/8B converting portion 91, the composite 10-bit word sequence data DZ(10) is subjected to 10B/8B conversion by which every ten bits of the composite 10-bit word sequence data DZ(10) are partitioned and the partitioned ten bits are converted into eight bits in accordance with a predetermined conversion table to reproduce composite 8-bit word sequence data DZ(8) having the word transmission rate of 110.014 MBps. The composite 8-bit word sequence data DZ(8) thus obtained in the synchronous data detecting, S/P converting and 10B/8B converting portion 91 are supplied to a data separating and transmission rate converting portion 92.

Besides, in the synchronous data detecting, S/P converting and 10B/8B converting portion 91, the +K28.5 or −K28.5 in the additional word data group DWS contained in the composite 10-bit word sequence data DZ(10) are detected and a K28.5 detection output signal SWS is produced to be supplied to a control signal producing portion 93. The K28.5 detection output signal SWS is obtained in response to the contents of the additional word data group DWS contained in the composite 10-bit word sequence data DZ(10), for example, as shown in FIG. 28B or FIG. 28D.

In the control signal producing portion 93, a synchronous control signal CW is produced based on the K28.5 detection output signal SWS. The synchronous control signal CW obtained from the control signal producing portion 93 is supplied to the data separating and transmission rate converting portion 92.

In the data separating and transmission rate converting portion 92, the additional word data group DWS is separated from the composite 8-bit word sequence data DZ(8) with use of the synchronous control signal CW from the control signal producing portion 93, and 8-bit word sequence data DZ′(8) obtained based on the composite 8-bit word sequence data DZ(8) to have the word transmission rate of 110.014 MBps and the additional word data group DWS are separately obtained. Further, in data separating and transmission rate converting portion 92, the 8-bit word sequence data DZ′(8) having the word transmission rate of 110.014 MBps are subjected to transmission rate conversion by which the word transmission rate of the 8-bit word sequence data DZ′(8) is converted from 110.014 MBps to 108 MBps to produce 8-bit word sequence data DU(8) having the word transmission rate of 108 MBps. Accordingly, the additional word data group DWS and the 8-bit word sequence data DU(8) having the word transmission rate of 108 MBps are derived from the data separating and transmission rate converting portion 92.

The 8-bit word sequence data DU(8) thus obtained from the data separating and transmission rate converting portion 92 is supplied to a signal separating portion 94. In the signal separating portion 94, each 32 bits forming successive 4 word data of the 8-bit word sequence data DU(8) are divided into three groups of 10 bits and 2 bits. Then, each 10 bits in each of three groups are derived successively to produce three 10-bit word sequence data each having the word transmission rate of 108 MBps/4=27 MBps and each 2 bite are derived successively to produce 2-bit word sequence data having the word transmission rate of 108 MBps/4=27 MBps. As a result, three channels of D1 signals DVP1 to DVP3, each of which are 10-bit word sequence data having the word transmission rate of 27 MBps and 2-bit additional data DAB(2) which are 2-bit word sequence data having the word transmission rate of 27 MBps are derived separately from the signal separating portion 94. In such a manner as mentioned above, the three channels of D1 signals DVP1 to DVP3 which are a plurality of digital video signals and 2-bit additional data DAB(2) which are a bit adding signal are reproduced.

Although three channels of D1 signals and 2-bit additional data DAB(2) are multiplexed and transmitted by the method for transmitting digital data carried out in each of the embodiments shown in FIGS. 17 and 22, digital data to be transmitted should not be limited to the D1 signal but may be other digital video signal without the combination with a bit adding signal, such as the 2-bit additional data DAB(2). Further, the number of channels of digital video signals to be transmitted should not be restricted to three.

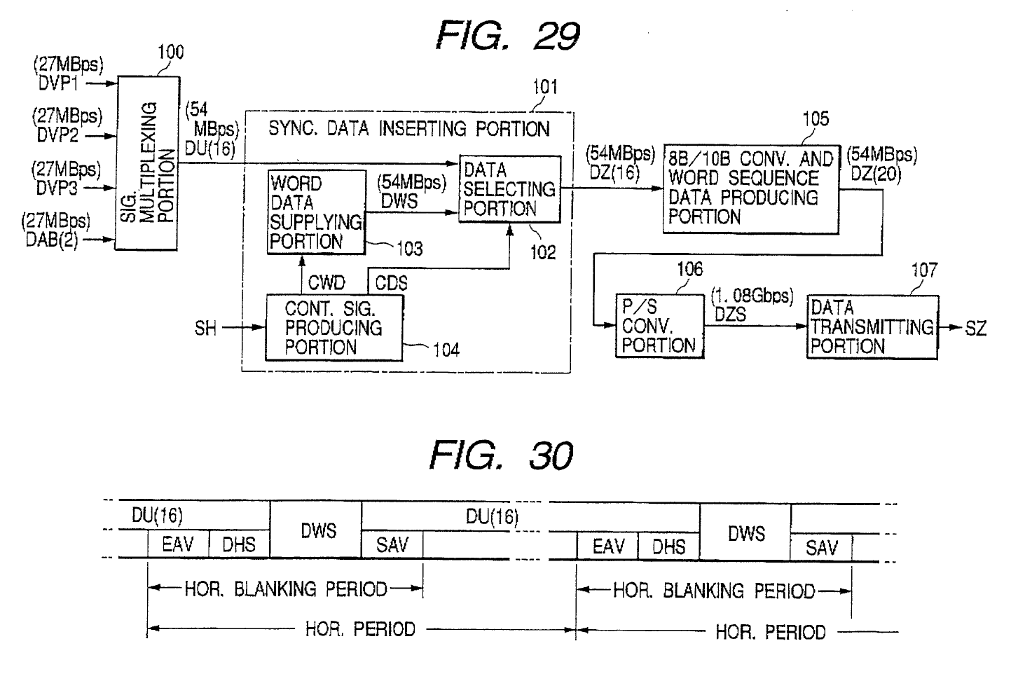

FIG. 29 shows a fifth embodiment of apparatus for transmitting digital data according to the present invention, in which a fifth embodiment of method of transmitting digital data according to the present invention is carried out.

Referring to FIG. 29, three channels of D1 signals DVP1 to DVP3 as a plurality of digital video signals and 2-bit additional data DAB(2) as a bit adding signal are supplied to a signal maltiplexing portion 100. Each of the D1 signals DVP1 to DVP3 is, for example, a digital signal formed with 10-bit word sequence data according to the data format shown in FIG. 3 and having the word transmission rate of, for example, 27 MBps. The 2-bit additional data DAB(2) are 2-bit word sequence data having the word transmission rate of, for example, 27 MBps.

In the signal maltiplexing portion 100, the D1 signals DVP1 to DVP3 and the 2-bit additional data DAB(2) are subjected to data multiplexing, under a condition in which the D1 signals DVP1 to DVP3 are in synchronism in phase of horizontal period with one another and the 2-bit additional data DAB(2) and each of the D1 signals DVP1 to DVP3 are in bit-synchronism with each other, to produce 16-bit word sequence data DU(16) based on the D1 signals DVP1 to DVP3 are the 2-bit additional data DAB(2). In such data multiplexing, 32 bits including 10 bits of each of the D1 signals DVP1 to DVP3 and 2 bits of the 2-bit additional data DAB(2) and transmitted at the same time are successively divided into two words each formed with 16 bits so as to produce 16-bit word sequence data DU(16) having the word transmission rate of 27 MBps×32/16=54 MBps.

Since the D1 signals DVP1 to DVP3 are in synchronism in phase of horizontal period with one another, the 16-bit word sequence data DU(16) obtained as mentioned above has horizontal period, horizontal blanking period and so on corresponding respectively to the horizontal period, horizontal blanking period and so on of each of the D1 signals DVP1 to DVP3. In the horizontal blanking period of the 16-bit word sequence data DU(16), EAV and SAV based on time reference code data EAV and SAV in each of the D1 signals DVP1 to DVP3 are provided and a group of horizontal synchronous data composed of a plurality of horizontal synchronous word data are also provided between the EAV and the SAV.

The 16-bit word sequence data DU(16) obtained from the signal multiplexing portion 100 are supplied to a synchronous data inserting portion 101. A horizontal synchronous pulse signal SH of each of the Dl signals DVP1 to DVP3 is also supplied to the synchronous data inserting portion 101. In the synchronous data inserting portion 101, the 16-bit word sequence data DU(16) from the signal multiplexing portion 100 are guided to a data selecting portion 102 to which an additional word data group DWS having the word transmission rate of 54 MBps are supplied from a word data supplying portion 103. The additional word data group DWS is constituted with a plurality of 16-bit word data including word synchronous data allotted a predetermined specific code.

Further, in the synchronous data inserting portion 101, the horizontal synchronous pulse signal SH is supplied to a control signal producing portion 104. In the control signal producing portion 104, control signals CWD and CDS, each of which is in synchronism with the horizontal synchronous pulse signal SH, are produced. The control signal CWD is supplied to the word data supplying portion 103 and the control signal CDS is supplied to the data selecting portion 102. The additional word data group DWS is derived in response to the control signal CWD from the word data supplying portion 103 to be supplied to the data selecting portion 102.

The data selecting portion 102 is operative to derive selectively the additional word data group DWS when the control signal CDS is supplied and the 16-bit word sequence data DU(16) when the control signal CDS is not supplied so that the additional word data group DWS is inserted in response to the control signal CDS into the horizontal blanking period in each horizontal period of the 16-bit word sequence data DU(16).

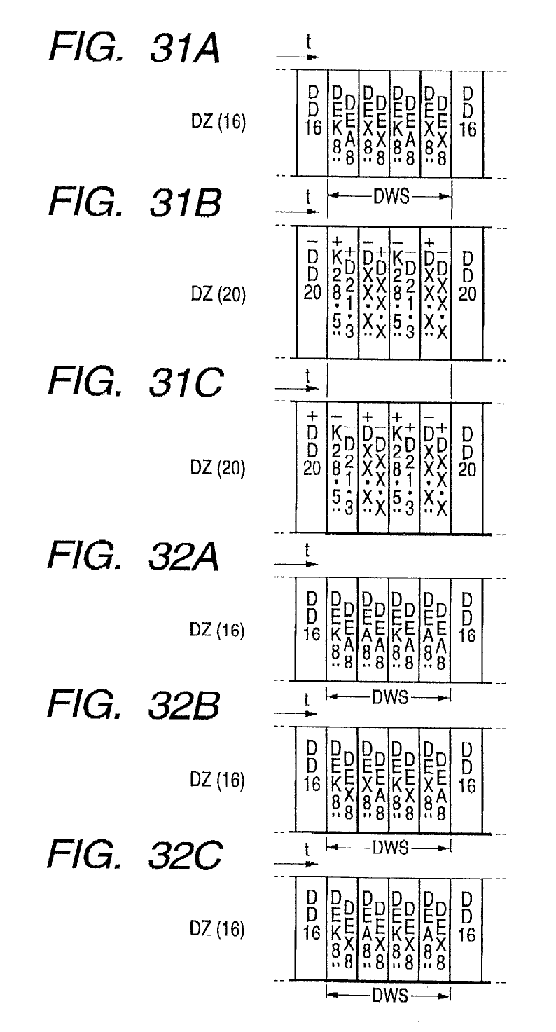

Such data insertion by which the additional word data group DWS is inserted into the 16-bit word sequence data DU(16) is concretely carried out, for example, in the manner as shown in FIG. 30. That is, a plurality of horizontal synchronous word data positioned just before the SAV in the horizontal blanking period in each horizontal period of the 16-bit word sequence data DU(16) are replaced with the additional word data group DWS.

The timing of such data replacement by which the horizontal synchronous word data positioned just before the SAV are replaced with the additional word data group DWS is set by the control signals CWD and CDS. Then, the 18-bit word sequence data DU(16) having the horizontal blanking period in each horizontal period into which the additional word data group DWS is inserted are obtained from the data selecting portion 102 as 16-bit word sequence data DZ(16) having the word transmission rate of 54 MBps.

The additional word data group DWS supplied from the word data supplying portion 103 is constituted with a plurality of 16-bit word data including 8-bit word synchronous data DEK8 allotted a predetermined specific code and specific 16-bit ancillary word data in the form of 16-bit word data. An example of the additional word data group DWS is formed to have at least a couple of groups of two 16-bit word data arranged in series, each of which includes first 16-bit word data which are composed of 8-bit word synchronous data DEK8 and specific 8-bit word ancillary data DEA8 multiplexed with each other and second 16-bit word data which are composed of two optional 8-bit word ancillary data DEX8 for reversing the running disparity multiplexed with each other.

The 8-bit word synchronous data DEK8, the specific 8-bit word ancillary data DEA8 and the optional 8-bit word ancillary data DEX8 for reversing the running disparity are the same as those included in the additional word data group DWS supplied from the word data supplying portion 53 in FIG. 17 and explained above.

A portion of the 16-bit word sequence data DZ(16) in which the example of the additional word data group DWS mentioned above is inserted is shown in FIG. 31A. In FIG. 31A, DD16 represents 16-bit word data contained in the 16-bit word sequence data DU(16) obtained from the signal multiplexing portion 100 and an arrow t represents elapsing time.

Another example of the additional word data group DWS supplied from the word data supplying portion 103 is formed to have, for example, at least a couple of groups of two 16-bit word data arranged in series, each of which includes first 16-bit word data which are composed of 8-bit word synchronous data DEK8 and specific 8-bit word ancillary data DEA8 multiplexed with each other and second 16-bit word data which are composed of two specific 8-bit word ancillary data DEA8 multiplexed with each other, at least a couple of groups of two 16-bit word data arranged in series, each of which includes first 16-bit word data which are composed of 8-bit word synchronous data DEK8 and optional 8-bit word ancillary data DEX8 for reversing the running disparity multiplexed with each other and second 16-bit word data which are composed of optional 8-bit word ancillary data DEX8 for reversing the running disparity and specific 8-bit word ancillary data DEA8 multiplexed with each other, or at least a couple of groups of two 16-bit word data arranged in series, each of which includes first 16-bit word data which are composed of 8-bit word synchronous data DEK8 and optional 8-bit word ancillary data DEX8 for reversing the running disparity multiplexed with each other and second 16-bit word data which are composed of specific 8-bit word ancillary data DEA8 and optional 8-bit word ancillary data DEX8 for reversing the running disparity multiplexed with each other.

A portion of the 16-bit word sequence data DZ(16) in which another example of the additional word data group DWS mentioned above is inserted is shown in FIG. 32A, 32B or 32C. In each of FIGS. 32A, 32B and 32C, DD16 represents 16-bit word data contained in the 16-bit word sequence data DU(16) obtained from the signal multiplexing portion 100 and an arrow t represents elapsing time.

The 16-bit word sequence data DZ(16) containing the additional word data group DWS obtained from the data selecting portion 102 to have the word transmission rate of 54 MBps is derived from the synchronous data inserting portion 101 to be supplied to an 8B/10B converting and word sequence data producing portion 105.

In the 8B/10B converting and word sequence data producing portion 105, the 16-bit word sequence data DZ(16) are subjected to 8B/10B conversion by which every sixteen bits constituting each word of the 16-bit word sequence data DZ(16) are divided into a couple of groups of eight bits and every group of eight bits is converted into a group of ten bits in accordance with a predetermined conversion table. Then, every successive two group of ten bits are multiplexed with each other to form 20-bit word data and the 20-bit word data thud formed are derived successively to produce composite 20-bit word sequence data DZ(20) having the word transmission rate of 54 MBps.

In such 8B/10B conversion, the 8-bit word synchronous data DEK8 are converted into 10-bit word synchronous data K 28.5, the specific 8-bit word ancillary data DEA8 are converted into 10-bit word data D21.3, the optional 8-bit word ancillary data DEX8 are converted into 10-bit word data DXX.X, and the 16-bit word data DD16 are converted into 20-bit word data DD20.

Accordingly, if such an additional word data group DWS as shown in FIG. 31A is inserted into the 16-bit word sequence data DZ(16), a portion of the composite 20-bit word sequence data DZ(20) formed based on the additional word data group DWS are so formed that the first K28.5 is provided with the positive running disparity to be +K28.5 and the second K28.5 is provided with the negative running disparity to be −K28.5 when the running disparity just before the 20-bit word data containing the first K28.5 is negative, as shown in FIG. 31B, and a portion of the composite 20-bit word sequence data DZ(20) formed based on the additional word data group DWS are so formed that the first K28.5 is provided with the negative running disparity to be −K28.5 and the second K28.5 is provided with the positive running disparity to be +K28.5 when the running disparity just before the 20-bit word data containing the first K28.5 is positive, as shown in FIG. 31C.

In either case, two 10-bit word synchronous data K28.5, one of which are +K28.5, are contained in the portion of the composite 20-bit word sequence data DZ(20) formed based on the additional word data group DWS.

Further, in the case where such an additional word data group DWS as shown in FIG. 32A, 32B or 32C is inserted into the composite 16bit word sequence data DZ(16), two 10-bit word synchronous data K28.5, one of which are +K28.5, are also contained in the portion of the composite 20-bit word sequence data DZ(20) formed based on the additional word data group DWS in the same manner as the case where the additional word data group DWS shown in FIG. 31A is inserted into the 16-bit word sequence data DZ(16).

The composite 20-bit word sequence data DZ(20) having the word transmission rate of 54 MBps and obtained from the 8B/10B converting and word sequence data producing portion 105, are supplied to a P/S converting portion 106. In the P/S converting portion 106, the composite 20-bit word sequence data DZ(20) are subjected to P/S conversion by which parallel data are converted into serial data to produce serial data DZS based on the composite 20-bit word sequence data DZ(20) and having the bit transmission rate of 54 MBps×20=1.08 Gbps. The serial data DZS thus obtained are supplied from the P/S converting portion 106 to a data transmitting portion 107.

The data transmitting portion 107 is operative to convert the serial data DZS to a transmittal signal SZ which is, for example, an electric signal suitable for transmission through a data transmission line made of a coaxial cable or an optical signal suitable for transmission through a data transmission line made of an optical fiber, and to transmit the transmittal signal SZ through a data transmission line so that the serial data DZS are substantially transmitted.

In the embodiment shown in FIG. 29, the P/S converting portion 106 and the data transmitting portion 107 are operative to cause the composite 20-bit word sequence data DZ(20) having the word transmission rate of 54 MBps to be subjected to the P/S conversion to produce the serial data DZS having the bit transmission rate of 1.08 GBps and to transmit the serial data DZS. Accordingly, the P/S converting portion 106 and the data transmitting portion 107 can be constituted,for example, by utilizing effectively integrated circuit (IC) devices which have been previously proposed to be used for digital data transmission under the Fibre Channel System or the like. Consequently, a plurality of compressed digital video or video and audio signal data, for example, three channels of D1 signals DVP1 to DVP3 and 2-bit additional data DAB(2) can be transmitted in such a manner that word sequence data containing word synchronous data are formed based on the compressed digital video or video and audio signal data to be transmitted and then subjected to 8B/10B conversion to produce converted sequence data and the converted sequence data thus produced are further converted into serial data to be transmitted.

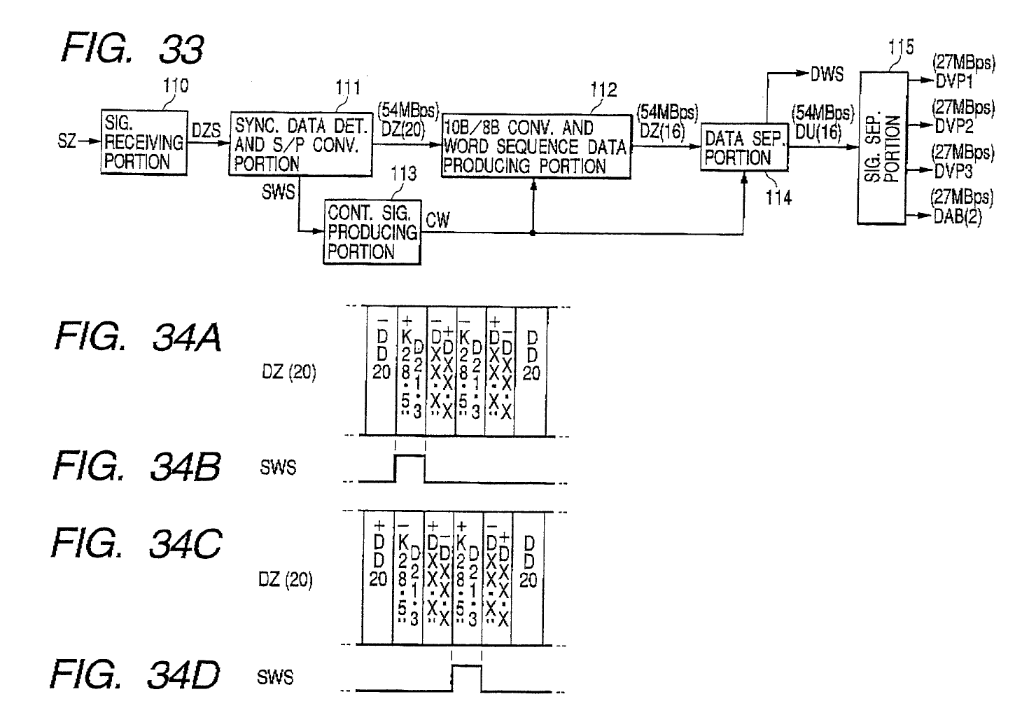

FIG. 33 shows an embodiment of data receiving apparatus for receiving the transmittal signal SZ formed based on the serial data DZS, which are obtained by causing the composite 20-bit word sequence data DZ(20) to be subjected to the P/S conversion and transmitted from the data transmitting portion 107 of the apparatus shown in FIG. 29.

Referring to FIG. 33, a signal receiving portion 110 is provided for receiving a transmittal signal SZ which is, for example, an electric signal suitable for transmission through a data transmission line made of a coaxial cable or an optical signal suitable for transmission through a data transmission line made of an optical fiber. The signal receiving portion 110 is operative to reproduce serial data DZS based on the transmittal signal SZ received thereby and supplies a synchronous data detecting and S/P converting portion 111 with the serial data DZS.

In the synchronous data detecting and S/P converting portion 111, such a portion of the serial data DZS that is formed with serial data converted from 10-bit word synchronous data of +K28.5 or −K28.5 is detected as synchronous data and the serial data DZS are subjected to S/P conversion under a word synchronism condition in accordance with the detected synchronous data to produce composite 20-bit word sequence data DZ(20) having the word transmission rate of, for example, 54 MBps, as shown in FIG. 34A or FIG. 34C. The composite 20-bit word sequence data DZ(20) shown in FIG. 34A or FIG. 34C. are formed selectively in response to the contents of additional word data group DWS contained therein and the running disparity just before the 20-bit word data containing the first K28.5 in the additional word data group DWS.

Then, the composite 20-bit word sequence data DZ(20) having the word transmission rate of 54 MBps and obtained from the synchronous data detecting and S/P converting portion 111 are supplied to a 10B/8B converting and word sequence data producing portion 112.

Further, in the synchronous data detecting and S/P converting portion 111, the 20-bit word data containing the +K28.5 or −K28.5 in the portion of the composite 20-bit word sequence data DZ(20) formed based on the additional word data group DWS are detected and a K28.5 detection output signal SWS is produced to be supplied to a control signal producing portion 113. The K28.5 detection output signal SWS is obtained in response to the contents of the portion of the composite 20-bit word sequence data DZ(20) formed based on the additional word data group DWS, for example, as shown in FIG. 34B or FIG. 34D.

In the 10B/8B converting and word sequence data producing portion 112, the composite 20-bit word sequence data DZ(20) is subjected to 10B/8B conversion by which every twenty bits constituting each word of the composite 20-bit word sequence data DZ(20) are divided into a couple of groups of ten bits and every group of ten bits is converted into a group of eight bits in accordance with a predetermined conversion table. Then, every successive two group of eight bits are multiplexed with each other to form 16-bit word data and the 16-bit word data thud formed are derived successively to produce 16-bit word sequence data DZ(16) having the word transmission rate of 54 MBps.

The 16-bit word sequence data DZ(16) thus obtained in the 10B/8B converting and word sequence data producing portion 112 are supplied to a data separating portion 114. The synchronous control signal CW obtained from the control signal producing portion 113 is also supplied to the data separating portion 114.

In the data separating portion 114, the additional word data group DWS is separated from the 16-bit word sequence data DZ(16) with use of the synchronous control signal CW from the control signal producing portion 113, and 16-bit word sequence data DU(16) obtained based on the 16-bit word sequence data DZ(16) to have the word transmission rate of 54 MBps and the additional word data group DWS are separately obtained.

The 16-bit word sequence data DU(16) thus obtained from the data separating portion 114 is supplied to a signal separating portion 115. In the signal separating portion 115, each 32 bits forming successive 2 word data of the 16-bit word sequence data DU(16) are divided into three groups of 10 bits and 2 bits. Then, each 10 bits in each of three groups are derived successively to produce three 10-bit word sequence data each having the word transmission rate of 54 MBps/2=27 MBps and each 2 bits are derived successively to produce 2-bit word sequence data having the word transmission rate of 54 MBps/4=27 MBps. As a result, three channels of D1 signals DVP1 to DVP3, each of which are 10-bit word sequence data having the word transmission rate of 27 MBps and 2-bit additional data DAB(2) which are 2-bit word sequence data having the word transmission rate of 27 MBps are derived separately from the signal separating portion 115. In such a manner as mentioned above, the three channels of D1 signals DVP1 to DVP3 which are a plurality of digital video signals and 2-bit additional data DAB(2) which are a bit adding signal are reproduced.

Although three channels of D1 signals and 2-bit additional data DAB(2) are multiplexed and transmitted by the method for transmitting digital data carried out in each of the embodiments shown in FIG. 29, digital data to be transmitted should not be limited to the D1 signal but may be other digital video signal without the combination with a bit adding signal, such as the 2-bit additional data DAB(2). Further, the number of channels of digital video signals to be transmitted should not be restricted to three.

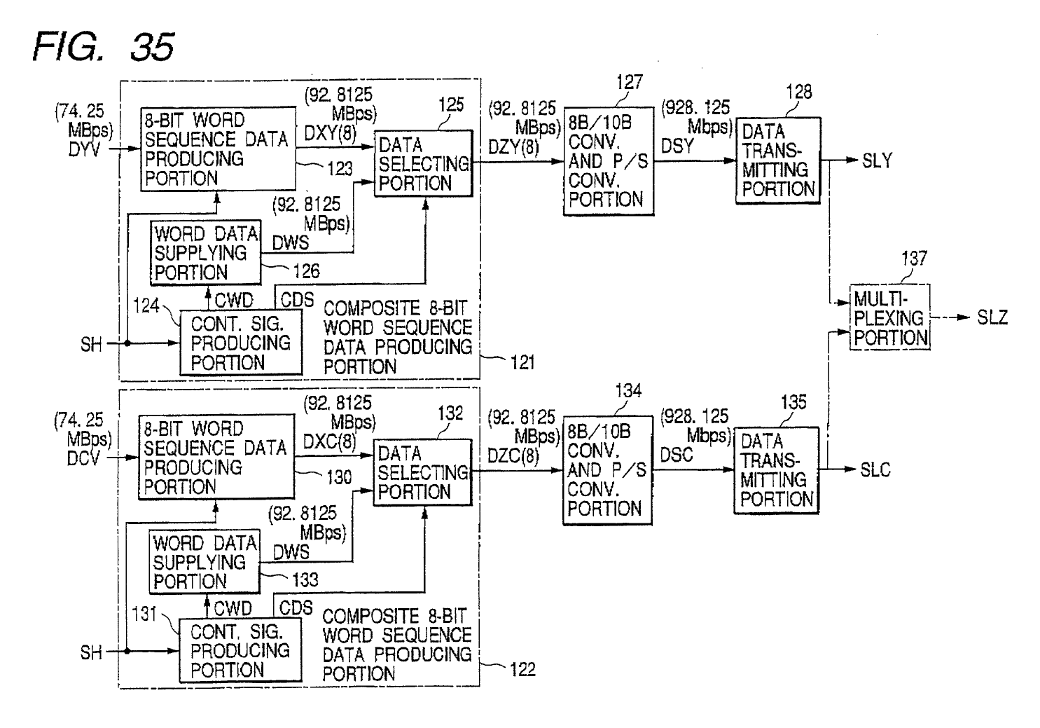

FIG. 35 shows a sixth embodiment of apparatus for transmitting digital data according to the present invention, in which a sixth embodiment of method of transmitting digital data according to the present invention is carried out.

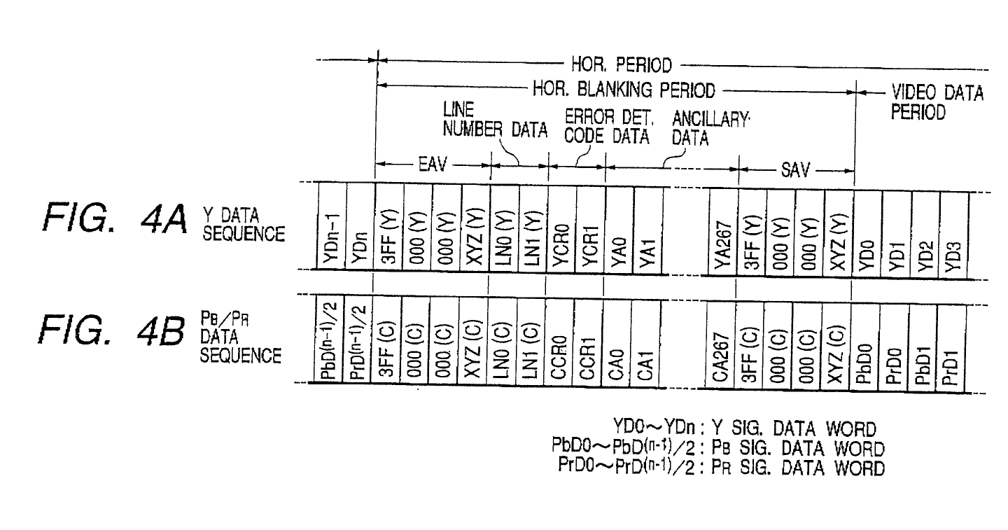

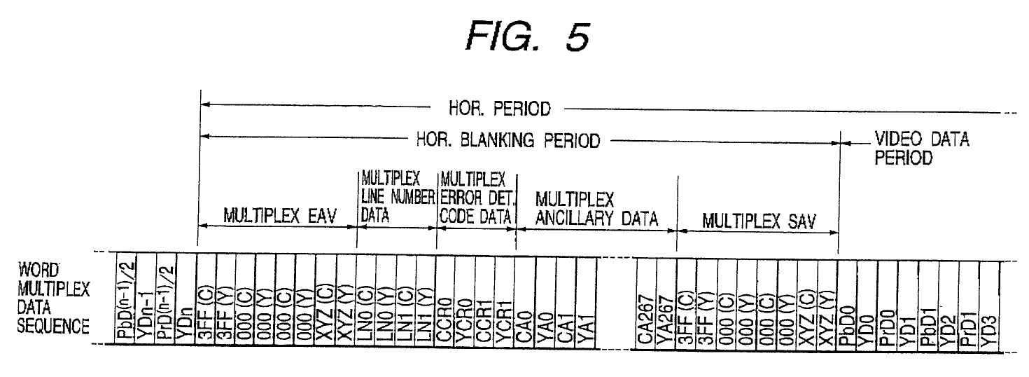

Referring to FIG. 35, a Y data sequence DYV, such as the Y data sequence shown in FIG. 4A, which represents luminance signal information data consisting partially an HD signal and a PB/PR data sequence DCV, such as the PB/PR data sequence shown in FIG. 4B, which represents chrominance signal information data consisting partially the HD signal are supplied as first and second digital information data to composite 8-bit word sequence data producing portions 121 and 122, respectively. Each of the Y data sequence DYV and the PB/PR data sequence DCV is constituted with 10-bit word sequence data having the word transmission rate of, for example, 74.25 MBps.

A horizontal synchronous pulse signal SH related to the Y data sequence DYV is also supplied to the composite 8-bit word sequence data producing portion 121 to which the Y data sequence DYV is supplied.

In the composite 8-bit word sequence data producing portion 121, the Y data sequence DYV is guided to an 8-bit word sequence data producing portion 123 and the horizontal synchronous pulse signal SH is guided to the 8-bit word sequence data producing portion 123 and a control signal producing portion 124.

In the 8-bit word sequence data producing portion 123, the Y data sequence DYV is converted into word sequence data, each word of which is composed of ten bits, with time reference according to the horizontal synchronous pulse signal SH to produce 8-bit word sequence data DXY(8) having the word transmission rate of 74.25 MBps×10/8=92.8125 MBps. The 8-bit word sequence data DXY(8) obtained from the 8-bit word sequence data producing portion 123 are supplied to a data selecting portion 125.

An additional word data group DWS having the word transmission rate of 92.8125 MBps is supplied from a word data supplying portion 126 to the data selecting portion 125. The additional word data group DWS is constituted with a plurality of 8-bit word data including word synchronous data allotted a predetermined specific code.

In the control signal producing portion 124, control signals CWD and CDS, each of which is in synchronism with the horizontal synchronous pulse signal SH, are produced. The control signal CWD is supplied to the word data supplying portion 126 and the control signal CDS is supplied to the data selecting portion 125. The additional word data group DWS is derived in response to the control signal CWD from the word data supplying portion 126 to be supplied to the data selecting portion 125.

The data selecting portion 125 is operative to derive selectively the additional word data group DWS when the control signal CDS is supplied and the 8-bit word sequence data DXY(8) when the control signal CDS is not supplied so that the additional word data group DWS is inserted in response to the control signal CDS into a horizontal blanking period in each horizontal period of the 8-bit word sequence data DXY(8).

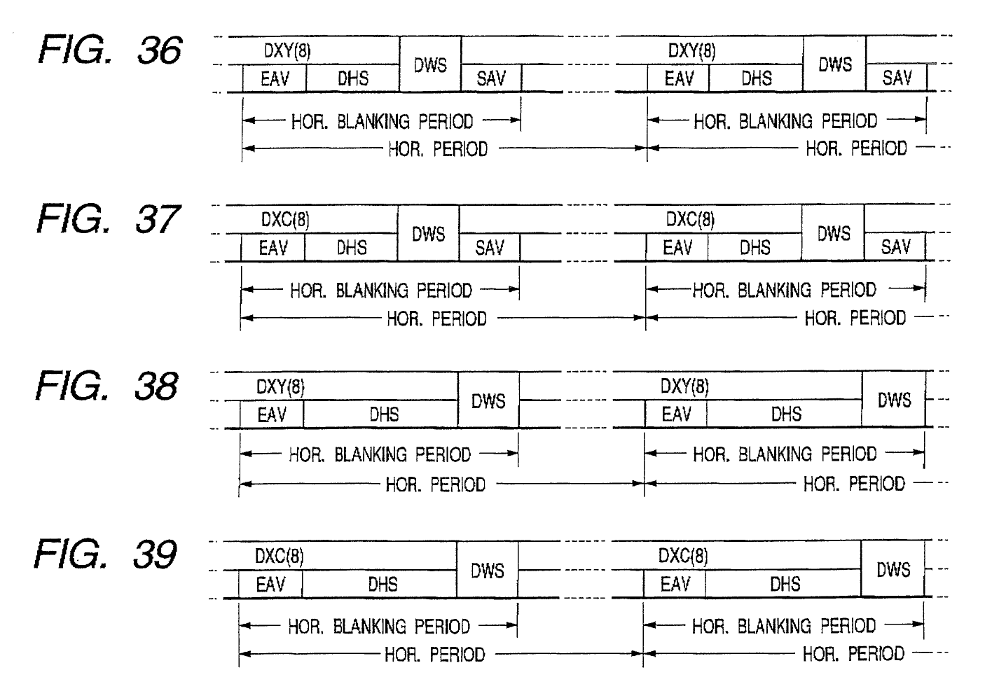

Such data insertion in which the additional word data group DWS is inserted into the 8-bit word sequence data DXY(8) is concretely carried out, for example, in the manner as shown in FIG. 36. That is, a plurality of horizontal synchronous word data DHS positioned just before time reference code data SAV in the horizontal blanking period in each horizontal period of the 8-bit word sequence data DXY(8) are replaced with the additional word data group DWS. The timing of such data replacement by which the horizontal synchronous word data DHS positioned just before the SAV are replaced with the additional word data group DWS is set by the control signals CWD and CDS. Then, the 8-bit word sequence data DXY(8) having the horizontal blanking period in each horizontal period into which the additional word data group DWS is inserted are obtained from the data selecting portion 125 as composite 8-bit word sequence data DZY(8) having the word transmission rate of 92. 8125 MBps.

The additional word data group DWS having the word transmission rate of 92.8125 MBps and supplied from the word data supplying portion 126 is constituted with a plurality of 8-bit word data including 8-bit word synchronous data DEK8 allotted the predetermined specific code, optional 8-bit word ancillary data DEX8 and so on. An example of the additional word data group DWS is formed with four 8-bit word data includes 8-bit word synchronous data DEK8 and three optional 8-bit word ancillary data DEX8 following the 8-bit word synchronous data DEK8 in series.

The 8-bit word synchronous data DEK8 and the optional 8-bit word ancillary data DEX8 are the same as those included in the additional word data group DWS supplied from the word data supplying portion 53 in FIG. 17.

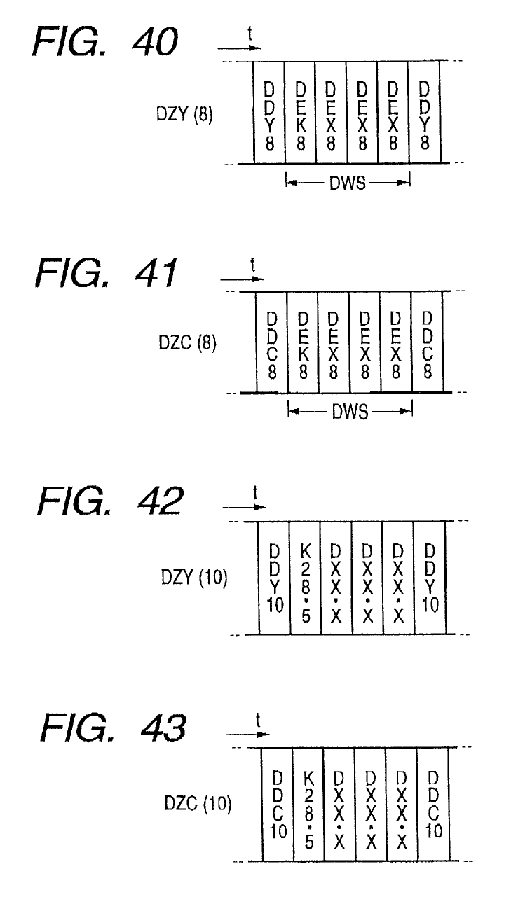

A portion of the composite 8-bit word sequence data DZY(8) in which the example of the additional word data group DWS mentioned above is inserted is shown in FIG. 40. In FIG. 40, DDY8 represents 8-bit word data contained in the 8-bit word sequence data DXY(8) obtained from the 8-bit word sequence data producing portion 123 and an arrow t represents elapsing time.

Another embodiment of the data insertion in which the additional word data group DWS is inserted into the 8-bit word sequence data DXY(8) is carried out in the manner as shown in FIG. 38. That is, the SAV following a plurality of horizontal synchronous word data DHS in the horizontal blanking period in each horizontal period of the 8-bit word sequence data DXY(8) are replaced with the additional word data group DWS. The timing of such data replacement by which the SAV are replaced with the additional word data group DWS is set by the control signals CWD and CDS. Then, the 8-bit word sequence data DXY(8) having the horizontal blanking period in each horizontal period into which the additional word data group DWS is inserted are obtained from the data selecting portion 125 as composite 8-bit word sequence data DZY(8) having the word transmission rate of 92.8125 MBps.

In such a case, the additional word data group DWS is formed with, for example, four 8-bit word data includes 8-bit word synchronous data DEK8 and three optional 8-bit word ancillary data DEX8 following the 8-bit word synchronous data DEK8 in series and a portion of the composite 8-bit word sequence data DZY(8) in which the additional word data group DWS mentioned above is inserted is shown in FIG. 40.

The composite 8-bit word sequence data DZY(8) containing the additional word data group DWS obtained from the data selecting portion 125 to have the word transmission rate of 92.8125 MBps is derived from the composite 8-bit word sequence data producing portion 121 to be supplied to an 8B/10B converting and P/S converting portion 127.

In the 8B/10B converting and P/S converting portion 127, the composite 8-bit word sequence data DZY(8) are subjected to 8B/10B conversion by which every eight bits constituting each word of the composite 8-bit word sequence data DZY(8) are converted into ten bits in accordance with a predetermined conversion table to produce composite 10-bit word sequence data DZY(10) having the word transmission rate of 92.8125 MBps. In such 8B/10B conversion, the 8-bit word synchronous data DEK8 are converted into 10-bit word synchronous data K 28.5, the optional 8-bit word ancillary data DEX8 are converted into 10-bit word data DXX.X, and the 8-bit word data DDY8 are converted into 10-bit word data DDY10.

Accordingly, if such an additional word data group DWS as shown in FIG. 40 is inserted into the composite 8-bit word sequence data DZY(8), a portion of the composite 10-bit word sequence data DZY(10) formed based on the additional word data group DWS are so formed as to be shown in FIG. 42, and the 10-bit word synchronous data K28.5 are contained in the portion of the composite 10-bit word sequence data DZY(10) formed based on the additional word data group DWS.

In addition to the above, in the 8B/10B converting and P/S converting portion 127, the composite 10-bit word sequence data DZY(10) which are obtained by causing the composite 8-bit word sequence data DZY(8) to be subjected to the 8B/10B conversion to have the word transmission rate of 92.8125 MBps, are subjected to P/S conversion by which parallel data are converted into serial data to produce serial data DSY based on the composite 10-bit word sequence data DZY(10) and having the bit transmission rate of 92.8125 MBps×10=928.125 Mbps. The serial data DSY thus obtained are supplied from the 8B/10B converting and P/S converting portion 127 to a data transmitting portion 128.

The data transmitting portion 128 is operative to convert the serial data DSY to a transmittal signal SLY which is, for example, an electric signal suitable for transmission through a data transmission line made of a coaxial cable or an optical signal suitable for transmission through a data transmission line made of an optical fiber, and to transmit the transmittal signal SLY through a data transmission line so that the serial data DSY are substantially transmitted.

Further, a horizontal synchronous pulse signal SH related to the PB/PR data sequence DCV is also supplied to the composite 8-bit word sequence data producing portion 122 to which the PB/PR data sequence DCV is supplied.

In the composite 8-bit word sequence data producing portion 122, the PB/PR data sequence DCV is guided to an 8-bit word sequence data producing portion 130 and the horizontal synchronous pulse signal SH is guided to the 8-bit word sequence data producing portion 130 and a control signal producing portion 131.

In the 8-bit word sequence data producing portion 130, the PB/PR data sequence DCV is converted into word sequence data, each word of which is composed of ten bits, with time reference according to the horizontal synchronous pulse signal SH to produce 8-bit word sequence data DXC(8) having the word transmission rate of 74.25 MBps×10/8=92.8125 MBps. The 8-bit word sequence data DXC(8) obtained from the 8-bit word sequence data producing portion 130 are supplied to a data selecting portion 132.

An additional word data group DWS having the word transmission rate of 92.8125 MBps is supplied from a word data supplying portion 133 to the data selecting portion 132. The additional word data group DWS is constituted with a plurality of 8-bit word data including word synchronous data allotted a predetermined specific code.

In the control signal producing portion 131, control signals CWD and CDS, each of which is in synchronism with the horizontal synchronous pulse signal SH, are produced. The control signal CWD is supplied to the word data supplying portion 133 and the control signal CDS is supplied to the data selecting portion 132. The additional word data group DWS is derived in response to the control signal CWD from the word data supplying portion 133 to be supplied to the data selecting portion 132.

The data selecting portion 132 is operative to derive selectively the additional word data group DWS when the control signal CDS is supplied and the 8-bit word sequence data DXC(8) when the control signal CDS is not supplied so that the additional word data group DWS is inserted in response to the control signal CDS into a horizontal blanking period in each horizontal period of the 8-bit word sequence data DXC(8).

Such data insertion in which the additional word data group DWS is inserted into the 8-bit word sequence data DXC(8) is concretely carried out, for example, in the manner as shown in FIG. 37 or FIG. 39. That is, a plurality of horizontal synchronous word data DHS positioned just before time reference code data SAV or the time reference code data SAV in the horizontal blanking period in each horizontal period of the 8-bit word sequence data DXC(8) are replaced with the additional word data group DWS. The timing of such data replacement by which the horizontal synchronous word data DHS positioned just before the SAV are replaced with the additional word data group DWS is set by the control signals CWD and CDS. Then, the 8-bit word sequence data DXC(8) having the horizontal blanking period in each horizontal period into which the additional word data group DWS is inserted are obtained from the data selecting portion 132 as composite 8-bit word sequence data DZC(8) having the word transmission rate of 92.8125 MBps.

The additional word data group DWS having the word transmission rate of 92.8125 MBps and supplied from the word data supplying portion 133 is constituted with a plurality of 8-bit word data including 8-bit word synchronous data DEK8 allotted the predetermined specific code, optional 8-bit word ancillary data DEX8 and so on. An example of the additional word data group DWS is formed with four 8-bit word data includes 8-bit word synchronous data DEK8 and three optional 8-bit word ancillary data DEX8 following the 8-bit word synchronous data DEK8 in series.

A portion of the composite 8-bit word sequence data DZC(8) in which the example of the additional word data group DWS mentioned above is inserted is shown in FIG. 41. In FIG. 41, DDC8 represents 8-bit word data contained in the 8-bit word sequence data DXC(8) obtained from the 8-bit word sequence data producing portion 130 and an arrow t represents elapsing time.

The composite 8-bit word sequence data DZC(8) containing the additional word data group DWS obtained from the data selecting portion 132 to have the word transmission rate of 92.8125 MBps is derived from the composite 8-bit word sequence data producing portion 122 to be supplied to an 8B/10B converting and P/S converting portion 134.

In the 8B/10B converting and P/S converting portion 134, the composite 8-bit word sequence data DZC(8) are subjected to 8B/10B conversion by which every eight bits constituting each word of the composite 8-bit word sequence data DZC(8) are converted into ten bits in accordance with a predetermined conversion table to produce composite 10-bit word sequence data DZC(10) having the word transmission rate of 92.8125 MBps. In such 8B/10B conversion, the 8-bit word synchronous data DEK8 are converted into 10-bit word synchronous data K 28.5, the optional 8-bit word ancillary data DEX8 are converted into 10-bit word data DXX.X, and the 8-bit word data DDC8 are converted into 10-bit word data DDC10.

Accordingly, if such an additional word data group DWS as shown in FIG. 41 is inserted into the composite 8-bit word sequence data DZC(8), a portion of the composite 10-bit word sequence data DZC(10) formed based on the additional word data group DWS are so formed as to be shown in FIG. 43, and the 10-bit word synchronous data K28.5 are contained in the portion of the composite 10-bit word sequence data DZC(10) formed based on the additional word data group DWS.

In addition to the above, in the 8B/10B converting and P/S converting portion 134, the composite 10-bit word sequence data DZC(10) which are obtained by causing the composite 8-bit word sequence data DZC(8) to be subjected to the 8B/10B conversion to have the word transmission rate of 92.8125 MBps, are subjected to P/S conversion by which parallel data are converted into serial data to produce serial data DSC based on the composite 10-bit word sequence data DZC(10) and having the bit transmission rate of 92.8125 MBps×10=928.125 Mbps. The serial data DSC thus obtained are supplied from the 8B/10B converting and P/S converting portion 134 to a data transmitting portion 135.

The data transmitting portion 135 is operative to convert the serial data DSC to a transmittal signal SLC which is, for example, an electric signal suitable for transmission through a data transmission line made of a coaxial cable or an optical signal suitable for transmission through a data transmission line made of an optical fiber, and to transmit the transmittal signal SLC through a data transmission line so that the serial data DSC are substantially transmitted.

In the case where the transmittal signals SLY and SLC are optical signals, it is possible that the transmittal signals SLY and SLC are so produced as to be different in wavelength from each other and multiplexed to be transmitted through a common data transmission line made of an optical fiber. A multiplexing portion 137 shown with a dotdash line in FIG. 35 is used in such a case for multiplexing the transmittal signals SLY and SLC with each other to produce a multiplexed transmittal signal SLZ to be transmitted through the common data transmission line.

In the embodiment shown in FIG. 35, the 8B/10B converting and P/S converting portion 127 and the data transmitting portion 128 are operative to cause the composite 8-bit word sequence data DZY(8) having the word transmission rate of 92.8125 MBps to be subjected to the 8B/10B conversion to produce the composite 10-bit word sequence data DZY(10) having the word transmission rate of 92.8125 MBps, to cause the composite 10-bit word sequence data DZY(10) to be subjected to the P/S conversion to produce the serial data DSY having the bit transmission rate 928.125 Mbps and to transmit the serial data DSY. Further, the 8B/10B converting and P/S converting portion 134 and the data transmitting portion 135 are operative to cause the composite 8-bit word sequence data DZC(8) having the word transmission rate of 92.8125 MBps to be subjected to the 8B/10B conversion to produce the composite 10-bit word sequence data DZC(10) having the word transmission rate of 92.8125 MBps, to cause the composite 10-bit word sequence data DZC(10) to be subjected to the P/S conversion to produce the serial data DSC having the bit transmission rate 928.125 Mbps and to transmit the serial data DSC.

Accordingly, the 8B/10B converting and P/S converting portions 127 and 134 and the data transmitting portions 128 and 135 can be constituted, for example, by utilizing effectively integrated circuit (IC) devices which have been previously proposed to be used for digital data transmission under the Fibre Channel System or the like. Consequently, a plurality of digital information data, such as the Y data sequence DYV and the PB/PR data sequence DCV, can be transmitted in such a manner that 8-bit word sequence data containing 8-bit word synchronous data are formed based on the digital information data to be transmitted and then subjected to 8B/10B conversion to produce 10-bit word sequence data containing 10-bit word synchronous data and the 10-bit word sequence data thus produced are further converted into serial data to be transmitted.

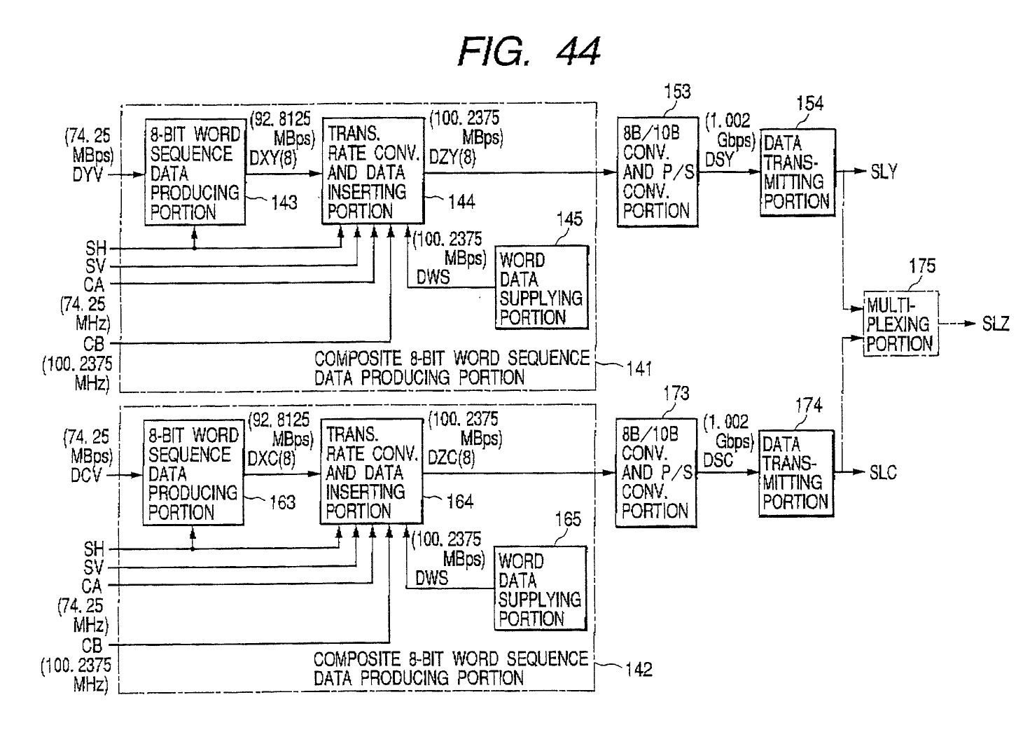

FIG. 44 shows a seventh embodiment of apparatus for transmitting digital data according to the present invention, in which a seventh embodiment of method of transmitting digital data according to the present invention is carried out.

Referring to FIG. 44, a Y data sequence DYV, such as the Y data sequence shown in FIG. 4A, which represents luminance signal information data consisting partially an HD signal and a PB/PR data sequence DCV,such as the Y data sequence shown in FIG. 4b, which represents chrominance signal information data consisting partially the HD signal are supplied as first and second digital information data to composite 8-bit word sequence data producing portions 141 and 142, respectively. Each of the Y data sequence DYV and the PB/PR data sequence DCV is constituted with 10-bit word sequence data having the word transmission rate of, for example, 74.25 MBps.

Horizontal and vertical synchronous pulse signals SH and SV relative to the Y data sequence DYV, a clock pulse signal CA which has the frequency of 74.25 MHz and is in synchronism with a word clock signal of the Y data sequence DYV and another clock pulse signal CB having the frequency 100.2375 MHz are also supplied to the composite 8-bit word sequence data producing portion 141.

In the composite 8-bit word sequence data producing portion 141, the Y data sequence DYV and the horizontal synchronous pulse signal SH are guided to an 8-bit word sequence data producing portion 143, and the horizontal synchronous pulse signal SH, the vertical synchronous pulse signal SV, the clock pulse signal CA and the clock pulse signal CB are guided to a transmission rate converting and data inserting portion 144.

In the 8-bit word sequence data producing portion 143, the Y data sequence DYV is converted into word sequence data, each word of which is composed of ten bits, with time reference according to the horizontal synchronous pulse signal SH to produce 8-bit word sequence data DXY(8) having the word transmission rate of 74.25 MBps×10/8=92.8125 MBps. The 8-bit word sequence data DXY(8) obtained from the 8-bit word sequence data producing portion 143 are supplied to the transmission rate converting and data inserting portion 144.

An additional word data group DWS having the word transmission rate of 100.2375 MBps is supplied from a word data supplying portion 145 to the transmission rate converting and data inserting portion 144. The additional word data group DWS is constituted with a plurality of 8-bit word data including word synchronous data allotted a predetermined specific code.

In the transmission rate converting and data inserting portion 144, the word transmission rate of the 8-bit word sequence data DXY(8) is converted, for example, from 92.8125 MBps to 100.2375 MBps and then the additional word data group DWS including the 8-bit word synchronous data from the word data supplying portion 145 is inserted into the 8-bit word sequence data DXY(8) at predetermined word intervals thereof to produce composite 8-bit word sequence data DZY(8) having the word transmission rate of 100.2375 MBps. That is, the composite 8-bit word sequence data DZY(8) are produced based on the Y data sequence DYV in the transmission rate converting and data inserting portion 144.

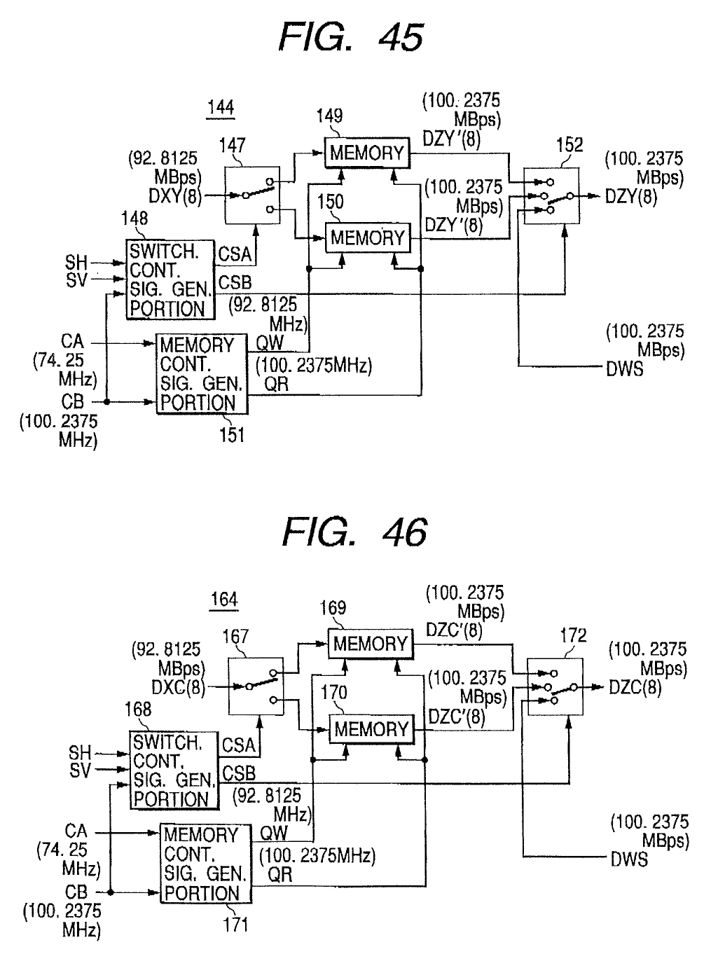

FIG. 45 shows an embodiment of the transmission rate converting and data inserting portion 144. In the embodiment shown in FIG. 45, the 8-bit word sequence data DXY(8) obtained from the 8-bit word sequence data producing portion 143 are supplied to a switch 147. The switch 147 performs switching operations at every predetermined period, for example, every horizontal period of the 8-bit word sequence data DXY(8) in response to a control signal CSA supplied from a switching control signal generating portion 148.

The horizontal synchronous pulse signal SH, the vertical synchronous pulse signal SV and the clock pulse signal CB having the frequency of 100.2375 MHz are supplied to the switching control signal generating portion 148. In the switching control signal generating portion 148, the control signal CSA is produced in response to the horizontal and vertical synchronous pulse signals SH and SV so as to be in synchronism with the horizontal period of the 8-bit word sequence data DXY(8) and a control signal CSB is produced in response to the horizontal synchronous pulse signal SH and the clock pulse signal CB to be in synchronism with the horizontal period of the 8-bit word sequence data DXY(8) so as to be in synchronism with both of the horizontal period of the 8-bit word sequence data DXY(8) and a period corresponding to an integer times the period of the clock pulse signal CB.

Memories 149 and 150 are connected with the switch 147. The switch 147 supplies alternately the memory 149 and the memory 150 with the 8-bit word sequence data DXY(8) at every horizontal period of the 8-bit word sequence data DXY(8) with its switching operations.

A memory control signal generating portion 151 to which the clock pulse signal CA having the frequency of 74.25 MHz and the clock pulse signal CB having the frequency of 100.2375 MHz are supplied, is provided in relation to the memories 149 and 150. The memory control signal generating portion 151 is operative to produce a write control signal QW having the frequency of 74.25 MHz×5/4=92.8125 MHz based on the clock pulse signal CA and a read control signal QR having the frequency of 100.2375 MHz based on the clock pulse signal CB and to supply each of the memories 149 and 150 with the write control signal QW and the read control signal QR.

In the memory 149, the 8-bit word sequence data DXY(8) are written to be stored at the word transmission rate of 92.8125 MBps in accordance with the write control signal QW having the frequency of 92.8125 MHz when the 8-bit word sequence data DXY(8) are supplied through the switch 147 to the memory 149. Similarly, in the memory 150, the 8-bit word sequence data DXY(8) are written to be stored at the word transmission rate of 92.8125 MBps in accordance with the write control signal QW having the frequency of 92.8125 MHz when the 8-bit word sequence data DXY(8) are supplied through the switch 147 to the memory 150. Accordingly, the 8-bit word sequence data DXY(8) having the word transmission rate of 92.8125 MBps are written to be stored in the memories 149 and 150 alternately at every horizontal period of the 8-bit word sequence data DXY(8).

The 8-bit word sequence data DXY(8) stored in the memory 149 during a certain horizontal period of the 8-bit word sequence data DXY(8) are read from the memory 149 during the next horizontal period of the 8-bit word sequence data DXY(8) in accordance with the read control signal QR having the frequency of 100.2375 MHz so as to produce 8-bit word sequence data DZY′(8) having the word transmission rate of 100.2375 MBps. The 8-bit word sequence data DZY′(8) thus obtained from the memory 149 are supplied to a switch 152. The 8-bit word sequence data DXY(8) stored in the memory 150 during a certain horizontal period of the 8-bit word sequence data DXY(8) are read from the memory 150 during the next horizontal period of the 8-bit word sequence data DXY(8) in accordance with the read control signal QR having the frequency of 100.2375 MHz so as to produce 8-bit word sequence data DZY′(8) having the word transmission rate of 100.2375 MBps. The 8-bit word sequence data DZY′(8) thus obtained from the memory 150 are also supplied to the switch 152. The additional word data group DWS having the word transmission rate of 100.2375 MBps is further supplied from the word data supplying portion 145 to the switch 152.

The switch 152 is operative to extract successively the additional word data group DWS having the word transmission rate of 100.2375 MBps and supplied from the word data supplying portion 145, the 8-bit word sequence data DZY′(8) having the word transmission rate of 100.2375 MBps and read from the memory 150 and the 8-bit word sequence data DZY′(8) having the word transmission rate of 100.2375 MBps and read from the memory 149 at every predetermined period corresponding to a predetermined number of 8-bit word data, in response to the control signal CSB supplied from the switching control signal generating portion 148. As a result, the composite 8-bit word sequence data DZY(8), which are obtained by inserting the additional word data group DWS having the word transmission rate of 100.2375 MBps into the 8-bit word sequence data DZY′(8) having the word transmission rate of 100.2375 MBps at predetermined word intervals are derived from the switch 152.

The additional word data group DWS supplied from the word data supplying portion 145 is constituted with a plurality of 8-bit word data including 8-bit word synchronous data DEK8 allotted the predetermined specific code and optional 8-bit word ancillary data DEX8. An example of the additional word data group DWS is constituted with 220 word data (220 Bytes) with beginning and end portions in each of which four 8-bit word data including 8-bit word synchronous data DEK8 and three optional 8-bit word ancillary data DEX8 following the 8-bit word synchronous data DEK8 in series are provided.

The 8-bit word synchronous data DEK8 and the optional 8-bit word ancillary data DEX8 are the same as those included in the additional word data group DWS supplied from the word data supplying portion 126 in shown FIG. 35 and explained above.

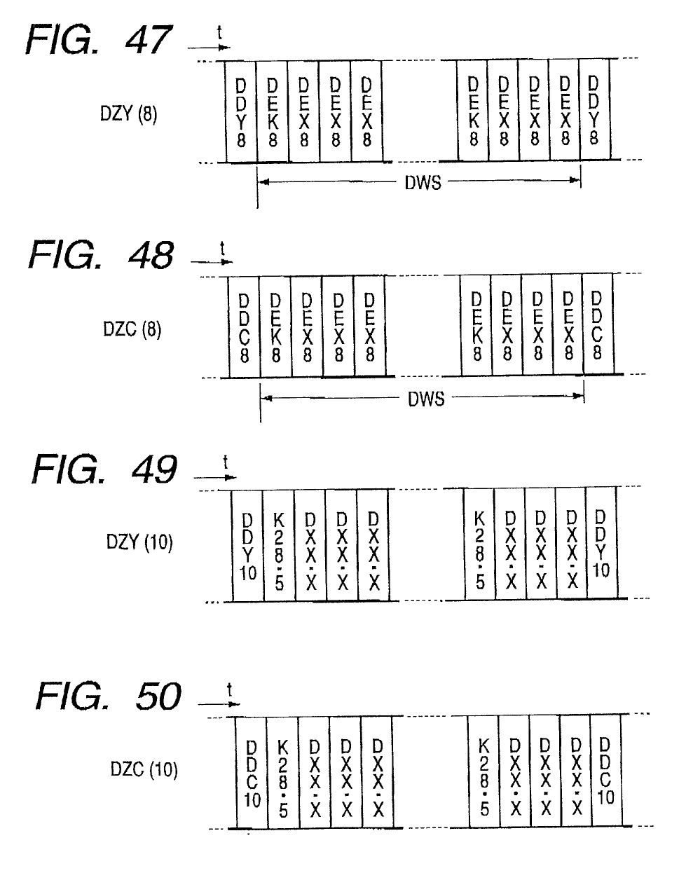

A portion of the composite 8-bit word sequence data DZY(8) in which the example of the additional word data group DWS mentioned above is inserted is shown in FIG. 47. In FIG. 47, DDY8 represents 8-bit word data contained in the 8-bit word sequence data DZY′(8) read from the memories 149 and 150 and an arrow t represents elapsing time.

The composite 8-bit word sequence data DZY(8) obtained in the transmission rate converting and data inserting portion 144 to have the word transmission rate of 100.2375 MBps is derived from the composite 8-bit word sequence data producing portion 141 to be supplied to an 8B/10B converting and P/S converting portion 153.

In the 8B/10B converting and P/S converting portion 153, the composite 8-bit word sequence data DZY(8) are subjected to 8B/10B conversion by which every eight bits constituting each word of the 8-bit word sequence data DZY(8) are converted into ten bits in accordance with a predetermined conversion table to produce composite 10-bit word sequence data DZY(10) having the word transmission rate of 100.2375 MBps. In such 8B/10B conversion, the 8-bit word synchronous data DEK8 are converted into 10-bit word synchronous data K 28.5, the optional 8-bit word ancillary data DEX8 are converted into 10-bit word data DXX.X, and the 8-bit word data DDY8 are converted into 10-bit word data DDY10.

Accordingly, if such an additional word data group DWS as shown in FIG. 47 is inserted into the composite 8-bit word sequence data DZY(8), a portion of the composite 10-bit word sequence data DZY(10) formed based on the additional word data group DWS are so formed as to be shown in FIG. 49 and a couple of 10-bit word synchronous data K28.5 are contained in the portion of the composite 10-bit word sequence data DZY(10) formed based on the additional word data group DWS.

In addition to the above, in the 8B/10B converting and P/S converting portion 153, the composite 10-bit word sequence data DZY(10) which are obtained by causing the composite 8-bit word sequence data DZY(8) to be subjected to the 8B/10B conversion to have the word transmission rate of 100.2375 MBps, are subjected to P/S conversion by which parallel data are converted into serial data to produce serial data DSY based on the composite 10-bit word sequence data DZY(10) and having the bit transmission rate of 100.2375 MBps×10≈1.002 Gbps. The serial data DSY thus obtained are supplied from the 8B/10B converting and P/S converting portion 153 to a data transmitting portion 154.

The data transmitting portion 154 is operative to convert the serial data DSY to a transmittal signal SLY which is, for example, an electric signal suitable for transmission through a data transmission line made of a coaxial cable or an optical signal suitable for transmission through a data transmission line made of an optical fiber, and to transmit the transmittal signal SLY through the data transmission line so that the serial data DSY are substantially transmitted.

Further, horizontal and vertical synchronous pulse signals SH and SV relative to the PB/PR data sequence DCV, a clock pulse signal CA which has the frequency of 74.25 MHz and is in synchronism with a word clock signal of each of the PB/PR data sequence DCV and another clock pulse signal CB having the frequency 100.2375 MHz are also supplied to the composite 8-bit word sequence data producing portion 142.

In the composite 8-bit word sequence data producing portion 142, the PB/PR data sequence DCV and the horizontal synchronous pulse signal SH are guided to an 8-bit word sequence data producing portion 163, and the horizontal synchronous pulse signal SH, the vertical synchronous pulse signal SV, the clock pulse signal CA and the clock pulse signal CB are guided to a transmission rate converting and data inserting portion 164.

In the 8-bit word sequence data producing portion 163, the PB/PR data sequence DCV is converted into word sequence data, each word of which is composed of ten bits, with time reference according to the horizontal synchronous pulse signal SH to produce 8-bit word sequence data DXC(8) having the word transmission rate of 74.25 MBps×10/8=92.8125 MBps. The 8-bit word sequence data DXC(8) obtained from the 8-bit word sequence data producing portion 163 are supplied to the transmission rate converting and data inserting portion 164.

An additional word data group DWS having the word transmission rate of 100.2375 MBps is supplied from a word data supplying portion 165 to the transmission rate converting and data inserting portion 164. The additional word data group DWS is constituted with a plurality of 8-bit word data including word synchronous data allotted a predetermined specific code.

In the transmission rate converting and data inserting portion 164, the word transmission rate of the 8-bit word sequence data DXC(8) is converted, for example, from 92.8125 MBps to 100.2375 MBps and then the additional word data group DWS including the 8-bit word synchronous data from the word data supplying portion 165 is inserted into the 8-bit word sequence data DXC(8) at predetermined word intervals thereof to produce composite 8-bit word sequence data DZC(8) having the word transmission rate of 100.2375 MBps. That is, the composite 8-bit word sequence data DZC(8) are produced based on the PB/PR data sequence DCV in the transmission rate converting and data inserting portion 164.

FIG. 46 shows an embodiment of the transmission rate converting and data inserting portion 164. In the embodiment shown in FIG. 46, the 8-bit word sequence data DXC(8) obtained from the 8-bit word sequence data producing portion 163 are supplied to a switch 167. The switch 167 performs switching operations at every predetermined period, for example, every horizontal period of the 8-bit word sequence data DXC(8) in response to a control signal CSA supplied from a switching control signal generating portion 168.

The horizontal synchronous pulse signal SH, the vertical synchronous pulse signal SV and the clock pulse signal CB having the frequency of 100.2375 MHz are supplied to the switching control signal generating portion 168. In the switching control signal generating portion 168, the control signal CSA is produced in response to the horizontal and vertical synchronous pulse signals SH and SV so as to be in synchronism with the horizontal period of the 8-bit word sequence data DXC(8) and a control signal CSB is produced in response to the horizontal synchronous pulse signal SH and the clock pulse signal CB to be in synchronism with the horizontal period of the 8-bit word sequence data DXC(8) so as to be in synchronism with both of the horizontal period of the 8-bit word sequence data DXC(8) and a period corresponding to an integer times the period of the clock pulse signal CB.

Memories 169 and 170 are connected with the switch 167. The switch 167 supplies alternately the memory 169 and the memory 170 with the 8-bit word sequence data DXC(8) at every horizontal period of the 8-bit word sequence data DXC(8) with its switching operations.

A memory control signal generating portion 171 to which the clock pulse signal CA having the frequency of 74.25 MHz and the clock pulse signal CB having the frequency of 100.2375 MHz are supplied, is provided in relation to the memories 169 and 170. The memory control signal generating portion 171 is operative to produce a write control signal QW having the frequency of 74.25 MHz×5/4=92.8125 MHz based on the clock pulse signal CA and a read control signal QR having the frequency of 100.2375 MHz based on the clock pulse signal CB and to supply each of the memories 169 and 170 with the write control signal QW and the read control signal QR.

In the memory 169, the 8-bit word sequence data DXC(8) are written to be stored at the word transmission rate of 92.8125 MBps in accordance with the write control signal QW having the frequency of 92.8125 MHz when the 8-bit word sequence data DXC(8) are supplied through the switch 167 to the memory 169. Similarly, in the memory 170, the 8-bit word sequence data DXC(8) are written to be stored at the word transmission rate of 92.8125 MBps in accordance with the write control signal QW having the frequency of 92.8125 MHz when the 8-bit word sequence data DXC(8) are supplied through the switch 167 to the memory 170. Accordingly, the 8-bit word sequence data DXC(8) having the word transmission rate of 92.8125 MBps are written to be stored in the memories 169 and 170 alternately at every horizontal period of the 8-bit word sequence data DXC(8).

The 8-bit word sequence data DXC(8) stored in the memory 169 during a certain horizontal period of the 8-bit word sequence data DXC(8) are read from the memory 169 during the next horizontal period of the 8-bit word sequence data DXC(8) in accordance with the read control signal QR having the frequency of 100.2375 MHz so as to produce 8-bit word sequence data DZC′(8) having the word transmission rate of 100.2375 MBps. The 8-bit word sequence data DZC′(8) thus obtained from the memory 169 are supplied to a switch 172. The 8-bit word sequence data DXC(8) stored in the memory 170 during a certain horizontal period of the 8-bit word sequence data DXC(8) are read from the memory 170 during the next horizontal period of the 8-bit word sequence data DXC(8) in accordance with the read control signal QR having the frequency of 100.2375 MHz so as to produce 8-bit word sequence data DZC′(8) having the word transmission rate of 100.2375 MBps. The 8-bit word sequence data DZC′(8) thus obtained from the memory 170 are also supplied to the switch 172. The additional word data group DWS having the word transmission rate of 100.2375 MBps is further supplied from the word data supplying portion 165 to the switch 172.

The switch 172 is operative to extract successively the additional word data group DWS having the word transmission rate of 100.2375 MBps and supplied from the word data supplying portion 165, the 8-bit word sequence data DZC′(8) having the word transmission rate of 100.2375 MBps and read from the memory 170 and the 8-bit word sequence data DZC′(8) having the word transmission rate of 100.2375 MBps and read from the memory 169 at every predetermined period corresponding to a predetermined number of 8-bit word data, in response to the control signal CSB supplied from the switching control signal generating portion 168. As a result, the composite 8-bit word sequence data DZC(8), which are obtained by inserting the additional word data group DWS having the word transmission rate of 100.2375 MBps into the 8-bit word sequence data DZC′(8) having the word transmission rate of 100.2375 MBps at predetermined word intervals are derived from the switch 172.

The additional word data group DWS supplied from the word data supplying portion 165 is constituted with a plurality of 8-bit word data including 8-bit word synchronous data DEK8 allotted the predetermined specific code and optional 8-bit ancillary word data DEX8. An example of the additional word data group DWS is constituted with 220 word data (220 Bytes) with beginning and end portions in each of which four 8-bit word data including 8-bit word synchronous data DEK8 and three optional 8-bit ancillary word data DEX8 following the 8-bit word synchronous data DEK8 in series are provided.

The 8-bit word synchronous data DEK8 and the optional 8-bit word ancillary data DEX8 are the same as those included in the additional word data group DWS supplied from the word data supplying portion 145 in composite 8-bit word sequence data producing portion 141.

A portion of the composite 8-bit word sequence data DZC(8) in which the example of the additional word data group DWS mentioned above is inserted is shown in FIG. 48. In FIG. 48, DDC8 represents 8-bit word data contained in the 8-bit word sequence data DZC′(8) read from the memories 169 and 170 and an arrow t represents elapsing time.

The composite 8-bit word sequence data DZC(8) obtained in the transmission rate converting and data inserting portion 164 to have the word transmission rate of 100.2375 MBps is derived from the composite 8-bit word sequence data producing portion 142 to be supplied to an 8B/10B converting and P/S converting portion 173.

In the 8B/10B converting and P/S converting portion 173, the composite 8-bit word sequence data DZC(8) are subjected to 8B/10B conversion by which every eight bits constituting each word of the 8-bit word sequence data DZC(8) are converted into ten bits in accordance with a predetermined conversion table to produce composite 10-bit word sequence data DZC(10) having the word transmission rate of 100.2375 MBps. In such 8B/10B conversion, the 8-bit word synchronous data DEK8 are converted into 10-bit word synchronous data K 28.5, the optional 8-bit word ancillary data DEX8 are converted into 10-bit word data DXX.X, and the 8-bit word data DDC8 are converted into 10-bit word data DDC10.

Accordingly, if such an additional word data group DWS as shown in FIG. 48 is inserted into the composite 8-bit word sequence data DZC(8), a portion of the composite 10-bit word sequence data DZC(10) formed based on the additional word data group DWS are so formed as to be shown in FIG. 50 and a couple of 10-bit word synchronous data K28.5 are contained in the portion of the composite 10-bit word sequence data DZC(10) formed based on the additional word data group DWS.

In addition to the above, in the 8B/10B converting and P/S converting portion 173, the composite 10-bit word sequence data DZC(10) which are obtained by causing the composite 8-bit word sequence data DZC(8) to be subjected to the 8B/10B conversion to have the word transmission rate of 100.2375 MBps, are subjected to P/S conversion by which parallel data are converted into serial data to produce serial data DSC based on the composite 10-bit word sequence data DZC(10) and having the bit transmission rate of 100.2375 MBps×10≈1.002 Gbps. The serial data DSC thus obtained are supplied from the 8B/10B converting and P/S converting portion 173 to a data transmitting portion 174.

The data transmitting portion 174 is operative to convert the serial data DSC to a transmittal signal SLC which is, for example, an electric signal suitable for transmission through a data transmission line made of a coaxial cable or an optical signal suitable for transmission through a data transmission line made of an optical fiber, and to transmit the transmittal signal SLC through the data transmission line so that the serial data DSC are substantially transmitted.

In the case where the transmittal signals SLY and SLC are optical signals, it is possible that the transmittal signals SLY and SLC are so produced as to be different in wavelength from each other and multiplexed to be transmitted through a common data transmission line made of an optical fiber. A multiplexing portion 175 shown with a dotdash line in FIG. 44 is used in such a case for multiplexing the transmittal signals SLY and SLC with each other to produce a multiplexed transmittal signal SLZ to be transmitted through the common data transmission line.

In the embodiment shown in FIG. 44, the 8B/10B converting and P/S converting portion 153 and the data transmitting portion 154 are operative to cause the composite 8-bit word sequence data DZY(8) having the word transmission rate of 100.2375 MBps to be subjected to the 8B/10B conversion to produce the composite 10-bit word sequence data DZY(10) having the word transmission rate of 100.2375 MBps, to cause the composite 10-bit word sequence data DZY(10) to be subjected to the P/S conversion to produce the serial data DSY having the bit transmission rate 1.002 Gbps and to transmit the serial data DSY. Further, the 8B/10B converting and P/S converting portion 173 and the data transmitting portion 174 are operative to cause the composite 8-bit word sequence data DZC(8) having the word transmission rate of 100.2375 MBps to be subjected to the 8B/10B conversion to produce the composite 10-bit word sequence data DZC(10) having the word transmission rate of 100.2375 MBps, to cause the composite 10-bit word sequence data DZC(10) to be subjected to the P/S conversion to produce the serial data DSC having the bit transmission rate 1.002 Gbps and to transmit the serial data DSC.

Accordingly, the 8B/10B converting and P/S converting portions 153 and 173 and the data transmitting portions 154 and 174 can be constituted, for example, by utilizing effectively integrated circuit (IC) devices which have been previously proposed to be used for digital data transmission under the Fibre Channel System or the like. Consequently, a plurality of digital information data, such as the Y data sequence DYV and the PB/PR data sequence DCV, can be transmitted in such a manner that 8-bit word sequence data containing 8-bit word synchronous data are formed based on the digital information data to be transmitted and then subjected to 8B/10B conversion to produce 10-bit word sequence data containing 10-bit word synchronous data and the 10-bit word sequence data thus produced are further converted into serial data to be transmitted.

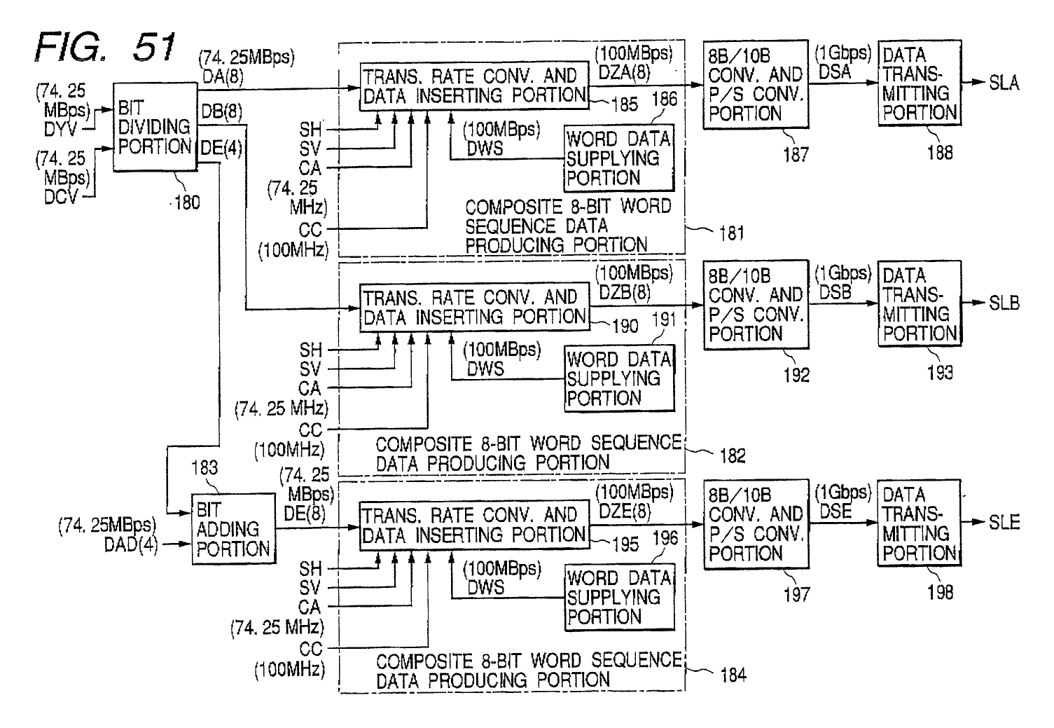

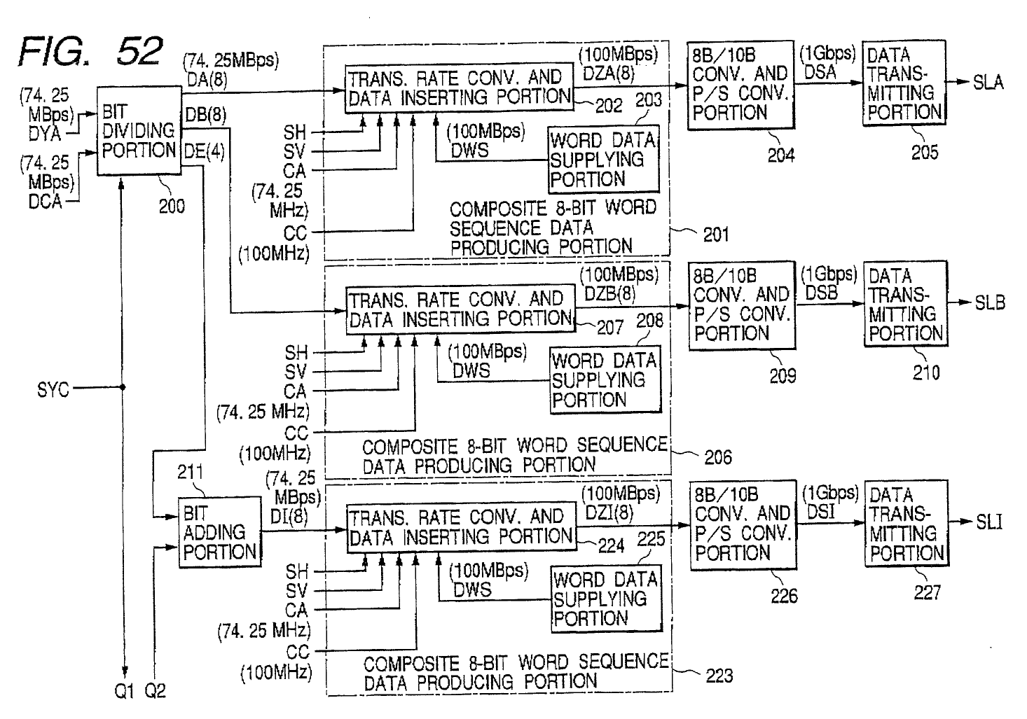

FIG. 51 shows an eighth embodiment of apparatus for transmitting digital data according to the present invention, in which an eighth embodiment of method of transmitting digital data according to the present invention is carried out.

Referring to FIG. 51, a Y data sequence DYV, such as the Y data sequence shown in FIG. 4A, which represents luminance signal information data consisting partially an HD signal and a PB/PR data sequence DCV, such as the PB/PR data sequence shown in FIG. 4A, which represents chrominance signal information data consisting partially the HD signal are supplied to a bit dividing portion 180. Each of the Y data sequence DYV and the PB/PR data sequence DCV is constituted with 10-bit word sequence data having the word transmission rate of, for example, 74.25 MBps.

In the bit dividing portion 180, each pair of one of 10-bit word data constituting the Y data sequence DYV and one of 10-bit word data constituting the PB/PR data sequence DCV corresponding to each other are successively subjected to bit-dividing to be divided into a group of eight bits, another group of eight bits and a group of four bits, so that 8-bit word sequence data DA(8), 8-bit word sequence data DB(8) and 4-bit word sequence data DE(4) are produced. Each of the 8-bit word sequence data DA(8), the 8-bit word sequence data DB(8) and the 4-bit word sequence data DE(4) has the word transmission rate of 74.25 MBps.

The 8-bit word sequence data DA(8), the 8-bit word sequence data DB(8) and the 4-bit word sequence data DE(4) obtained from the bit dividing portion 180 are supplied to a composite 8-bit word sequence data producing portion 181, a composite 8-bit word sequence data producing portion 182 and a bit adding portion 183, respectively. 4-bit word sequence additional data DAD(4) having the word transmission rate of 74.25 MBps are also supplied to the bit adding portion 183.

In the bit adding portion 183, the 4-bit word sequence additional data DAD(4) are added to the 4-bit word sequence data DE(4) from the bit dividing portion 180 to produce 8-bit word sequence data DE(8) having the word transmission rate of 74.25 MBps. The 8-bit word sequence data DE(8) thus obtained are supplied from the bit adding portion 183 to a composite 8-bit word sequence data producing portion 184.

Horizontal and vertical synchronous pulse signals SH and SV relative to both of the Y data sequence DYV and the PB/PR data sequence DCV, a clock pulse signal CA which has the frequency of 74.25 MHz and is in synchronism with a word clock signal of each of the Y data sequence DYV and the PB/PR data sequence DCV, and another clock pulse signal CC having the frequency 100 MHz are also supplied to the composite 8-bit word sequence data producing portion 181 to which the 8-bit word sequence data DA(8) are supplied.

In the composite 8-bit word sequence data producing portion 181, the 8-bit word sequence data DA(8), the horizontal synchronous pulse signal SH, the vertical synchronous pulse signal SV, the clock pulse signal CA and the clock pulse signal CC are guided to a transmission rate converting and data inserting portion 185. An additional word data group DWS having the word transmission rate of 100 MBps is further supplied from a word data supplying portion 186 to the transmission rate converting and data inserting portion 185. The additional word data group DWS is constituted with a plurality of 8-bit word data including 8-bit word synchronous data allotted a predetermined specific code.

In the transmission rate converting and data inserting portion 185, the word transmission rate of the 8-bit word sequence data DA(8) is converted from 74.25 MBps to 100 MBps and then the additional word data group DWS including the 8-bit word synchronous data from the word data supplying portion 186 is inserted into the 8-bit word sequence data DA(8) at predetermined word intervals thereof to produce composite 8-bit word sequence data DZA(8) having the word transmission rate of 100 MBps. That is, the composite 8-bit word sequence data DZA(8) are produced based on the 8-bit word sequence data DA(8) in the transmission rate converting and data inserting portion 185.

An example of the transmission rate converting and data inserting portion 185 is constituted in the same manner as the example of the transmission rate converting and data inserting portion 144 shown in FIG. 45. To such an example of the transmission rate converting and data inserting portion 185, the 8-bit word sequence data DA(8) are supplied in place of the 8-bit word sequence data DXY(8) in the example of the transmission rate converting and data inserting portion 144 and the clock pulse signal CC is supplied in place of the clock pulse signal CB in the example of the transmission rate converting and data inserting portion 144.

The additional word data group DWS supplied from the word data supplying portion 186 is constituted with a plurality of 8-bit word data including 8-bit word synchronous data DEK8 allotted the predetermined specific code and optional 8-bit word ancillary data DEX8 in the same manner as the additional word data group DWS shown in FIG. 47.

The composite 8-bit word sequence data DZA(8) obtained in the transmission rate converting and data inserting portion 185 to have the word transmission rate of 100 MBps is derived from the composite 8-bit word sequence data producing portion 181 to be supplied to an 8B/10B converting and P/S converting portion 187.

In the 8B/10B converting and P/S converting portion 187, the composite 8-bit word sequence data DZA(8) are subjected to 8B/10B conversion by which every eight bits constituting each word of the composite 8-bit word sequence data DZA(8) are converted into ten bits in accordance with a predetermined conversion table to produce composite 10-bit word sequence data DZA(10) having the word transmission rate of 100 MBps. In such 8B/10B conversion, the 8-bit word synchronous data DEK8 are converted into 10-bit word synchronous data K 28.5 and the optional 8-bit word ancillary data DEX8 are converted into 10-bit word data DXX.X.

Accordingly, if such an additional word data group DWS as shown in FIG. 47 is inserted into the composite 8-bit word sequence data DZA(8), a couple of 10-bit word synchronous data K28.5 are contained in the portion of the composite 10-bit word sequence data DZA(10) formed based on the additional word data group DWS.

In addition to the above, in the 8B/10B converting and P/S converting portion 187, the composite 10-bit word sequence data DZA(10) which are obtained by causing the composite 8-bit word sequence data DZA(8) to be subjected to the 8B/10B conversion to have the word transmission rate of 100 MBps, are subjected to P/S conversion by which parallel data are converted into serial data to produce serial data DSA based on the composite 10-bit word sequence data DZA(10) and having the bit transmission rate of 100 MBps×10=1 Gbps. The serial data DSA thus obtained are supplied from the 8B/10B converting and P/S converting portion 187 to a data transmitting portion 188.

The data transmitting portion 188 is operative to convert the serial data DSA to a transmittal signal SLA which is, for example, an electric signal suitable for transmission through a data transmission line made of a coaxial cable or an optical signal suitable for transmission through a data transmission line made of an optical fiber, and to transmit the transmittal signal SLA through the data transmission line so that the serial data DSA are substantially transmitted.

The horizontal and vertical synchronous pulse signals SH and SV relative to both of the Y data sequence DYV and the PB/PR sequence DCV, the clock pulse signal CA having the frequency of 74.25 MHz and the clock pulse signal CC having the frequency 100 MHz are also supplied to the composite 8-bit word sequence data producing portion 182 to which the 8-bit word sequence data DB(8) are supplied.

In the composite 8-bit word sequence data producing portion 182, the 8-bit word sequence data DB(8), the horizontal synchronous pulse signal SH, the vertical synchronous pulse signal SV, the clock pulse signal CA and the clock pulse signal CC are guided to a transmission rate converting and data inserting portion 190. An additional word data group DWS having the word transmission rate of 100 MBps is further supplied from a word data supplying portion 191 to the transmission rate converting and data inserting portion 190. The additional word data group DWS is constituted with a plurality of 8-bit word data including 8-bit word synchronous data allotted a predetermined specific code.

In the transmission rate converting and data inserting portion 190, the word transmission rate of the 8-bit word sequence data DB(8) is converted from 74.25 MBps to 100 MBps and then the additional word data group DWS including the 8-bit word synchronous data from the word data supplying portion 191 is inserted into the 8-bit word sequence data DB(8) at predetermined word intervals thereof to produce composite 8-bit word sequence data DZB(8) having the word transmission rate of 100 MBps. That is, the composite 8-bit word sequence data DZB(8) are produced based on the 8-bit word sequence data DB(8) in the transmission rate converting and data inserting portion 190.

An example of the transmission rate converting and data inserting portion 190 is also constituted in the same manner as the example of the transmission rate converting and data inserting portion 144 shown in FIG. 45. To such an example of the transmission rate converting and data inserting portion 190, the 8-bit word sequence data DB(8) are supplied in place of the 8-bit word sequence data DXY(8) in the example of the transmission rate converting and data inserting portion 144 and the clock pulse signal CC is supplied in place of the clock pulse signal CB in the example of the transmission rate converting and data inserting portion 144.

The additional word data group DWS supplied from the word data supplying portion 191 is constituted with a plurality of 8-bit word data including 8-bit word synchronous data DEK8 allotted the predetermined specific code and optional 8-bit word ancillary data DEX8 in the same manner as the additional word data group DWS shown in FIG. 47.

The composite 8-bit word sequence data DZB(8) obtained in the transmission rate converting and data inserting portion 190 to have the word transmission rate of 100 MBps is derived from the composite 8-bit word sequence data producing portion 182 to be supplied to an 8B/10B converting and P/S converting portion 192.

In the 8B/10B converting and P/S converting portion 192, the composite 8-bit word sequence data DZB(8) are subjected to 8B/10B conversion by which every eight bits constituting each word of the composite 8-bit word sequence data DZB(8) are converted into ten bits in accordance with a predetermined conversion table to produce composite 10-bit word sequence data DZB(10) having the word transmission rate of 100 MBps. In such 8B/10B conversion, the 8-bit word synchronous data DEK8 are converted into 10-bit word synchronous data K 28.5 and the optional 8-bit word ancillary data DEX8 are converted into 10-bit word data DXX.X.

Accordingly, if such an additional word data group DWS as shown in FIG. 47 is inserted into the composite 8-bit word sequence data DZB(8), a couple of 10-bit word synchronous data K28.5 are contained in the portion of the composite 10-bit word sequence data DZB(10) formed based on the additional word data group DWS.

In addition to the above, in the 8B/10B converting and P/S converting portion 192, the composite 10-bit word sequence data DZB(10) which are obtained by causing the composite 8-bit word sequence data DZB(8) to be subjected to the 8B/10B conversion to have the word transmission rate of 100 MBps, are subjected to P/S conversion by which parallel data are converted into serial data to produce serial data DSB based on the composite 10-bit word sequence data DZB(10) and having the bit transmission rate of 100 MBps×10=1 Gbps. The serial data DSB thus obtained are supplied from the 8B/10B converting and P/S converting portion 192 to a data transmitting portion 193.

The data transmitting portion 193 is operative to convert the serial data DSB to a transmittal signal SLB which is, for example, an electric signal suitable for transmission through a data transmission line made of a coaxial cable or an optical signal suitable for transmission through a data transmission line made of an optical fiber, and to transmit the transmittal signal SLB through the data transmission line so that the serial data DSB are substantially transmitted.

The horizontal and vertical synchronous pulse signals SH and SV relative to both of the Y data sequence DYV and the PB/PR sequence DCV, the clock pulse signal CA having the frequency of 74.25 MHz and the clock pulse signal CC having the frequency 100 MHz are further supplied to the composite 8-bit word sequence data producing portion 184 to which the 8-bit word sequence data DE(8) are supplied.

In the composite 8-bit word sequence data producing portion 184, the 8-bit word sequence data DB(8), the horizontal synchronous pulse signal SH, the vertical synchronous pulse signal SV, the clock pulse signal CA and the clock pulse signal CC are guided to a transmission rate converting and data inserting portion 195. An additional word data group DWS having the word transmission rate of 100 MBps is further supplied from a word data supplying portion 196 to the transmission rate converting and data inserting portion 195. The additional word data group DWS is constituted with a plurality of 8-bit word data including 8-bit word synchronous data allotted a predetermined specific code.

In the transmission rate converting and data inserting portion 195, the word transmission rate of the 8-bit word sequence data DE(8) is converted from 74.25 MBps to 100 MBps and then the additional word data group DWS including the 8-bit word synchronous data from the word data supplying portion 196 is inserted into the 8-bit word sequence data DE(8) at predetermined word intervals thereof to produce composite 8-bit word sequence data DZE(8) having the word transmission rate of 100 MBps. That is, the composite 8-bit word sequence data DZE(8) are produced based on the 8-bit word sequence data DE(8) in the transmission rate converting and data inserting portion 195.

An example of the transmission rate converting and data inserting portion 195 is also constituted in the same manner as the example of the transmission rate converting and data inserting portion 144 shown in FIG. 45. To such an example of the transmission rate converting and data inserting portion 195, the 8-bit word sequence data DE(8) are supplied in place of the 8-bit word sequence data DXY(8) in the example of the transmission rate converting and data inserting portion 144 and the clock pulse signal CC is supplied in place of the clock pulse signal CB in the example of the transmission rate converting and data inserting portion 144.

The additional word data group DWS supplied from the word data supplying portion 196 is constituted with a plurality of 8-bit word data including 8-bit word synchronous data DEK8 allotted the predetermined specific code and optional 8-bit word ancillary data DEX8 in the same manner as the additional word data group DWS shown in FIG. 47.

The composite 8-bit word sequence data DZE(8) obtained in the transmission rate converting and data inserting portion 195 to have the word transmission rate of 100 MBps is derived from the composite 8-bit word sequence data producing portion 184 to be supplied to an 8B/10B converting and P/S converting portion 197.

In the 8B/10B converting and P/S converting portion 197, the composite 8-bit word sequence data DZE(8) are subjected to 8B/10B conversion by which every eight bits constituting each word of the composite 8-bit word sequence data DZE(8) are converted into ten bits in accordance with a predetermined conversion table to produce composite 10-bit word sequence data DZE(10) having the word transmission rate of 100 MBps. In such 8B/10B conversion, the 8-bit word synchronous data DEK8 are c on verted into 10-bit word synchronous data K 28.5 and the optional 8-bit word ancillary data DEX8 are converted into 10-bit word da ta DXX.X.

Accordingly, if such an additional word data group DWS as shown in FIG. 47 is inserted into the composite 8-bit word sequence data DZE(8), a couple of 10-bit word synchronous data K28.5 are contained in the portion of the composite 10-bit word sequence data DZE(10) formed based on the additional word data group DWS.

In addition to the above, in the 8B/10B converting and P/S converting portion 197, the composite 10-bit word sequence data DZE(10) which are obtained by causing the composite 8-bit word sequence data DZE(8) to be subjected to the 8B/10B conversion to have the word transmission rate of 100 MBps, are subjected to P/S conversion by which parallel data are converted into serial data to produce serial data DSE based on the composite 10-bit word sequence data DZE(10) and having the bit transmission rate of 100 MBps×10=1 Gbps. The serial data DSE thus obtained are supplied from the 8B/10B converting and P/S converting portion 197 to a data transmitting portion 198.

The data transmitting portion 198 is operative to convert the serial data DSE to a transmittal signal SLE which is, for example, an electric signal suitable for transmission through a data transmission line made of a coaxial cable or an optical signal suitable for transmission through a data transmission line made of an optical fiber, and to transmit the transmittal signal SLE through the data transmission line so that the serial data DSE are substantially transmitted.

In the embodiment shown in FIG. 51, the 8B/10B converting and P/S converting portion 187 and the data transmitting portion 188 are operative to cause the composite 8-bit word sequence data DZA(8) having the word transmission rate of 100 MBps to be subjected to the 8B/10B conversion to produce the composite 10-bit word sequence data DZA(10) having the word transmission rate of 100 MBps, to cause the composite 10-bit word sequence data DZA(10) to be subjected to the P/S conversion to produce the serial data DSA having the bit transmission rate 1 Gbps and to transmit the serial data DSA. The 8B/10B converting and P/S converting portion 192 and the data transmitting portion 193 are operative to cause the composite 8-bit word sequence data DZB(8) having the word transmission rate of 100 MBps to be subjected to the 8B/10B conversion to produce the composite 10-bit word sequence data DZB(10) having the word transmission rate of 10OMBps, to cause the composite 10-bit word sequence data DZB(10) to be subjected to the P/S conversion to produce the serial data DSB having the bit transmission rate 1 Gbps and to transmit the serial data DSB. Further, the 8B/10B converting and P/S converting portion 197 and the data transmitting portion 198 are operative to cause the composite 8-bit word sequence data DZE(8) having the word transmission rate of 100 MBps to be subjected to the 8B/10B conversion to produce the composite 10-bit word sequence data DZE(10) having the word transmission rate of 100 MBps, to cause the composite 10-bit word sequence data DZE(10) to be subjected to the P/S conversion to produce the serial data DSE having the bit transmission rate 1 Gbps and to transmit the serial data DSE.

Accordingly, the 8B/10B converting and P/S converting portions 187,192 and 197 and the data transmitting portions 188, 193 and 198 can be constituted, for example, by utilizing effectively integrated circuit (IC) devices which have been previously proposed to be used for digital data transmission under the Fibre Channel System or the like. Consequently, a plurality of digital information data, such as the Y data sequence DYV and the PB/PR data sequence DCV, can be transmitted in such a manner that 8-bit word sequence data containing 8-bit word synchronous data are formed based on the digital information data to be transmitted and then subjected to 8B/10B conversion to produce 10-bit word sequence data containing 10-bit word synchronous data and the 10-bit word sequence data thus produced are further converted into serial data to be transmitted.

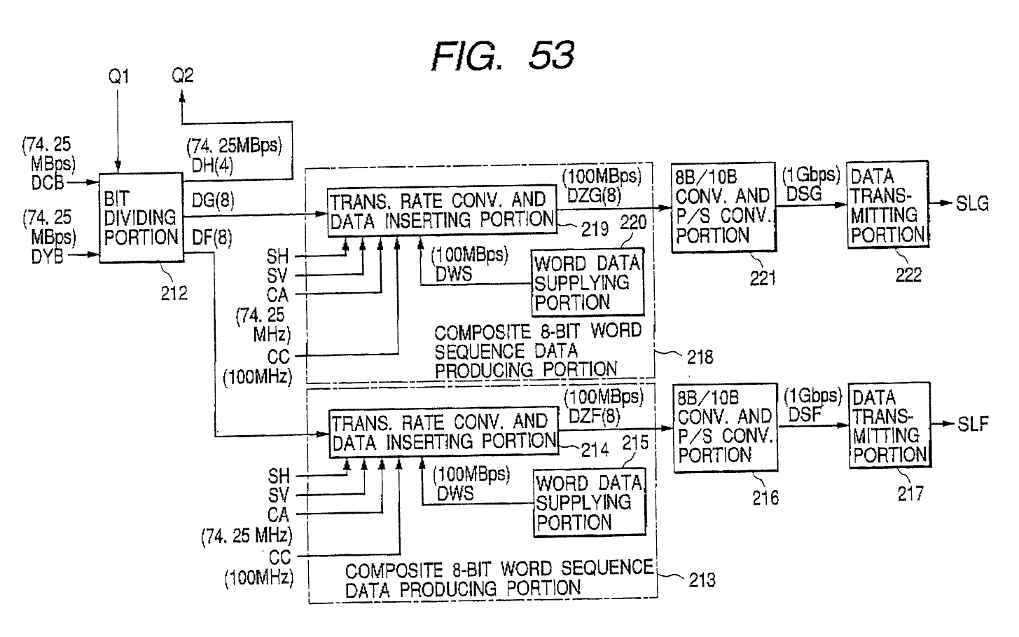

FIGS. 52 and 53 show a ninth embodiment of apparatus for transmitting digital data according to the present invention, in which a ninth embodiment of method of transmitting digital data according to the present invention is carried out.

Referring to FIGS. 52 and 53, a Y data sequence DYA, such as the Y data sequence shown in FIG. 4A, which represents luminance signal information data consisting partially a first HD signal and a PB/PR data sequence DCA, such as the PB/PR data sequence shown in FIG. 4B, which represents chrominance signal information data consisting partially the first HD signal are supplied to a bit dividing portion 200. Each of the Y data sequence DYA and the PB/PR data sequence DCA is constituted with 10-bit word sequence data having the word transmission rate of, for example, 74.25 MBps.

In the bit dividing portion 200, each pair of one of 10-bit word data constituting the Y data sequence DYA and one of 10-bit word data constituting the PB/PR sequence DCA corresponding to each other are successively subjected to bit-dividing to be divided into a group of eight bits, another group of eight bits and a group of four bits, so that 8-bit word sequence data DA(8), 8-bit word sequence data DB(8) and 4-bit word sequence data DE(4) are produced. Each of the 8-bit word sequence data DA(8), the 8-bit word sequence data DB(8) and the 4-bit word sequence data DE(4) has the word transmission rate of 74.25 MBps.

The 8-bit word sequence data DA(8) obtained from the bit dividing portion 200 are supplied to a composite 8-bit word sequence data producing portion 201. Horizontal and vertical synchronous pulse signals SH and SV relative to both of the Y data sequence DYA and the PB/PR data sequence DCA, a clock pulse signal CA which has the frequency of 74.25 MHz and is in synchronism with a word clock signal of each of the Y data sequence DYA and the PB/PR data sequence DCA, and another clock pulse signal CC having the frequency 100 MHz are also supplied to the composite 8-bit word sequence data producing portion 201.

In the composite 8-bit word sequence data producing portion 201, the 8-bit word sequence data DA(8), the horizontal synchronous pulse signal SH, the vertical synchronous pulse signal SV, the clock pulse signal CA and the clock pulse signal CC are guided to a transmission rate converting and data inserting portion 202. An additional word data group DWS having the word transmission rate of 100 MBps is further supplied from a word data supplying portion 203 to the transmission rate converting and data inserting portion 202. The additional word data group DWS is constituted with a plurality of 8-bit word data including 8-bit word synchronous data allotted a predetermined specific code.

In the transmission rate converting and data inserting portion 202, the word transmission rate of the 8-bit word sequence data DA(8) is converted from 74.25 MBps to 100 MBps and then the additional word data group DWS including the 8-bit word synchronous data from the word data supplying portion 203 is inserted into the 8-bit word sequence data DA(8) at predetermined word intervals thereof to produce composite 8-bit word sequence data DZA(8) having the word transmission rate of 100 MBps. That is, the composite 8-bit word sequence data DZA(8) are produced based on the 8-bit word sequence data DA(8) in the transmission rate converting and data inserting portion 202.

An example of the transmission rate converting and data inserting portion 202 is constituted in the same manner as the example of the transmission rate converting and data inserting portion 144 shown in FIG. 45. To such an example of the transmission rate converting and data inserting portion 202, the 8-bit word sequence data DA(8) are supplied in place of the 8-bit word sequence data DXY(8) in the example of the transmission rate converting and data inserting portion 144 and the clock pulse signal CC is supplied in place of the clock pulse signal CB in the example of the transmission rate converting and data inserting portion 144.

The additional word data group DWS supplied from the word data supplying portion 203 is constituted with a plurality of 8-bit word data including 8-bit word synchronous data DEK8 allotted the predetermined specific code and optional 8-bit word ancillary data DEX8 in the same manner as the additional word data group DWS shown in FIG. 47.

The composite 8-bit word sequence data DZA(8) obtained in the transmission rate converting and data inserting portion 202 to have the word transmission rate of 100 MBps is derived from the composite 8-bit word sequence data producing portion 201 to be supplied to an 8B/10B converting and P/S converting portion 204.

In the 8B/10B converting and P/S converting portion 204, the composite 8-bit word sequence data DZA(8) are subjected to 8B/10B conversion by which every eight bits constituting each word of the composite 8-bit word sequence data DZA(8) are converted into ten bits in accordance with a predetermined conversion table to produce composite 10-bit word sequence data DZA(10) having the word transmission rate of 100 MBps. In such 8B/10B conversion, the 8-bit word synchronous data DEK8 are converted into 10-bit word synchronous data K 28.5 and the optional 8-bit word ancillary data DEX8 are converted into 10-bit word data DXX.X.

Accordingly, if such an additional word data group DWS as shown in FIG. 47 is inserted into the composite 8-bit word sequence data DZA(8), a couple of 10-bit word synchronous data K28.5 are contained in the portion of the composite 10-bit word sequence data DZA(10) formed based on the additional word data group DWS.

In addition to the above, in the 8B/10B converting and P/S converting portion 204, the composite 10-bit word sequence data DZA(10) which are obtained by causing the composite 8-bit word sequence data DZA(8) to be subjected to the 8B/10B conversion to have the word transmission rate of 100 MBps, are subjected to P/S conversion by which parallel data are converted into serial data to produce serial data DSA based on the composite 10-bit word sequence data DZA(10) and having the bit transmission rate of 100 MBps×10=1 Gbps. The serial data DSA thus obtained are supplied from the 8B/10B converting and P/S converting portion 204 to a data transmitting portion 205.

The data transmitting portion 205 is operative to convert the serial data DSA to a transmittal signal SLA which is, for example, an electric signal suitable for transmission through a data transmission line made of a coaxial cable or an optical signal suitable for transmission through a data transmission line made of an optical fiber, and to transmit the transmittal signal SLA through the data transmission line so that the serial data DSA are substantially transmitted.

The 8-bit word sequence data DB(8) obtained from the bit dividing portion 200 are supplied to a composite 8-bit word sequence data producing portion 206. The horizontal and vertical synchronous pulse signals SH and SV relative to both of the Y data sequence DYA and the PB/PR data sequence DCA, the clock pulse signal CA which has the frequency of 74.25 MHz and the clock pulse signal CC having the frequency 100 MHz are also supplied to the composite 8-bit word sequence data producing portion 206.

In the composite 8-bit word sequence data producing portion 206, the 8-bit word sequence data DB(8), the horizontal synchronous pulse signal SH, the vertical synchronous pulse signal SV, the clock pulse signal CA and the clock pulse signal CC are guided to a transmission rate converting and data inserting portion 207. An additional word data group DWS having the word transmission rate of 100 MBps is further supplied from a word data supplying portion 208 to the transmission rate converting and data inserting portion 207. The additional word data group DWS is constituted with a plurality of 8-bit word data including 8-bit word synchronous data allotted a predetermined specific code.

In the transmission rate converting and data inserting portion 207, the word transmission rate of the 8-bit word sequence data DB(8) is converted from 74.25 MBps to 100 MBps and then the additional word data group DWS including the 8-bit word synchronous data from the word data supplying portion 208 is inserted into the 8-bit word sequence data DB(8) at predetermined word intervals thereof to produce composite 8-bit word sequence data DZB(8) having the word transmission rate of 100 MBps. That is, the composite 8-bit word sequence data DZB(8) are produced based on the 8-bit word sequence data DB(8) in the transmission rate converting and data inserting portion 207.

An example of the transmission rate converting and data inserting portion 207 is constituted in the same manner as the example of the transmission rate converting and data inserting portion 144 shown in FIG. 45. To such an example of the transmission rate converting and data inserting portion 207, the 8-bit word sequence data DB(8) are supplied in place of the 8-bit word sequence data DXY(8) in the example of the transmission rate converting and data inserting portion 144 and the clock pulse signal CC is supplied in place of the clock pulse signal CB in the example of the transmission rate converting and data inserting portion 144.

The additional word data group DWS supplied from the word data supplying portion 208 is constituted with a plurality of 8-bit word data including 8-bit word synchronous data DEK8 allotted the predetermined specific code and optional 8-bit word ancillary data DEX8 in the same manner as the additional word data group DWS shown in FIG. 47.

The composite 8-bit word sequence data DZB(8) obtained in the transmission rate converting and data inserting portion 207 to have the word transmission rate of 100 MBps is derived from the composite 8-bit word sequence data producing portion 206 to be supplied to an 8B/10B converting and P/S converting portion 209.

In the 8B/10B converting and P/S converting portion 209, the composite 8-bit word sequence data DZB(8) are subjected to 8B/10B conversion by which every eight bits constituting each word of the composite 8-bit word sequence data DZB(8) are converted into ten bits in accordance with a predetermined conversion table to produce composite 10-bit word sequence data DZB(10) having the word transmission rate of 10OMBps. In such 8B/10B conversion, the 8-bit word synchronous data DEK8 are converted into 10-bit word synchronous data K 28.5 and the optional 8-bit word ancillary data DEX8 are converted into 10-bit word data DXX.X.

Accordingly, if such an additional word data group DWS as shown in FIG. 47 is inserted into the composite 8-bit word sequence data DZB(8), a couple of 10-bit word synchronous data K28.5 are contained in the portion of the composite 10-bit word sequence data DZB(10) formed based on the additional word data group DWS.

In addition to the above, in the 8B/10B converting and P/S converting portion 209, the composite 10-bit word sequence data DZB(10) which are obtained by causing the composite 8-bit word sequence data DZB(8) to be subjected to the 8B/10B conversion to have the word transmission rate of 100 MBps, are subjected to P/S conversion by which parallel data are converted into serial data to produce serial data DSB based on the composite 10-bit word sequence data DZB(10) and having the bit transmission rate of 100 MBps×10=1 Gbps. The serial data DSB thus obtained are supplied from the 8B/10B converting and P/S converting portion 209 to a data transmitting portion 210.

The data transmitting portion 210 is operative to convert the serial data DSB to a transmittal signal SLB which is, for example, an electric signal suitable for transmission through a data transmission line made of a coaxial cable or an optical signal suitable for transmission through a data transmission line made of an optical fiber, and to transmit the transmittal signal SLB through the data transmission line so that the serial data DSB are substantially transmitted.

The 4-bit word sequence data DE(4) obtained from the bit dividing portion 200 are supplied to a bit adding portion 211.

Further, a Y data sequence DYB, such as the Y data sequence shown in FIG. 4A, which represents luminance signal information data consisting partially a second HD signal and a PB/PR data sequence DCB, such as the PB/PR data sequence shown in FIG. 4B, which represents chrominance signal information data consisting partially the second HD signal are supplied to a bit dividing portion 212. Each of the Y data sequence DYB and the PB/PR data sequence DCB is constituted with 10-bit word sequence data having the word transmission rate of, for example, 74.25 MBps. A synchronous signal SYC common to the bit dividing portions 200 and 212 is supplied to both of the bit dividing portions 200 and 212 and therefore the bit dividing portions 200 and 212 are in synchronism with each other.

In the bit dividing portion 212, each pair of one of 10-bit word data constituting the Y data sequence DYB and one of 10-bit word data constituting the PB/PR data sequence DCB corresponding to each other are successively subjected to bit-dividing to be divided into a group of eight bits, another group of eight bits and a group of four bits, so that 8-bit word sequence data DF(8), 8-bit word sequence data DG(8) and 4-bit word sequence data DH(4) are produced. Each of the 8-bit word sequence data DF(8), the 8-bit word sequence data DG(8) and the 4-bit word sequence data DH(4) has the word transmission rate of 74.25 MBps.

The 8-bit word sequence data DF(8) obtained from the bit dividing portion 212 are supplied to a composite 8-bit word sequence data producing portion 213. Horizontal and vertical synchronous pulse signals SH and SV relative to both of the Y data sequence DYB and the P B/PR data sequence DCB, a clock pulse signal CA which has the frequency of 74.25 MHz and is in synchronism with a word clock signal of each of the Y data sequence DYB and the PB/PR data sequence DCB, and another clock pulse signal CC having the frequency 100 MHz are also supplied to the composite 8-bit word sequence data producing portion 213.

In the composite 8-bit word sequence data producing portion 213, the 8-bit word sequence data DF(8), the horizontal synchronous pulse signal SH, the vertical synchronous pulse signal SV, the clock pulse signal CA and the clock pulse signal CC are guided to a transmission rate converting and data inserting portion 214. An additional word data group DWS having the word transmission rate of 100 MBps is further supplied from a word data supplying portion 215 to the transmission rate converting and data inserting portion 214. The additional word data group DWS is constituted with a plurality of 8-bit word data including 8-bit word synchronous data allotted a predetermined specific code.

In the transmission rate converting and data inserting portion 214, the word transmission rate of the 8-bit word sequence data DF(8) is converted from 74.25 MBps to 100 MBps and then the additional word data group DWS including the 8-bit word synchronous data from the word data supplying portion 215 is inserted into the 8-bit word sequence data DF(8) at predetermined word intervals thereof to produce composite 8-bit word sequence data DZF(8) having the word transmission rate of 100 MBps. That is, the composite 8-bit word sequence data DZF(8) are produced based on the 8-bit word sequence data DF(8) in the transmission rate converting and data inserting portion 214.

An example of the transmission rate converting and data inserting portion 214 is constituted in the same manner as the example of the transmission rate converting and data inserting portion 144 shown in FIG. 45. To such an example of the transmission rate converting and data inserting portion 214, the 8-bit word sequence data DF(8) are supplied in place of the 8-bit word sequence data DXY(8) in the example of the transmission rate converting and data inserting portion 144 and the clock pulse signal CC is supplied in place of the clock pulse signal CB in the example of the transmission rate converting and data inserting portion 144.

The additional word data group DWS supplied from the word data supplying portion 215 is constituted with a plurality of 8-bit word data including 8-bit word synchronous data DEK8 allotted the predetermined specific code and optional 8-bit word ancillary data DEX8 in the same manner as the additional word data group DWS shown in FIG. 47.

The composite 8-bit word sequence data DZF(8) obtained in the transmission rate converting and data inserting portion 214 to have the word transmission rate of 100 MBps is derived from the composite 8-bit word sequence data producing portion 213 to be supplied to an 8B/10B converting and P/S converting portion 216.

In the 8B/10B converting and P/S converting portion 216, the composite 8-bit word sequence data DZF(8) are subjected to 8B/10B conversion by which every eight bits constituting each word of the composite 8-bit word sequence data DZF(8) are converted into ten bits in accordance with a predetermined conversion table to produce composite 10-bit word sequence data DZF(10) having the word transmission rate of 100 MBps. In such 8B/10B conversion, the 8-bit word synchronous data DEK8 are converted into 10-bit word synchronous data K 28.5 and the optional 8-bit word ancillary data DEX8 are converted into 10-bit word data DXX.X.

Accordingly, if such an additional word data group DWS as shown in FIG. 47 is inserted into the composite 8-bit word sequence data DZF(8), a couple of 10-bit word synchronous data K28.5 are contained in the portion of the composite 10-bit word sequence data DZF(10) formed based on the additional word data group DWS.

In addition to the above, in the 8B/10B converting and P/S converting portion 216, the composite 10-bit word sequence data DZF(10) which are obtained by causing the composite 8-bit word sequence data DZF(8) to be subjected to the 8B/10B conversion to have the word transmission rate of 100 MBps, are subjected to P/S conversion by which parallel data are converted into serial data to produce serial data DSF based on the composite 10-bit word sequence data DZF(10) and having the bit transmission rate of 100 MBps×10=1 Gbps. The serial data DSF thus obtained are supplied from the 8B/10B converting and P/S converting portion 216 to a data transmitting portion 217.

The data transmitting portion 217 is operative to convert the serial data DSF to a transmittal signal SLF which is, for example, an electric signal suitable for transmission through a data transmission line made of a coaxial cable or an optical signal suitable for transmission through a data transmission line made of an optical fiber, and to transmit the transmittal signal SLF through the data transmission line so that the serial data DSF are substantially transmitted.

The 8-bit word sequence data DG(8) obtained from the bit dividing portion 212 are supplied to a composite 8-bit word sequence data producing portion 218. The horizontal and vertical synchronous pulse signals SH and SV relative to both of the Y data sequence DYB and the PB/PR data sequence DCB, the clock pulse signal CA which has the frequency of 74.25 MHz and the clock pulse signal CC having the frequency 100 MHz are also supplied to the composite 8-bit word sequence data producing portion 218.

In the composite 8-bit word sequence data producing portion 218, the 8-bit word sequence data DG(8), the horizontal synchronous pulse signal SH, the vertical synchronous pulse signal SV, the clock pulse signal CA and the clock pulse signal CC are guided to a transmission rate converting and data inserting portion 219. An additional word data group DWS having the word transmission rate of 100 MBps is further supplied from a word data supplying portion 220 to the transmission rate converting and data inserting portion 219. The additional word data group DWS is constituted with a plurality of 8-bit word data including 8-bit word synchronous data allotted a predetermined specific code.

In the transmission rate converting and data inserting portion 219, the word transmission rate of the 8-bit word sequence data DG(8) is converted from 74.25 MBps to 100 MBps and then the additional word data group DWS including the 8-bit word synchronous data from the word data supplying portion 220 is inserted into the 8-bit word sequence data DG(8) at predetermined word intervals thereof to produce composite 8-bit word sequence data DZG(8) having the word transmission rate of 100 MBps. That is, the composite 8-bit word sequence data DZG(8) are produced based on the 8-bit word sequence data DG(8) in the transmission rate converting and data inserting portion 219.

An example of the transmission rate converting and data inserting portion 219 is constituted in the same manner as the example of the transmission rate converting and data inserting portion 144 shown in FIG. 45. To such an example of the transmission rate converting and data inserting portion 219, the 8-bit word sequence data DG(8) are supplied in place of the 8-bit word sequence data DXY(8) in the example of the transmission rate converting and data inserting portion 144 and the clock pulse signal CC is supplied in place of the clock pulse signal CB in the example of the transmission rate converting and data inserting portion 144.

The additional word data group DWS supplied from the word data supplying portion 220 is constituted with a plurality of 8-bit word data including 8-bit word synchronous data DEK8 allotted the predetermined specific code and optional 8-bit word ancillary data DEX8 in the same manner as the additional word data group DWS shown in FIG. 47.

The composite 8-bit word sequence data DZG(8) obtained in the transmission rate converting and data inserting portion 219 to have the word transmission rate of 100 MBps is derived from the composite 8-bit word sequence data producing portion 218 to be supplied to an 8B/10B converting and P/S converting portion 221.

In the 8B/10B converting and P/S converting portion 221, the composite 8-bit word sequence data DZG(8) are subjected to 8B/10B conversion by which every eight bits constituting each word of the composite 8-bit word sequence data DZG(8) are converted into ten bits in accordance with a predetermined conversion table to produce composite 10-bit word sequence data DZG(10) having the word transmission rate of 100 MBps. In such 8B/10B conversion, the 8-bit word synchronous data DEK8 are converted into 10-bit word synchronous data K 28.5 and the optional 8-bit word ancillary data DEX8 are converted into 10-bit word data DXX.X.

Accordingly, if such an additional word data group DWS as shown in FIG. 47 is inserted into the composite 8-bit word sequence data DZG(8), a couple of 10-bit word synchronous data K28.5 are contained in the portion of the composite 10-bit word sequence data DZG(10) formed based on the additional word data group DWS.

In addition to the above, in the 8B/10B converting and P/S converting portion 221, the composite 10-bit word sequence data DZG(10) which are obtained by causing the composite 8-bit word sequence data DZG(8) to be subjected to the 8B/10B conversion to have the word transmission rate of 100 MBps, are subjected to P/S conversion by which parallel data are converted into serial data to produce serial data DSG based on the composite 10-bit word sequence data DZG(10) and having the bit transmission rate of 100 MBps×10=1 Gbps. The serial data DSG thus obtained are supplied from the 8B/10B converting and P/S converting portion 221 to a data transmitting portion 222.

The data transmitting portion 222 is operative to convert the serial data DSG to a transmittal signal SLG which is, for example, an electric signal suitable for transmission through a data transmission line made of a coaxial cable or an optical signal suitable for transmission through a data transmission line made of an optical fiber, and to transmit the transmittal signal SLG through the data transmission line so that the serial data DSG are substantially transmitted.

The 4-bit word sequence data DH(4) obtained from the bit dividing portion 212 are supplied to the bit adding portion 211.

In the bit adding portion 211, the 4-bit word sequence data DH(4) from the bit dividing portion 212 are added to the 4-bit word sequence data DE(4) from the bit dividing portion 200 to produce 8-bit word sequence data DI(8) having the word transmission rate of 74.25 MBps. The 8-bit word sequence data DI(8) thus obtained are supplied from the bit adding portion 211 to a composite 8-bit word sequence data producing portion 223. The horizontal and vertical synchronous pulse signals SH and SV relative to both of the Y data sequence DYA and the PB/PR data sequence DCA or both of the Y data sequence DYB and the PB/PR data sequence DCB , the clock pulse signal CA which has the frequency of 74.25 MHz and the clock pulse signal CC having the frequency 100 MHz are also supplied to the composite 8-bit word sequence data producing portion 223.

In the composite 8-bit word sequence data producing portion 223, the 8-bit word sequence data DI(8), the horizontal synchronous pulse signal SH, the vertical synchronous pulse signal SV, the clock pulse signal CA and the clock pulse signal CC are guided to a transmission rate converting and data inserting portion 224. An additional word data group DWS having the word transmission rate of 100 MBps is further supplied from a word data supplying portion 225 to the transmission rate converting and data inserting portion 224. The additional word data group DWS is constituted with a plurality of 8-bit word data including 8-bit word synchronous data allotted a predetermined specific code.

In the transmission rate converting and data inserting portion 224, the word transmission rate of the 8-bit word sequence data DI(8) is converted from 74.25 MBps to 100 MBps and then the additional word data group DWS including the 8-bit word synchronous data from the word data supplying portion 225 is inserted into the 8-bit word sequence data DI(8) at predetermined word intervals thereof to produce composite 8-bit word sequence data DZI(8) having the word transmission rate of 100 MBps. That is, the composite 8-bit word sequence data DZI(8) are produced based on the 8-bit word sequence data DI(8) in the transmission rate converting and data inserting portion 224.

An example of the transmission rate converting and data inserting portion 224 is constituted in the same manner as the example of the transmission rate converting and data inserting portion 144 shown in FIG. 45. To such an example of the transmission rate converting and data inserting portion 224, the 8-bit word sequence data DI(8) are supplied in place of the 8-bit word sequence data DXY(8) in the example of the transmission rate converting and data inserting portion 144 and the clock pulse signal CC is supplied in place of the clock pulse signal CB in the example of the transmission rate converting and data inserting portion 144.

The additional word data group DWS supplied from the word data supplying portion 225 is constituted with a plurality of 8-bit word data including 8-bit word synchronous data DEK8 allotted the predetermined specific code and optional 8-bit word ancillary data DEX8 in the same manner as the additional word data group DWS shown in FIG. 47.

The composite 8-bit word sequence data DZI(8) obtained in the transmission rate converting and data inserting portion 224 to have the word transmission rate of 100 MBps is derived from the composite 8-bit word sequence data producing portion 223 to be supplied to an 8B/10B converting and P/S converting portion 226.

In the 8B/10B converting and P/S converting portion 226, the composite 8-bit word sequence data DZI(8) are subjected to 8B/10B conversion by which every eight bits constituting each word of the composite 8-bit word sequence data DZI(8) are converted into ten bits in accordance with a predetermined conversion table to produce composite 10-bit word sequence data DZI(10) having the word transmission rate of 100 MBps. In such 8B/10B conversion, the 8-bit word synchronous data DEK8 are converted into 10-bit word synchronous data K 28.5 and the optional 8-bit word ancillary data DEX8 are converted into 10-bit word data DXX.X.

Accordingly, if such an additional word data group DWS as shown in FIG. 47 is inserted into the composite 8-bit word sequence data DZI(8), a couple of 10-bit word synchronous data K28.5 are contained in the portion of the composite 10-bit word sequence data DZI(10) formed based on the additional word data group DWS.

In addition to the above, in the 8B/10B converting and P/S converting portion 226, the composite 10-bit word sequence data DZI(10) which are obtained by causing the composite 8-bit word sequence data DZI(8) to be subjected to the 8B/10B conversion to have the word transmission rate of 100 MBps, are subjected to P/S conversion by which parallel data are converted into serial data to produce serial data DSI based on the composite 10-bit word sequence data DZI(10) and having the bit transmission rate of 100 MBps×10=1 Gbps. The serial data DSI thus obtained are supplied from the 8B/10B converting and P/S converting portion 226 to a data transmitting portion 227.

The data transmitting portion 227 is operative to convert the serial data DSI to a transmittal signal SLI which is, for example, an electric signal suitable for transmission through a data transmission line made of a coaxial cable or an optical signal suitable for transmission through a data transmission line made of an optical fiber, and to transmit the transmittal signal SLI through the data transmission line so that the serial data DSI are substantially transmitted.

In the embodiment shown in FIGS. 52 and 53, the 8B/10B converting and P/S converting portion 204 and the data transmitting portion 205 are operative to cause the composite 8-bit word sequence data DZA(8) having the word transmission rate of 100 MBps to be subjected to the 8B/10B conversion to produce the composite 10-bit word sequence data DZA(10) having the word transmission rate of 100 MBps, to cause the composite 10-bit word sequence data DZA(10) to be subjected to the P/S conversion to produce the serial data DSA having the bit transmission rate 1 Gbps and to transmit the serial data DSA. The 8B/10B converting and P/S converting portion 209 and the data transmitting portion 210 are operative to cause the composite 8-bit word sequence data DZB(8) having the word transmission rate of 100 MBps to be subjected to the 8B/10B conversion to produce the composite 10-bit word sequence data DZB(10) having the word transmission rate of 100 MBps, to cause the composite 10-bit word sequence data DZB(10) to be subjected to the P/S conversion to produce the serial data DSB having the bit transmission rate 1 Gbps and to transmit the serial data DSB. The 8B/10B converting and P/S converting portion 216 and the data transmitting portion 217 are operative to cause the composite 8-bit word sequence data DZF(8) having the word transmission rate of 100 MBps to be subjected to the 8B/10B conversion to produce the composite 10-bit word sequence data DZF(10) having the word transmission rate of 100 MBps, to cause the composite 10-bit word sequence data DZF(10) to be subjected to the P/S conversion to produce the serial data DSF having the bit transmission rate 1 Gbps and to transmit the serial data DSF. The 8B/10B converting and P/S converting portion 221 and the data transmitting portion 222 are operative to cause the composite 8-bit word sequence data DZG(8) having the word transmission rate of 100 MBps to be subjected to the 8B/10B conversion to produce the composite 10-bit word sequence data DZG(10) having the word transmission rate of 100 MBps, to cause the composite 10-bit word sequence data DZG(10) to be subjected to the P/S conversion to produce the serial data DSG having the bit transmission rate 1 Gbps and to transmit the serial data DSG. Further, the 8B/10B converting and P/S converting portion 226 and the data transmitting portion 227 are operative to cause the composite 8-bit word sequence data DZI(8) having the word transmission rate of 100 MBps to be subjected to the 8B/10B conversion to produce the composite 10-bit word sequence data DZI(10) having the word transmission rate of 100 MBps, to cause the composite 10-bit word sequence data DZI(10) to be subjected to the P/S conversion to produce the serial data DSI having the bit transmission rate 1 Gbps and to transmit the serial data DSI.

Accordingly, the 8B/10B converting and P/S converting portions 204, 209, 216, 221 and 226 and the data transmitting portions 205, 210, 217, 222 and 227 can be constituted, for example, by utilizing effectively integrated circuit (IC) devices which have been previously proposed to be used for digital data transmission under the Fibre Channel System or the like. Consequently, a plurality of digital information data, such as the Y data sequence DYA and the PB/PR data sequence DCA representing the first HD signal and the Y data sequence DYB and the PB/PR data sequence DCB representing the second HD signal, can be transmitted in such a manner that 8-bit word sequence data containing 8-bit word synchronous data are formed based on the digital information data to be transmitted and then subjected to 8B/10B conversion to produce 10-bit word sequence data containing 10-bit word synchronous data and the 10-bit word sequence data thus produced are further converted into serial data to be transmitted.

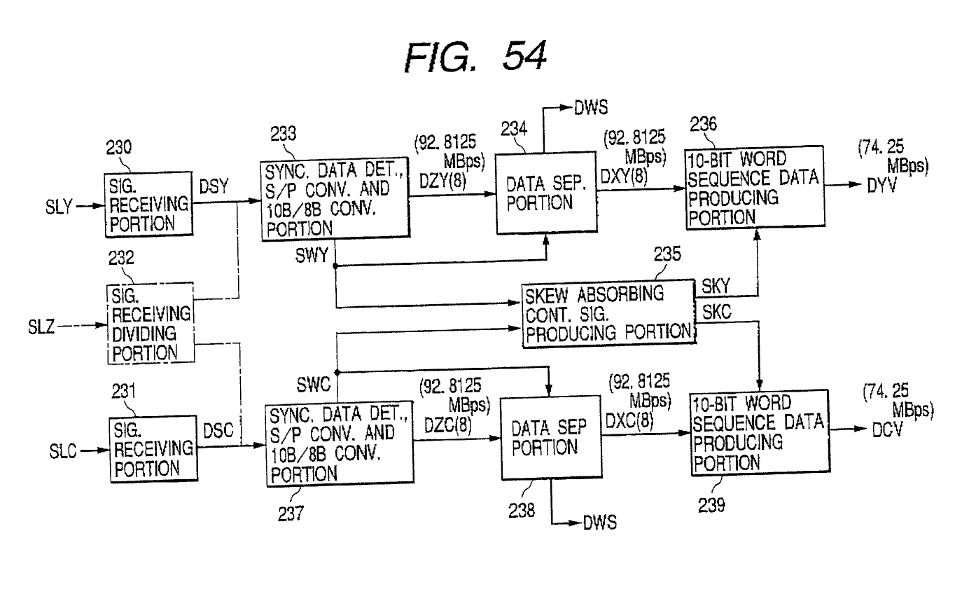

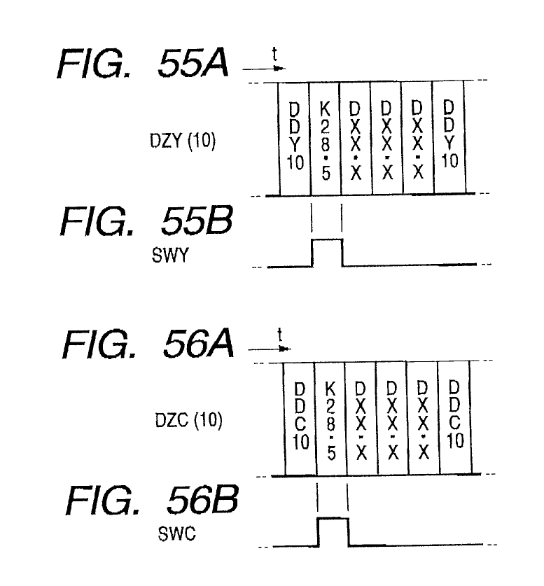

FIG. 54 shows an embodiment of data receiving apparatus for receiving transmittal signals SLY and SLC transmitted from the data transmitting portions 128 and 135 (or a multiplexed transmittal signal SLZ transmitted from the multiplexing portions 137) of the apparatus shown in FIG. 35.

Referring to FIG. 54, signal receiving portions 230 and 231 are provided for receiving the transmittal signal SLY and SLC, each of which is, for example, an electric signal suitable for transmission through a data transmission line made of a coaxial cable or an optical signal suitable for transmission through a data transmission line made of an optical fiber. In the case where the apparatus shown in FIG. 35 is provided with the multiplexing portions 137 for transmitting the multiplexed transmittal signal SLZ, a signal receiving and dividing portion 232 is provided, as shown with a dot-dash line in FIG. 54, for receiving the multiplexed transmittal signal SLZ from the multiplexing portions 137. The signal receiving and dividing portion 232 is operative to reproduce separately serial data DSY and DSC from the multiplexed transmittal signal SLZ received thereby and supply synchronous data detecting, S/P converting and 10B/8B converting portions 233 and 237 with the serial data DSY and DSC, respectively.

The signal receiving portion 230 is operative to reproduce serial data DSY based on the transmittal signal SLY received thereby and supplies the synchronous data detecting, S/P converting and 10B/8B converting portion 233 with the serial data DSY.

In the synchronous data detecting, S/P converting and 10B/8B converting portion 233, such a portion of the serial data DSY that is formed with serial data converted from 10-bit word synchronous data K28.5 is detected as synchronous data and the serial data DSY are subjected to S/P conversion under a word synchronism condition in accordance with the detected synchronous data to produce composite 10-bit word sequence data DZY(10) having the word transmission rate of, for example, 92.8125 MBps, as shown in FIG. 55A.

Then, in the synchronous data detecting, S/P converting and 10B/8B converting portion 233, the composite 10-bit word sequence data DZY(10) is subjected to 10B/8B conversion by which every ten bits of the composite 10-bit word sequence data DZY(10) are partitioned and the partitioned ten bits are converted into eight bits in accordance with a predetermined conversion table to reproduce composite 8-bit word sequence data DZY(8) having the word transmission rate of 92.8125 MBps. The composite 8-bit word sequence data DZY(8) thus obtained in the synchronous data detecting, S/P converting and 10B/8B converting portion 233 are supplied to a data separating portion 234.

Besides, in the synchronous data detecting, S/P converting and 10B/8B converting portion 233, the 10-bit word synchronous data K28.5 in an additional word data group DWS contained in the composite 10-bit word sequence data DZY(10) are detected and a K28.5 detection output signal SWY is produced to be supplied to a data separating portion 234 and a skew absorbing control signal producing portion 235. The K28.5 detection output signal SWY is obtained in response to the contents of the additional word data group DWS contained in the composite 10-bit word sequence data DZY(10), for example, as shown in FIG. 55B.

In the data separating portion 234, the additional word data group DWS is separated from the composite 8-bit word sequence data DZY(8) with use of the K28.5 detection output signal SWY from the synchronous data detecting, S/P converting and 10B/8B converting portion 233, and 8-bit word sequence data DXY(8) obtained based on the composite 8-bit word sequence data DZY(8) to have the word transmission rate of 92.8125 MBps and the additional word data group DWS are separately obtained. The 8-bit word sequence data DXY(8) thus obtained from the data separating portion 234 are supplied to a 10-bit word sequence data producing portion 236.

The signal receiving portion 231 is operative to reproduce serial data DSC based on the transmittal signal SLC received thereby and supplies the synchronous data detecting, S/P converting and 10B/8B converting portion 237 with the serial data DSC.

In the synchronous data detecting, S/P converting and 10B/8B converting portion 237, such a portion of the serial data DSC that is formed with serial data converted from 10-bit word synchronous data K28.5 is detected as synchronous data and the serial data DSC are subjected to S/P conversion under a word synchronism condition in accordance with the detected synchronous data to produce composite 10-bit word sequence data DZC(10) having the word transmission rate of, for example, 92.8125 MBps, as shown in FIG. 56A.

Then, in the synchronous data detecting, S/P converting and 10B/8B converting portion 237, the composite 10-bit word sequence data DZC(10) is subjected to 10B/8B conversion by which every ten bits of the composite 10-bit word sequence data DZC(10) are partitioned and the partitioned ten bits are converted into eight bits in accordance with a predetermined conversion table to reproduce composite 8-bit word sequence data DZC(8) having the word transmission rate of 92.8125 MBps. The composite 8-bit word sequence data DZC(8) thus obtained in the synchronous data detecting, S/P converting and 10B/8B converting portion 237 are supplied to a data separating portion 238.

Besides, in the synchronous data detecting, S/P converting and 10B/8B converting portion 237, the 10-bit word synchronous data K28.5 in an additional word data group DWS contained in the composite 10-bit word sequence data DZC(10) are detected and a K28.5 detection output signal SWC is produced to be supplied to a data separating portion 238 and the skew absorbing control signal producing portion 235. The K28.5 detection output signal SWC is obtained in response to the contents of the additional word data group DWC contained in the composite 10-bit word sequence data DZC(10), for example, as shown in FIG. 56B.

In the data separating portion 238, the additional word data group DWS is separated from the composite 8-bit word sequence data DZC(8) with use of the K28.5 detection output signal SWC from the synchronous data detecting, S/P converting and 10B/8B converting portion 237, and 8-bit word sequence data DXC(8) obtained based on the composite 8-bit word sequence data DZC(8) to have the word transmission rate of 92.8125 MBps and the additional word data group DWS are separately obtained. The 8-bit word sequence data DXC(8) thus obtained from the data separating portion 238 are supplied to a 10-bit word sequence data producing portion 239.

In the skew absorbing control signal producing portion 235 to which the K28.5 detection output signal SWY from the synchronous data detecting, S/P converting and 10B/8B converting portion 233 and the K28.5 detection output signal SWC from the synchronous data detecting, S/P converting and 10B/8B converting portion 237 are supplied, time difference between the transmittal signal SLY and the transmittal signal SLC is detected on the strength of time difference between the K28.5 detection output signal SWY and the K28.5 detection output signal SWC and skew absorbing control signals SKY and SKC are produced based on the detected time difference. The skew absorbing control signals SKY and SKC are supplied to the 10-bit word sequence data producing portions 236 and 239, respectively.

In the 10-bit word sequence data producing portion 236, the 8-bit word sequence data DXY(8) is converted into word sequence data, each word data of which are constituted with ten bits, with timing control by the skew absorbing control signal SKY to produce 10-bit word sequence data having the word transmission rate of 92.8125 MBps×8/10=74.25 MBps, so that the Y data sequence DYV constituted with the 10-bit word sequence data is reproduced without skew and derived from the 10-bit word sequence data producing portion 236.

Similarly, in the 10-bit word sequence data producing portion 239, the 8-bit word sequence data DXC(8) is converted into word sequence data, each word data of which are constituted with ten bits, with timing control by the skew absorbing control signal SKC to produce 10-bit word sequence data having the word transmission rate of 92.8125 MBps×8/10=74.25 MBps, so that the PB/PR data sequence DCV constituted with the 10-bit word sequence data is reproduced without skew and derived from the 10-bit word sequence data producing portion 239.

Consequently, the Y data sequence DYV and the PB/PR data sequence DCV which are reproduced without the skew resulted from the time difference between the transmittal signal SLY and the transmittal signal SLC are obtained from the 10-bit word sequence data producing portions 236 and 239, respectively.

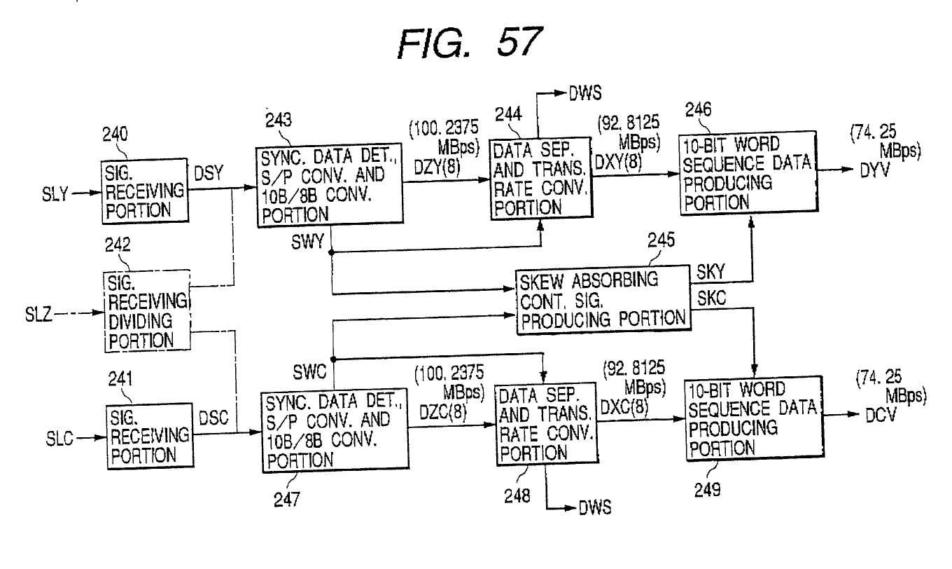

FIG. 57 shows an embodiment of data receiving apparatus for receiving transmittal signals SLY and SLC transmitted from the data transmitting portions 154 and 174 (or a multiplexed transmittal signal SLZ transmitted from the multiplexing portions 175) of the apparatus shown in FIG. 44.

Referring to FIG. 57, signal receiving portions 240 and 241 are provided for receiving the transmittal signal SLY and SLC, each of which is, for example, an electric signal suitable for transmission through a data transmission line made of a coaxial cable or an optical signal suitable for transmission through a data transmission line made of an optical fiber. In the case where the apparatus shown in FIG. 44 is provided with the multiplexing portions 175 for transmitting the multiplexed transmittal signal SLZ, a signal receiving and dividing portion 242 is provided, as shown with a dot-dash line in FIG. 57, for receiving the multiplexed transmittal signal SLZ from the multiplexing portions 175. The signal receiving and dividing portion 242 is operative to reproduce separately serial data DSY and DSC from the multiplexed transmittal signal SLZ received thereby and supply synchronous data detecting, S/P converting and 10B/8B converting portions 243 and 247 with the serial data DSY and DSC, respectively.

The signal receiving portion 240 is operative to reproduce serial data DSY based on the transmittal signal SLY received thereby and supplies the synchronous data detecting, S/P converting and 10B/8B converting portion 243 with the serial data DSY.

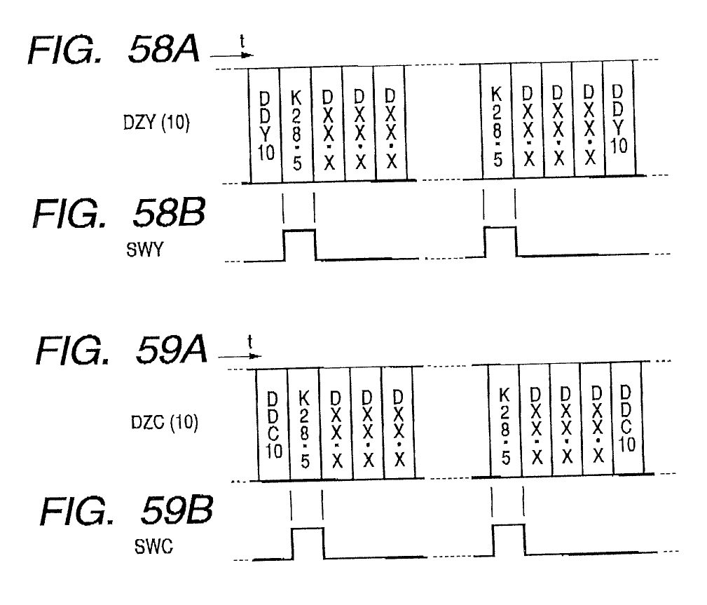

In the synchronous data detecting, S/P converting and 10B/8B converting portion 243, such a portion of the serial data DSY that is formed with serial data converted from 10-bit word synchronous data K28.5 is detected as synchronous data and the serial data DSY are subjected to S/P conversion under a word synchronism condition in accordance with the detected synchronous data to produce composite 10-bit word sequence data DZY(10) having the word transmission rate of, for example, 100.2375 MBps, as shown in FIG. 58A.

Then, in the synchronous data detecting, S/P converting and 10B/8B converting portion 243, the composite 10-bit word sequence data DZY(10) is subjected to 10B/8B conversion by which every ten bits of the composite 10-bit word sequence data DZY(10) are partitioned and the partitioned ten bits are converted into eight bits in accordance with a predetermined conversion table to reproduce composite 8-bit word sequence data DZY(8) having the word transmission rate of 100.2375 MBps. The composite 8-bit word sequence data DZY(8) thus obtained in the synchronous data detecting, S/P converting and 10B/8B converting portion 243 are supplied to a data separating and transmission rate converting portion 244.

Besides, in the synchronous data detecting, S/P converting and 10B/8B converting portion 243, the 10-bit word synchronous data K28.5 in an additional word data group DWS contained in the composite 10-bit word sequence data DZY(10) are detected and a K28.5 detection output signal SWY is produced to be supplied to a data separating and transmission rate converting portion 244 and a skew absorbing control signal producing portion 245. The K28.5 detection output signal SWY is obtained in response to the contents of the additional word data group DWS contained in the composite 10-bit word sequence data DZY(10), for example, as shown in FIG. 58B.

In the data separating and transmission rate converting portion 244, the additional word data group DWS is separated from the composite 8-bit word sequence data DZY(8) with use of the K28.5 detection output signal SWY from the synchronous data detecting, S/P converting and 10B/8B converting portion 243, and 8-bit word sequence data DXY(8) obtained based on the composite 8-bit word sequence data DZY(8) to have the word transmission rate of 100.2375 MBps and the additional word data group DWS are separately obtained. Then, the 8-bit word sequence data DXY(8) are subjected to transmission rate conversion by which the word transmission rate of the 8-bit word sequence data DXY(8) is converted from the 100.2375 MBps to 92.8125 MBps to produce 8-bit word sequence data DXY(8) having the word transmission rate of 92.8125 MBps. The 8-bit word sequence data DXY(8) thus obtained from the data separating and transmission rate converting portion 244 are supplied to a 10-bit word sequence data producing portion 246.

The signal receiving portion 241 is operative to reproduce serial data DSC based on the transmittal signal SLC received thereby and supplies the synchronous data detecting, S/P converting and 10B/8B converting portion 247 with the serial data DSC.

In the synchronous data detecting, S/P converting and 10B/8B converting portion 247, such a portion of the serial data DSC that is formed with serial data converted from 10-bit word synchronous data K28.5 is detected as synchronous data and the serial data DSC are subjected to S/P conversion under a word synchronism condition in accordance with the detected synchronous data to produce composite 10-bit word sequence data DZC(10) having the word transmission rate of, for example, 100.2375 MBps, as shown in FIG. 59A. Then, in the synchronous data detecting, S/P converting and 10B/8B converting portion 247, the composite 10-bit word sequence data DZC(10) is subjected to 10B/8B conversion by which every ten bits of the composite 10-bit word sequence data DZC(10) are partitioned and the partitioned ten bits are converted into eight bits in accordance with a predetermined conversion table to reproduce composite 8-bit word sequence data DZC(8) having the word transmission rate of 100.2375 MBps. The composite 8-bit word sequence data DZC(8) thus obtained in the synchronous data detecting, S/P converting and 10B/8B converting portion 247 are supplied to a data separating and transmission rate converting portion 248.

Besides, in the synchronous data detecting, S/P converting and 10B/8B converting portion 247, the 10-bit word synchronous data K28.5 in an additional word data group DWS contained in the composite 10-bit word sequence data DZC(10) are detected and a K28.5 detection output signal SWC is produced to be supplied to a data separating and transmission rate converting portion 248 and the skew absorbing control signal producing portion 245. The K28.5 detection output signal SWC is obtained in response to the contents of the additional word data group DWS contained in the composite 10-bit word sequence data DZC(10), for example, as shown in FIG. 59B.

In the data separating and transmission rate converting portion 248, the additional word data group DWS is separated from the composite 8-bit word sequence data DZC(8) with use of the K28.5 detection output signal SWC from the synchronous data detecting, S/P converting and 10B/8B converting portion 247, and 8-bit word sequence data DXC(8) obtained based on the composite 8-bit word sequence data DZC(8) to have the word transmission rate of 100.2375 MBps and the additional word data group DWS are separately obtained. Then, the 8-bit word sequence data DXC(8) are subjected to transmission rate conversion by which the word transmission rate of the 8-bit word sequence data DXC(8) is converted from the 100.2375 MBps to 92.8125 MBps to produce 8-bit word sequence data DXC(8) having the word transmission rate of 92.8125 MBps. The 8-bit word sequence data DXC(8) thus obtained from the data separating and transmission rate converting portion 248 are supplied to a 10-bit word sequence data producing portion 249.

In the skew absorbing control signal producing portion 245 to which the K28.5 detection output signal SWY from the synchronous data detecting, S/P converting and 10B/8B converting portion 243 and the K28.5 detection output signal SWC from the synchronous data detecting, S/P converting and 10B/8B converting portion 247 are supplied, time difference between the transmittal signal SLY and the transmittal signal SLC is detected on the strength of time difference between the K28.5 detection output signal SWY and the K28.5 detection output signal SWC and skew absorbing control signals SKY and SKC are produced based on the detected time difference. The skew absorbing control signals SKY and SKC are supplied to the 10-bit word sequence data producing portions 246 and 249, respectively.

In the 10-bit word sequence data producing portion 246, the 8-bit word sequence data DXY(8) is converted into word sequence data, each word data of which are constituted with ten bits, with timing control by the skew absorbing control signal SKY to produce 10-bit word sequence data having the word transmission rate of 92.8125 MBps×8/10=74.25 MBps, so that the Y data sequence DYV constituted with the 10-bit word sequence data is reproduced without skew and derived from the 10-bit word sequence data producing portion 246.

Similarly, in the 10-bit word sequence data producing portion 249, the 8-bit word sequence data DXC(8) is converted into word sequence data, each word data of which are constituted with ten bits, with timing control by the skew absorbing control signal SKC to produce 10-bit word sequence data having the word transmission rate of 92.8125 MBps×8/10=74.25 MBps, so that the PB/PR data sequence DCV constituted with the 10-bit word sequence data is reproduced without skew and derived from the 10-bit word sequence data producing portion 249.

Consequently, the Y data sequence DYV and the PB/PR data sequence DCV which are reproduced without the skew resulted from the time difference between the transmittal signal SLY and the transmittal signal SLC are obtained from the 10-bit word sequence data producing portions 246 and 249, respectively.

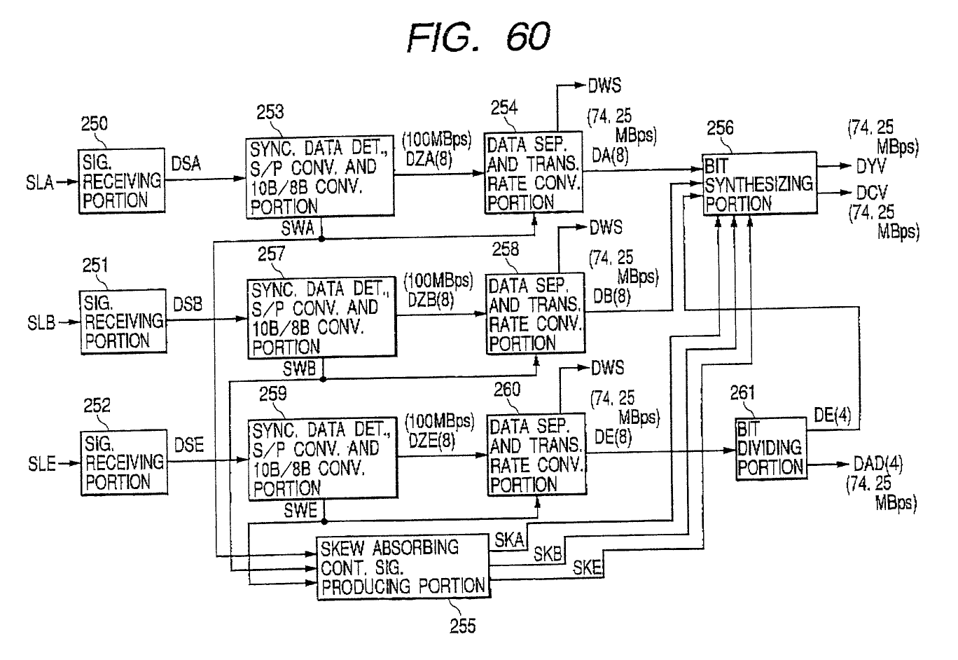

FIG. 60 shows an embodiment of data receiving apparatus for receiving transmittal signals SLA, SLB and SLE transmitted from the data transmitting portions 188, 193 and 198 of the apparatus shown in FIG. 51.

Referring to FIG. 60, signal receiving portions 250, 251 and 252 are provided for receiving the transmittal signal SLA, SLB and SLE, each of which is, for example, an electric signal suitable for transmission through a data transmission line made of a coaxial cable or an optical signal suitable for transmission through a data transmission line made of an optical fiber.

The signal receiving portion 250 is operative to reproduce serial data DSA based on the transmittal signal SLA received thereby and supplies a synchronous data detecting, S/P converting and 10B/8B converting portion 253 with the serial data DSA.

In the synchronous data detecting, S/P converting and 10B/8B converting portion 253, such a portion of the serial data DSA that is formed with serial data converted from 10-bit word synchronous data K28.5 is detected as synchronous data and the serial data DSA are subjected to S/P conversion under a word synchronism condition in accordance with the detected synchronous data to produce composite 10-bit word sequence data DZA(10) having the word transmission rate of, for example, 100 MBps.

Then, in the synchronous data detecting, S/P converting and 10B/8B converting portion 253, the composite 10-bit word sequence data DZA(10) is subjected to 10B/8B conversion by which every ten bits of the composite 10-bit word sequence data DZA(10) are partitioned and the partitioned ten bits are converted into eight bits in accordance with a predetermined conversion table to reproduce composite 8-bit word sequence data DZA(8) having the word transmission rate of 100 MBps. The composite 8-bit word sequence data DZA(8) thus obtained in the synchronous data detecting, S/P converting and 10B/8B converting portion 253 are supplied to a data separating and transmission rate converting portion 254.

Besides, in the synchronous data detecting, S/P converting and 10B/8B converting portion 253, the 10-bit word synchronous data K28.5 in an additional word data group DWS contained in the composite 10-bit word sequence data DZA(10) are detected and a K28.5 detection output signal SWA is produced to be supplied to the data separating and transmission rate converting portion 254 and a skew absorbing control signal producing portion 255.

In the data separating and transmission rate converting portion 254, the additional word data group DWS is separated from the composite 8-bit word sequence data DZA(8) with use of the K28.5 detection output signal SWA from the synchronous data detecting, S/P converting and 10B/8B converting portion 253, and 8-bit word sequence data DA(8) obtained based on the composite 8-bit word sequence data DZA(8) to have the word transmission rate of 100 MBps and the additional word data group DWS are separately obtained. Then, the 8-bit word sequence data DA(8) are subjected to transmission rate conversion by which the word transmission rate of the 8-bit word sequence data DA(8) is converted from the 100 MBps to 74.25 MBps to produce 8-bit word sequence data DA(8) having the word transmission rate of 74.25 MBps. The 8-bit word sequence data DA(8) thus obtained from the data separating and transmission rate converting portion 254 are supplied to a bit synthesizing portion 256.

The signal receiving portion 251 is operative to reproduce serial data DSB based on the transmittal signal SLB received thereby and supplies a synchronous data detecting, S/P converting and 10B/8B converting portion 257 with the serial data DSB.

In the synchronous data detecting, S/P converting and 10B/8B converting portion 257, such a portion of the serial data DSB that is formed with serial data converted from 10-bit word synchronous data K28.5 is detected as synchronous data and the serial data DSB are subjected to S/P conversion under a word synchronism condition in accordance with the detected synchronous data to produce composite 10-bit word sequence data DZB(10) having the word transmission rate of, for example, 100 MBps.

Then, in the synchronous data detecting, S/P converting and 10B/8B converting portion 257, the composite 10-bit word sequence data DZB(10) is subjected to 10B/8B conversion by which every ten bits of the composite 10-bit word sequence data DZB(10) are partitioned and the partitioned ten bits are converted into eight bits in accordance with a predetermined conversion table to reproduce composite 8-bit word sequence data DZB(8) having the word transmission rate of 100 MBps. The composite 8-bit word sequence data DZB(8) thus obtained in the synchronous data detecting, S/P converting and 10B/8B converting portion 257 are supplied to a data separating and transmission rate converting portion 258.

Besides, in the synchronous data detecting, S/P converting and 10B/8B converting portion 257, the 10-bit word synchronous data K28.5 in an additional word data group DWS contained in the composite 10-bit word sequence data DZB(10) are detected and a K28.5 detection output signal SWB is produced to be supplied to the data separating and transmission rate converting portion 258 and the skew absorbing control signal producing portion 255.

In the data separating and transmission rate converting portion 258, the additional word data group DWS is separated from the composite 8-bit word sequence data DZB(8) with use of the K28.5 detection output signal SWB from the synchronous data detecting, S/P converting and 10B/8B converting portion 257, and 8-bit word sequence data DB(8) obtained based on the composite 8-bit word sequence data DZB(8) to have the word transmission rate of 100 MBps and the additional word data group DWS are separately obtained. Then, the 8-bit word sequence data DB(8) are subjected to transmission rate conversion by which the word transmission rate of the 8-bit word sequence data DB(8) is converted from the 100 MBps to 74.25 MBps to produce 8-bit word sequence data DB(8) having the word transmission rate of 74.25 MBps. The 8-bit word sequence data DB(8) thus obtained from the data separating and transmission rate converting portion 258 are supplied to the bit synthesizing portion 256.

The signal receiving portion 252 is operative to reproduce serial data DSE based on the transmittal signal SLE received thereby and supplies a synchronous data detecting, S/P converting and 10B/8B converting portion 259 with the serial data DSE.

In the synchronous data detecting, S/P converting and 10B/8B converting portion 259, such a portion of the serial data DSE that is formed with serial data converted from 10-bit word synchronous data K28.5 is detected as synchronous data and the serial data DSE are subjected to S/P conversion under a word synchronism condition in accordance with the detected synchronous data to produce composite 10-bit word sequence data DZE(10) having the word transmission rate of, for example, 100 MBps.

Then, in the synchronous data detecting, S/P converting and 10B/8B converting portion 259, the composite 10-bit word sequence data DZE(10) is subjected to 10B/8B conversion by which every ten bits of the composite 10-bit word sequence data DZE(10) are partitioned and the partitioned ten bits are converted into eight bits in accordance with a predetermined conversion table to reproduce composite 8-bit word sequence data DZE(8) having the word transmission rate of 100 MBps. The composite 8-bit word sequence data DZE(8) thus obtained in the synchronous data detecting, S/P converting and 10B/8B converting portion 259 are supplied to a data separating and transmission rate converting portion 260.

Besides, in the synchronous data detecting, S/P converting and 10B/8B converting portion 259 the 10-bit word synchronous data K28.5 in an additional word data group DWS contained in the composite 10-bit word sequence data DZE(10) are detected and a K28.5 detection output signal SWE is produced to be supplied to the data separating and transmission rate converting portion 260 and the skew absorbing control signal producing portion 255.

In the data separating and transmission rate converting portion 260, the additional word data group DWS is separated from the composite 8-bit word sequence data DZE(8) with use of the K28.5 detection output signal SWE from the synchronous data detecting, S/P converting and 10B/8B converting portion 259, and 8-bit word sequence data DE(8) obtained based on the composite 8-bit word sequence data DZE(8) to have the word transmission rate of 100 MBps and the additional word data group DWS are separately obtained. Then, the 8-bit word sequence data DE(8) are subjected to transmission rate conversion by which the word transmission rate of the 8-bit word sequence data DE(8) is converted from the 100 MBps to 74.25 MBps to produce 8-bit word sequence data DE(8) having the word transmission rate of 74.25 MBps. The 8-bit word sequence data DE(8) thus obtained from the data separating and transmission rate converting portion 260 are supplied to a bit dividing portion 261.

In the bit dividing portion 261, each word data of the 8-bit word sequence data DE(8) are divided successively into a couple of groups of four bits so that 4-bit word sequence data DE(4) and 4-bit word sequence additional data DAD(4) each having the word transmission rate of 74.25 MBps are formed. The 4-bit word sequence data DE(4) are supplied to the bit synthesizing portion 256 and the 4-bit word sequence additional data DAD(4) are derived from the bit dividing portion 261 as reproduced data.

In the skew absorbing control signal producing portion 255 to which the K28.5 detection output signal SWA from the synchronous data detecting, S/P converting and 10B/8B converting portion 253, the K28.5 detection output signal SWB from the synchronous data detecting, S/P converting and 10B/8B converting portion 257 and the K28.5 detection output signal SWE from the synchronous data detecting, S/P converting and 10B/8B converting portion 259 are supplied, time difference among the transmittal signals SLA, SLB and SLE is detected on the strength of time difference among the K28.5 detection output signals SWA, SWB and SWE and skew absorbing control signals SKA, SKB and SKE are produced based on the detected time difference. The skew absorbing control signals SKA, SKB and SKE are supplied to the bit synthesizing portion 256.

In the bit synthesizing portion 256 to which the 8-bit word sequence data DA(8) from the data separating and transmission rate converting portion 254, the 8-bit word sequence data DB(8) from the data separating and transmission rate converting portion 258 and the 4-bit word sequence data DE(4) from the bit dividing portion 261 are supplied, the 8-bit word sequence data DA(8), the 8-bit word sequence data DB(8) and the 4-bit word sequence data DE(4) are added to one another to produce 20-bit word sequence data with timing control by the skew absorbing control signals SKA, SKB and SKI. Then, each word data of the 20-bit word sequence data are divided successively into a couple of ten bits so that 10-bit word sequence data constituting Y data sequence DYV having the word transmission rate of 74.25 MBps and 10-bit word sequence data constituting PB/PR data sequence DCV having the word transmission rate of 74.25 MBps are reproduced.

Consequently, the reproduced 4-bit word sequence additional data DAD(4) are obtained from the bit dividing portion 261 and the reproduced Y data sequence DYV and the reproduced PB/PR data sequence DCV are obtained from the bit synthesizing portion 256.

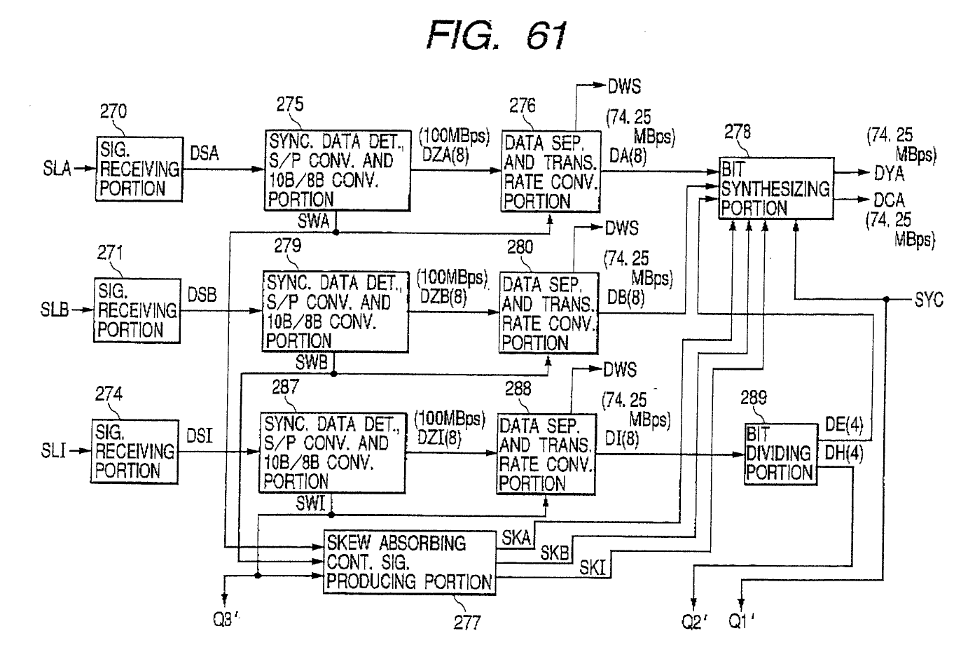

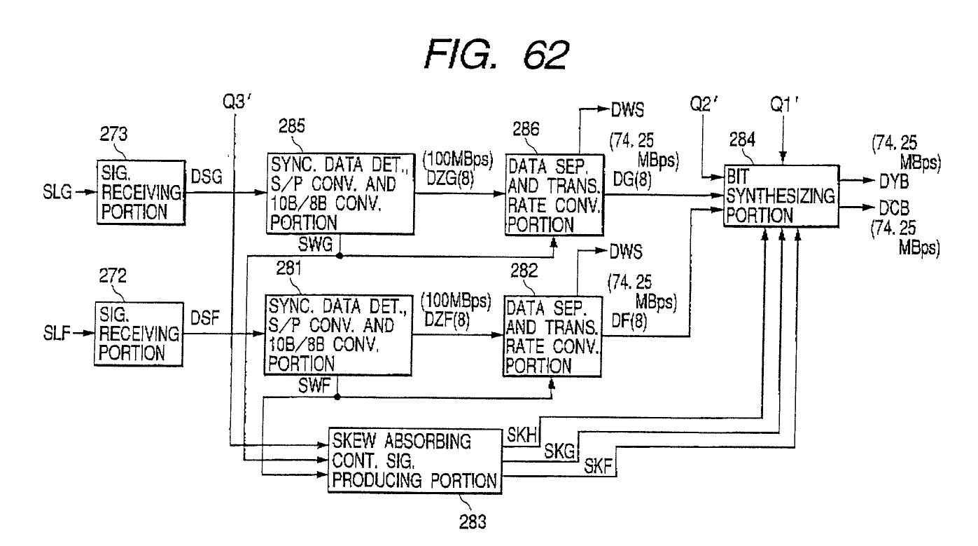

FIGS. 61 and 62 show an embodiment of data receiving apparatus for receiving transmittal signals SLA, SLB, SLF, SLG and SLI transmitted from the data transmitting portions 205, 210, 217, 222 and 227 of the apparatus shown in FIGS. 52 and 53.

Referring to FIGS. 52 and 53, signal receiving portions 270, 271, 272, 273 and 274 are provided for receiving the transmittal signal SLA, SLB, SLF, SLG and SLI, respectively. Each of the transmittal signal SLA, SLB, SLF, SLG and SLI is, for example, an electric signal suitable for transmission through a data transmission line made of a coaxial cable or an optical signal suitable for transmission through a data transmission line made of an optical fiber.

The signal receiving portion 270 is operative to reproduce serial data DSA based on the transmittal signal SLA received thereby and supplies a synchronous data detecting, S/P converting and 10B/8B converting portion 275 with the serial data DSA.

In the synchronous data detecting, S/P converting and 10B/8B converting portion 275, such a portion of the serial data DSA that is formed with serial data converted from 10-bit word synchronous data K28.5 is detected as synchronous data and the serial data DSA are subjected to S/P conversion under a word synchronism condition in accordance with the detected synchronous data to produce composite 10-bit word sequence data DZA(10) having the word transmission rate of, for example, 100 MBps.

Then, in the synchronous data detecting, S/P converting and 10B/8B converting portion 275, the composite 10-bit word sequence data DZA(10) is subjected to 10B/8B conversion by which every ten bits of the composite 10-bit word sequence data DZA(10) are partitioned and the partitioned ten bits are converted into eight bits in accordance with a predetermined conversion table to reproduce composite 8-bit word sequence data DZA(8) having the word transmission rate of 100 MBps. The composite 8-bit word sequence data DZA(8) thus obtained in the synchronous data detecting, S/P converting and 10B/8B converting portion 275 are supplied to a data separating and transmission rate converting portion 276.

Besides, in the synchronous data detecting, S/P converting and 10B/8B converting portion 275, the 10-bit word synchronous data K28.5 in an additional word data group DWS contained in the composite 10-bit word sequence data DZA(10) are detected and a K28.5 detection output signal SWA is produced to be supplied to the data separating and transmission rate converting portion 276 and a skew absorbing control signal producing portion 277.

In the data separating and transmission rate converting portion 276, the additional word data group DWS is separated from the composite 8-bit word sequence data DZA(8) with use of the K28.5 detection output signal SWA from the synchronous data detecting, S/P converting and 10B/8B converting portion 275, and 8-bit word sequence data DA(8) obtained based on the composite 8-bit word sequence data DZA(8) to have the word transmission rate of 100 MBps and the additional word data group DWS are separately obtained. Then, the 8-bit word sequence data DA(8) are subjected to transmission rate conversion by which the word transmission rate of the 8-bit word sequence data DA(8) is converted from the 100 MBps to 74.25 MBps to produce 8-bit word sequence data DA(8) having the word transmission rate of 74.25 MBps. The 8-bit word sequence data DA(8) thus obtained from the data separating and transmission rate converting portion 276 are supplied to a bit synthesizing portion 278.

The signal receiving portion 271 is operative to reproduce serial data DSB based on the transmittal signal SLB received thereby and supplies a synchronous data detecting, S/P converting and 10B/8B converting portion 279 with the serial data DSB.

In the synchronous data detecting, S/P converting and 10B/8B converting portion 279, such a portion of the serial data DSB that is formed with serial data converted from 10-bit word synchronous data K28.5 is detected as synchronous data and the serial data DSB are subjected to S/P conversion under a word synchronism condition in accordance with the detected synchronous data to produce composite 10-bit word sequence data DZB(10) having the word transmission rate of, for example, 100 MBps.

Then, in the synchronous data detecting, S/P converting and 10B/8B converting portion 279, the composite 10-bit word sequence data DZB(10) is subjected to 10B/8B conversion by which every ten bits of the composite 10-bit word sequence data DZB(10) are partitioned and the partitioned ten bits are converted into eight bits in accordance with a predetermined conversion table to reproduce composite 8-bit word sequence data DZB(8) having the word transmission rate of 100 MBps. The composite 8-bit word sequence data DZB(8) thus obtained in the synchronous data detecting, S/P converting and 10B/8B converting portion 279 are supplied to a data separating and transmission rate converting portion 280.

Besides, in the synchronous data detecting, S/P converting and 10B/8B converting portion 279, the 10-bit word synchronous data K28.5 in an additional word data group DWS contained in the composite 10-bit word sequence data DZB(10) are detected and a K28.5 detection output signal SWB is produced to be supplied to the data separating and transmission rate converting portion 280 and the skew absorbing control signal producing portion 277.

In the data separating and transmission rate converting portion 280, the additional word data group DWS is separated from the composite 8-bit word sequence data DZB(8) with use of the K28.5 detection output signal SWB from the synchronous data detecting, S/P converting and 10B/8B converting portion 279, and 8-bit word sequence data DB(8) obtained based on the composite 8-bit word sequence data DZB(8) to have the word transmission rate of 100 MBps and the additional word data group DWS are separately obtained. Then, the 8-bit word sequence data DB(8) are subjected to transmission rate conversion by which the word transmission rate of the 8-bit word sequence data DB(8) is converted from the 100 MBps to 74.25 MBps to produce 8-bit word sequence data DB(8) having the word transmission rate of 74.25 MBps. The 8-bit word sequence data DB(8) thus obtained from the data separating and transmission rate converting portion 280 are supplied to the bit synthesizing portion 278.

The signal receiving portion 272 is operative to reproduce serial data DSF based on the transmittal signal SLF received thereby and supplies a synchronous data detecting, S/P converting and 10B/8B converting portion 281 with the serial data DSF.

In the synchronous data detecting, S/P converting and 10B/8B converting portion 281, such a portion of the serial data DSF that is formed with serial data converted from 10-bit word synchronous data K28.5 is detected as synchronous data and the serial data DSF are subjected to S/P conversion under a word synchronism condition in accordance with the detected synchronous data to produce composite 10-bit word sequence data DZF(10) having the word transmission rate of, for example, 100 MBps.

Then, in the synchronous data detecting, S/P converting and 10B/8B converting portion 281, the composite 10-bit word sequence data DZF(10) is subjected to 10B/8B conversion by which every ten bits of the composite 10-bit word sequence data DZF(10) are partitioned and the partitioned ten bits are converted into eight bits in accordance with a predetermined conversion table to reproduce composite 8-bit word sequence data DZF(8) having the word transmission rate of 100 MBps. The composite 8-bit word sequence data DZF(8) thus obtained in the synchronous data detecting, S/P converting and 10B/8B converting portion 281 are supplied to a data separating and transmission rate converting portion 282.

Besides, in the synchronous data detecting, S/P converting and 10B/8B converting portion 281, the 10-bit word synchronous data K28.5 in an additional word data group DWS contained in the composite 10-bit word sequence data DZF(10) are detected and a K28.5 detection output signal SWF is produced to be supplied to the data separating and transmission rate converting portion 282 and a skew absorbing control signal producing portion 283.

In the data separating and transmission rate converting portion 282, the additional word data group DWS is separated from the composite 8-bit word sequence data DZF(8) with use of the K28.5 detection output signal SWF from the synchronous data detecting, S/P converting and 10B/8B converting portion 281, and 8-bit word sequence data DF(8) obtained based on the composite 8-bit word sequence data DZF(8) to have the word transmission rate of 100 MBps and the additional word data group DWS are separately obtained. Then, the 8-bit word sequence data DF(8) are subjected to transmission rate conversion by which the word transmission rate of the 8-bit word sequence data DF(8) is converted from the 100 MBps to 74.25 MBps to produce 8-bit word sequence data DF(8) having the word transmission rate of 74.25 MBps. The 8-bit word sequence data DF(8) thus obtained from the data separating and transmission rate converting portion 282 are supplied to a bit synthesizing portion 284.

The signal receiving portion 273 is operative to reproduce serial data DSG based on the transmittal signal SLG received thereby and supplies a synchronous data detecting, S/P converting and 10B/8B converting portion 285 with the serial data DSG.

In the synchronous data detecting, S/P converting and 10B/8B converting portion 285, such a portion of the serial data DSG that is formed with serial data converted from 10-bit word synchronous data K28.5 is detected as synchronous data and the serial data DSG are subjected to S/P conversion under a word synchronism condition in accordance with the detected synchronous data to produce composite 10-bit word sequence data DZG(10) having the word transmission rate of, for example, 100 MBps.

Then, in the synchronous data detecting, S/P converting and 10B/8B converting portion 285, the composite 10-bit word sequence data DZG(10) is subjected to 10B/8B conversion by which every ten bits of the composite 10-bit word sequence data DZG(10) are partitioned and the partitioned ten bits are converted into eight bits in accordance with a predetermined conversion table to reproduce composite 8-bit word sequence data DZG(8) having the word transmission rate of 100 MBps. The composite 8-bit word sequence data DZG(8) thus obtained in the synchronous data detecting, S/P converting and 10B/8B converting portion 285 are supplied to a data separating and transmission rate converting portion 286.

Besides, in the synchronous data detecting, S/P converting and 10B/8B converting portion 285, the 10-bit word synchronous data K28.5 in an additional word data group DWS contained in the composite 10-bit word sequence data DZG(10) are detected and a K28.5 detection output signal SWG is produced to be supplied to the data separating and transmission rate converting portion 286 and the skew absorbing control signal producing portion 283.

In the data separating and transmission rate converting portion 286, the additional word data group DWS is separated from the composite 8-bit word sequence data DZG(8) with use of the K28.5 detection output signal SWG from the synchronous data detecting, S/P converting and 10B/8B converting portion 285, and 8-bit word sequence data DG(8) obtained based on the composite 8-bit word sequence data DZG(8) to have the word transmission rate of 100 MBps and the additional word data group DWS are separately obtained. Then, the 8-bit word sequence data DG(8) are subjected to transmission rate conversion by which the word transmission rate of the 8-bit word sequence data DG(8) is converted from the 100 MBps to 74.25 MBps to produce 8-bit word sequence data DG(8) having the word transmission rate of 74.25 MBps. The 8-bit word sequence data DG(8) thus obtained from the data separating and transmission rate converting portion 286 are supplied to the bit synthesizing portion 284.

The signal receiving portion 274 is operative to reproduce serial data DSI based on the transmittal signal SLI received thereby and supplies a synchronous data detecting, S/P converting and 10B/8B converting portion 287 with the serial data DSI.

In the synchronous data detecting, S/P converting and 10B/8B converting portion 287, such a portion of the serial data DSI that is formed with serial data converted from 10-bit word synchronous data K28.5 is detected as synchronous data and the serial data DSI are subjected to S/P conversion under a word synchronism condition in accordance with the detected synchronous data to produce composite 10-bit word sequence data DZI(10) having the word transmission rate of, for example, 100 MBps.

Then, in the synchronous data detecting, S/P converting and 10B/8B converting portion 287, the composite 10-bit word sequence data DZI(10) is subjected to 10B/8B conversion by which every ten bits of the composite 10-bit word sequence data DZI(10) are partitioned and the partitioned ten bits are converted into eight bits in accordance with a predetermined conversion table to reproduce composite 8-bit word sequence data DZI(8) having the word transmission rate of 100 MBps. The composite 8-bit word sequence data DZI(8) thus obtained in the synchronous data detecting, S/P converting and 10B/8B converting portion 287 are supplied to a data separating and transmission rate converting portion 288.

Besides, in the synchronous data detecting, S/P converting and 10B/8B converting portion 287, the 10-bit word synchronous data K28.5 in an additional word data group DWS contained in the composite 10-bit word sequence data DZI(10) are detected and a K28.5 detection output signal SWI is produced to be supplied to the data separating and transmission rate converting portion 288 and the skew absorbing control signal producing portions 277 and 283.

In the data separating and transmission rate converting portion 288, the additional word data group DWS is separated from the composite 8-bit word sequence data DZI(8) with use of the K28.5 detection output signal SWI from the synchronous data detecting, S/P converting and 10B/8B converting portion 287, and 8-bit word sequence data DI(8) obtained based on the composite 8-bit word sequence data DZI(8) to have the word transmission rate of 100 MBps and the additional word data group DWS are separately obtained. Then, the 8-bit word sequence data DI(8) are subjected to transmission rate conversion by which the word transmission rate of the 8-bit word sequence data DI(8) is converted from the 100 MBps to 74.25 MBps to produce 8-bit word sequence data DI(8) having the word transmission rate of 74.25 MBps. The 8-bit word sequence data DI(8) thus obtained from the data separating and transmission rate converting portion 288 are supplied to a bit dividing portion 289.

In the bit dividing portion 289, each word data of the 8-bit word sequence data DI(8) are divided successively into a couple of groups of four bits so that 4-bit word sequence data DE(4) and 4-bit word sequence data DH(4) each having the word transmission rate of 74.25 MBps are formed. The 4-bit word sequence data DE(4) are supplied to the bit synthesizing portion 278 and the 4-bit word sequence data DH(4) are supplied to the bit synthesizing portion 284.

In the skew absorbing control signal producing portion 277 to which the K28.5 detection output signal SWA from the synchronous data detecting, S/P converting and 10B/8B converting portion 275, the K28.5 detection output signal SWB from the synchronous data detecting, S/P converting and 10B/8B converting portion 279 and the K28.5 detection output signal SWI from the synchronous data detecting, S/P converting and 10B/8B converting portion 287 are supplied, time difference among the transmittal signals SLA, SLB and SLI is detected on the strength of time difference among the K28.5 detection output signals SWA, SWB and SWI and skew absorbing control signals SKA, SKB and SKI are produced based on the detected time difference. The skew absorbing control signals SKA, SKB and SKI are supplied to the bit synthesizing portion 278.

Similarly, in the skew absorbing control signal producing portion 283 to which the K28.5 detection output signal SWF from the synchronous data detecting, S/P converting and 10B/8B converting portion 281, the K28.5 detection output signal SWG from the synchronous data detecting, S/P converting and 10B/8B converting portion 285 and the K28.5 detection output signal SWI from the synchronous data detecting, S/P converting and 10B/8B converting portion 287 are supplied, time difference among the transmittal signals SLF, SLG and SLI is detected on the strength of time difference among the K28.5 detection output signals SWF, SWG and SWI and skew absorbing control signals SKF, SKG and SKH are produced based on the detected time difference. The skew absorbing control signals SKF, SKG and SKH are supplied to the bit synthesizing portion 284.

A common synchronous signal SYC is supplied to both of the bit synthesizing portions 278 and 284 and thereby the bit synthesizing portions 278 and 284 are in synchronism with each other.

In the bit synthesizing portion 278 to which the 8-bit word sequence data DA(8) from the data separating and transmission rate converting portion 276, the 8-bit word sequence data DB(8) from the data separating and transmission rate converting portion 280 and the 4-bit word sequence data DE(4) from the bit dividing portion 289 are supplied, the 8-bit word sequence data DA(8), the 8-bit word sequence data DB(8) and the 4-bit word sequence data DE(4) are added to one another to produce 20-bit word sequence data with timing control by the skew absorbing control signals SKA, SKB and SKI. Then, each word data of the 20-bit word sequence data are divided successively into a couple of ten bits so that 10-bit word sequence data constituting Y data sequence DYA having the word transmission rate of 74.25 MBps and 10-bit word sequence data constituting PB/PR data sequence DCA having the word transmission rate of 74.25 MBps are reproduced.

Consequently, the reproduced Y data sequence DYA and the reproduced PB/PR data sequence DCA are obtained from the bit synthesizing portion 278.

Similarly, in the bit synthesizing portion 284 to which the 8-bit word sequence data DF(8) from the data separating and transmission rate converting portion 282, the 8-bit word sequence data DG(8) from the data separating and transmission rate converting portion 286 and the 4-bit word sequence data DH(4) from the bit dividing portion 289 are supplied, the 8-bit word sequence data DF(8), the 8-bit word sequence data DG(8) and the 4-bit word sequence data DH(4) are added to one another to produce 20-bit word sequence data with timing control by the skew absorbing control signals SKF, SKG and SKH. Then, each word data of the 20-bit word sequence data are divided successively into a couple of ten bits so that 10-bit word sequence data constituting Y data sequence DYB having the word transmission rate of 74.25 MBps and 10-bit word sequence data constituting PB/PR data sequence DCB having the word transmission rate of 74.25 MBps are reproduced.

Consequently, the reproduced Y data sequence DYB and the reproduced PB/PR data sequence DCB are obtained from the bit synthesizing portion 284.

Although the Y data sequence and the PB/PR data sequence constituting the HD signal are selected as digital information data to be transmitted in the embodiments shown in FIGS. 35, 44, 51, 52 and 53 mentioned above, it should be understood that digital information data to be transmitted by the method or apparatus according to the present invention are not limited to the Y data sequence and the PB/PR data sequence constituting the HD signal.

What is claimed is:

1. A method of transmitting digital data, which comprises the steps of;
multiplexing a plurality of compressed digital video or video and audio signal data to produce 8-bit word sequence data,
combining an additional word data group including 8-bit word synchronous data allotted a predetermined specific code with the 8-bit word sequence data to produce composite 8-bit word sequence data in which the additional word data group is repeatedly inserted at predetermined word intervals,
causing the composite 8-bit word sequence data to be subjected to 8B/10B conversion to produce composite 10-bit word sequence data having a portion formed based on the additional word data group including 10-bit word synchronous data provided with running disparity not neutral,
converting the composite 10-bit word sequence data into serial data, and
transmitting the serial data.

2. A method according to claim 1 further comprising the step of converting the word transmission rate of said composite 8-bit word sequence data in advance of the 8B/10B conversion.

3. A method according to claim 1, wherein said additional word data group is selected to include ancillary data to be converted into 10-bit word data of neutral running disparity by the 8B/10B conversion.

4. A method of transmitting digital data, which comprises the steps of;
multiplexing a plurality of digital video signals or combinations of a plurality of digital video signals and a bit adding signal to produce word sequence data,
inserting an additional word data group including word synchronous data allotted a predetermined specific code into the word sequence data at predetermined word intervals thereof to produce composite word sequence data,
causing the composite word sequence data to be subjected to 8B/10B conversion to produce converted composite word sequence data having a portion formed based on the additional word data group to include converted word synchronous data provided with running disparity not neutral,
converting the converted composite word sequence data into serial data, and
transmitting the serial data.

5. A method according to claim 4 further comprising the step of converting the word transmission rate of said word sequence data in advance of the 8B/10B conversion.

6. A method according to claim 4, wherein said additional word data group is selected to include ancillary data to be converted into 10-bit word data of neutral running disparity by the 8B/10B conversion.

7. A method according to claim 6, wherein said additional word data group is selected to have at least a couple of portions each including said word synchronous data and said ancillary data arranged in series.

8. A method of transmitting digital data, which comprises the steps of;
multiplexing a plurality of digital video signals or combinations of a plurality of digital video signals and a bit adding signal to produce word sequence data,
inserting an additional word data group having at least a couple of portions each including word synchronous data allotted a predetermined specific code and ancillary word data into the word sequence data at predetermined word intervals thereof to produce composite word sequence data,
causing the composite word sequence data to be subjected to 8B/10B conversion to produce converted composite word sequence data having a portion formed based on the additional word data group to include at least a couple of converted word synchronous data each provided with running disparity not neutral,
converting the converted composite word sequence data into serial data, and
transmitting the serial data.

9. A method according to claim 8, wherein at least one of said word synchronous data are selected to be converted into 10-bit word data of positive running disparity by the 8B/10B conversion.

10. A method according to claim 8, wherein at least one of said word synchronous data are selected to be converted into 10-bit word data of negative running disparity by the 8B/10B conversion.

11. A method according to claim 8, wherein at least one of said ancillary data are selected to be converted into 10-bit word data of neutral running disparity by the 8B/10B conversion.

12. A method according to claim 8, wherein said additional word data group is selected to include ancillary data for reversing running disparity, said ancillary data for reversing running disparity being converted into first 10-bit word data of positive running disparity by the 8B/10B conversion when the running disparity just before said first 10-bit word data is negative and into second 10-bit word data of negative running disparity by the 8B/10B conversion when the running disparity just before said second 10-bit word data is positive.

13. A method according to claim 8, wherein each of said digital video signal is selected to be constituted with 16-bit word sequence data and said converted composite word sequence data are obtained in the form of 20-bit word sequence data.

14. A method of transmitting digital data, which comprises the steps of;
obtaining first and second 8-bit word sequence data based on first and second digital information data forming a digital video signal, respectively,
inserting an additional word data group including 8-bit word synchronous data allotted a predetermined specific code into each of the first and second 8-bit word sequence data at predetermined word intervals thereof to produce first and second composite 8-bit word sequence data,
causing each of the first and second composite 8-bit word sequence data to be subjected to 8B/10B conversion to produce first and second composite 10-bit word sequence data each having a portion formed based on the additional word data group to include 10-bit word synchronous data allotted a predetermined specific code obtained based on the 8-bit word synchronous data,
converting the first and second composite 10-bit word sequence data into first and second serial data, respectively, and
transmitting the first and second serial data.

15. A method according to claim 14 further comprising the step of converting the word transmission rate of each of said first and second composite 8-bit word sequence data in advance of the insertion of the additional word data group.

16. A method according to claim 14, wherein said additional word data group is selected to have at least a couple of portions each including said 8-bit word synchronous data.

17. A method according to claim 14, wherein said 8-bit word synchronous data are selected to be converted into 10-bit word data of positive running disparity by the 8B/10B conversion.

18. A method according to claim 14, wherein said 8-bit word synchronous data are selected to be converted into 10-bit word data of negative running disparity by the 8B/10B conversion.

19. A method of transmitting digital data, which comprises the steps of;
causing a digital video signal to be subjected to bit-dividing to produce first, second and third divided-bit word sequence data,
inserting an additional word data group including 8-bit word synchronous data allotted a predetermined specific code into each of the first, second and third divided-bit word sequence data at predetermined word intervals thereof to produce first, second and third composite 8-bit word sequence data,
causing each of the first, second and third composite 8-bit word sequence data to be subjected to 8B/10B conversion to produce first, second and third composite 10-bit word sequence data each having a portion formed based on the additional word data group to include 10-bit word synchronous data allotted a predetermined specific code obtained based on the 8-bit word synchronous data,
converting the first, second and third composite 10-bit word sequence data into first, second and third serial data, respectively, and
transmitting the first, second and third serial data.

20. A method according to claim 19 further comprising the step of converting the word transmission rate of each of said first, second and third divided-bit word sequence data in advance of the insertion of the additional word data group.

21. A method according to claim 20, wherein said additional word data group is selected to have at least a couple of portions each including said 8-bit word synchronous data.

22. A method according to claim 20, wherein said first, second and third divided-bit word sequence data are selected to be constituted with 8-bit word sequence data, 8-bit word sequence data and 4-bit word sequence data, respectively.

23. A method according to claim 22 further comprising the step of adding 4-bit word sequence data to said third divided-bit word sequence data.

24. An apparatus for transmitting digital data, which comprises;
data multiplexing means for multiplexing a plurality of compressed digital video or video and audio signal data to produce 8-bit word sequence data,
composite 8-bit word sequence data producing means for combining an additional word data group including 8-bit word synchronous data allotted a predetermined specific code with the 8-bit word sequence data to produce composite 8-bit word sequence data in which the additional word data group is repeatedly inserted at predetermined word intervals,
serial data producing means operative to cause the composite 8-bit word sequence data to be subjected to 8B/10B conversion to produce composite 10-bit word sequence data having a portion formed based on the additional word data group including 10-bit word synchronous data provided with running disparity not neutral and to convert the composite 10-bit word sequence data into serial data, and
data transmitting means for transmitting the serial data.

25. An apparatus according to claim 24, wherein said composite 8-bit word sequence data producing means is operative to cause said 8-bit word sequence data to be subjected to transmission rate conversion to produce said composite 8-bit word sequence data.

26. An apparatus according to claim 24, wherein said additional word data group includes ancillary data to be converted into 10-bit word data of neutral running disparity by the 8B/10B conversion.

27. An apparatus for transmitting digital data, which comprises;
data multiplexing means for multiplexing a plurality of digital video signals or combinations of a plurality of digital video signals and a bit adding signal to produce word sequence data,
composite word sequence data producing means for inserting an additional word data group including word synchronous data allotted a predetermined specific code into the word sequence data at predetermined word intervals thereof to produce composite word sequence data,
serial data producing means operative to cause the composite word sequence data to be subjected to 8B/10B conversion to produce converted composite word sequence data having a portion formed based on the additional word data group to include converted word synchronous data provided with running disparity not neutral and to convert the converted composite word sequence data into serial data, and
data transmitting means for transmitting the serial data.

28. An apparatus according to claim 27, wherein said composite word sequence data producing means is operative to cause said word sequence data to be subjected to transmission rate conversion to produce said composite word sequence data.

29. An apparatus according to claim 27, wherein said additional word data group includes ancillary data to be converted into 10-bit word data of neutral running disparity by the 8B/10B conversion.

30. An apparatus according to claim 29, wherein said additional word data group has at least a couple of portions each including said word synchronous data and said ancillary data arranged in series.

31. An apparatus for transmitting digital data, which comprises;
data multiplexing means for multiplexing a plurality of digital video signals or combinations of a plurality of digital video signals and a bit adding signal to produce word sequence data,
composite word sequence data producing means for inserting an additional word data group having at least a couple of portions each including word synchronous data allotted a predetermined specific code and ancillary word data into the word sequence data at predetermined word intervals thereof to produce composite word sequence data,
serial data producing means operative to cause the composite word sequence data to be subjected to 8B/10B conversion to produce converted composite word sequence data having a portion formed based on the additional word data group to include at least a couple of converted word synchronous data each provided with running disparity not neutral and to convert the converted composite word sequence data into serial data, and
data transmitting means for transmitting the serial data.

32. An apparatus according to claim 31, wherein at least one of said word synchronous data is converted into 10-bit word data of positive running disparity by the 8B/10B conversion.

33. An apparatus according to claim 31, wherein at least one of said word synchronous data is converted into 10-bit word data of positive running disparity by the 8B/10B conversion.

34. An apparatus according to claim 31, wherein at least one of said ancillary data is converted into 10-bit word data of neutral running disparity by the 8B/10B conversion.

35. An apparatus according to claim 31, wherein said additional word data group includes ancillary data for reversing running disparity, said ancillary data for reversing running disparity being converted into first 10-bit word data of positive running disparity by the 8B/10B conversion when the running disparity just before said first 10-bit word data is negative and into second 10-bit word data of negative running disparity by the 8B/10B conversion when the running disparity just before said second 10-bit word data is positive.

36. An apparatus according to claim 31, wherein each of said digital video signal is constituted with 16-bit word sequence data and said converted composite word sequence data are obtained in the form of 20bit word sequence data.

37. An apparatus for transmitting digital data, which comprises;
8-bit word data producing means for obtaining first and second 8-bit word sequence data based on first and second digital information data forming a digital video signal, respectively,
composite 8-bit word data producing means for inserting an additional word data group including 8-bit word synchronous data allotted a predetermined specific code into each of the first and second 8-bit word sequence data at predetermined word intervals thereof to produce first and second composite 8-bit word sequence data,
serial data producing means operative to cause each of the first and second composite 8-bit word sequence data to be subjected to 8B/10B conversion to produce first and second composite 10-bit word sequence data each having a portion formed based on the additional word data group to include 10-bit word synchronous data allotted a predetermined specific code obtained based on the 8-bit word synchronous data and to convert the first and second composite 10-bit word sequence data into first and second serial data, respectively, and
data transmitting means for transmitting the first and second serial data.

38. An apparatus according to claim 37, wherein said composite 8-bit word data producing means is operative to cause each of said first and second 8-bit word sequence data to be subjected to transmission rate conversion in advance of the insertion of said additional word data group.

39. An apparatus according to claim 37, wherein said additional word data group has at least a couple of portions each including said 8-bit word synchronous data.

40. An apparatus according to claim 37, wherein said 8-bit word synchronous data are converted into 10-bit word data of positive running disparity by the 8B/10B conversion.

41. An apparatus according to claim 37, wherein said 8-bit word synchronous data are converted into 10-bit word data of negative running disparity by the 8B/10B conversion.

42. An apparatus for transmitting digital data, which comprises;
dividing means for causing a digital video signal to be subjected to bit-dividing to produce first, second and third divided-bit word sequence data,
composite 8-bit word sequence data producing means for inserting an additional word data group including 8-bit word synchronous data allotted a predetermined specific code into each of the first, second and third divided-bit word sequence data at predetermined word intervals thereof to produce first, second and third composite 8-bit word sequence data,
serial data producing means operative to cause each of the first, second and third composite 8-bit word sequence data to be subjected to 8B/10B conversion to produce first, second and third composite 10-bit word sequence data each having a portion formed based on the additional word data group to include 10-bit word synchronous data allotted a predetermined specific code obtained based on the 8-bit word synchronous data and to convert the first, second and third composite 10-bit word sequence data into first, second and third serial data, respectively, and
data transmitting means for transmitting the first, second and third serial data.

43. An apparatus according to claim 42, wherein said composite 8-bit word sequence data producing means is operative to cause each of said first, second and third 8-bit word sequence data to be subjected to transmission rate conversion in advance of the insertion of said additional word data group.

44. An apparatus according to claim 42, wherein said additional word data group has at least a couple of portions each including said 8-bit word synchronous data.

45. An apparatus according to claim 42, wherein said first, second and third divided-bit word sequence data are constituted with 8-bit word sequence data, 8-bit word sequence data and 4-bit word sequence data, respectively.

46. An apparatus according to claim 45 further comprising bit adding means for adding 4-bit word sequence data to said third divided-bit word sequence data.
